(19) United States
(12) Patent Application Publication
(10) Pub. No.: US 2016/0378545 A1
(43) Pub. Date: Dec. 29, 2016

(54) METHODS AND ARCHITECTURE FOR ENHANCED COMPUTER PERFORMANCE

(71) Applicant: APL Software Inc., San Jose, CA (US)

(72) Inventor: Lap-Wah Lawrence Ho, Campbell, CA (US)

(73) Assignee: APL Software Inc., San Jose, CA (US)

(21) Appl. No.: 15/150,113

(22) Filed: May 9, 2016

Related U.S. Application Data
(60) Provisional application No. 62/159,316, filed on May 10, 2015.

(51) Int. Cl. G06F 9/48; G06F 11/34; G06F 11/30

(52) U.S. Cl. CPC G06F 9/4843; G06F 9/4812; G06F 11/302; G06F 11/3495

(57) ABSTRACT

Methods and systems for enhanced computer performance improve software application execution in a computer system using, for example, a symmetrical multi-processing operating system including OS kernel services in kernel space of main memory, by using groups of related applications isolated areas in user space, such as containers, and using a reduced set of application group specific set of resource management services stored with each application group in user space, rather than the OS kernel facilities in kernel space, to manage shared resources during execution of an application, process or thread from that group. The reduced sets of resource management services may be optimized for the group stored therewith. Execution of each group may be exclusive to a different core of a multi-core processor and multiple groups may therefore execute separately and simultaneously on the different cores.

### RELATED APPLICATIONS

This application claims the prior of the filing date of U.S. Provisional Application Ser. No. 62/159,316, filed May 10, 2015.

### BACKGROUND OF THE INVENTION

Field of the Invention

This invention is related to improved methods and architecture in multi-core computer systems

### DESCRIPTION OF THE PRIOR ART

Conventional computer designs include hardware, such as a processor and memory and software including operating systems (OS) and various software programs or applications such as word processors, databases and the like. Computer utilization demands have resulted in hardware improvements such as larger, faster memories such as dynamic random access memories (DRAM), central processing units (processors or CPUs) with multiple processor or CPU cores (multi-core processors) as well as various techniques for virtualization including creating multiple virtual machines operating within a single computer.

Current computational demands, however, often require enormous amounts of computing power to host multiple software programs, for example, to host cloud based service and the like over the Internet.

Symmetric multi-processing (SMP) may be the most common computer operating system available for such uses, especially for multicore processors, and provides the processing of programs by multiple, usually identical processor cores that share a common OS, memory and input/output (I/O) path. Most existing software, as well as most new software being written, is designed to use SMP OS processing. SMP refers to a technique in which the OS services attempt to spread the processing load symmetrically across each of a plurality of cores in a computer system which may include one or more multicore CPUs using a common main memory.

That is, a computer system may contain a shared-memory processor which includes 4 (or more) cores on a single processor die. The processor die may be connected to the processor's main memories so that main memory is shared and cache coherency is maintained in the processor die among the processor cores.

Further enhancements include dual-socket servers in which a shared-memory cluster is made available to interconnected multi-core processors, or servers with even higher socket counts (e.g., 4 or more). Conventional multi-core processors such as Intel Xeon® processors have at least 4 cores. XEON® is a registered trademark of Intel Corporation). Dual (or higher) socket processer systems, with shared memory access, are used to double (or quadruple and so on) core counts in processors having high processing loads such as datacenters, cloud based computer processing systems and similar business environments.

When an SMP OS is loaded onto a computer system as the host OS, the OS is typically loaded into main memory, in a portion of main memory commonly called kernel-space. User application software, such as databases, are typically loaded into another portion of main memory called user-space.

Conventional OS services provided by an SMP OS in kernel-space have privileged access to all computer memory and hardware and are provided to avoid contentions by conflict between programs' instructions and statements, library calls, function calls, system calls and/or other software calls and the like from one or more software programs loaded into user-space which are concurrently executing. OS kernel-space services also typically provide arbitration and contention management for application related hardware interrupts, event notifications or call-backs and/or other signals, calls and/or data from low level hardware and their controllers.

Conventional OS services in kernel-space are used to isolate user-space programs from kernel-space programs (e.g., OS kernel services) to provide a clean interface (e.g., via system calls) and separation between programs/applications and the OS itself, and to prevent program-induced corruptions and errors to the OS itself, and to provide a standard and non-standard sets of OS processing and execution services to programs/applications that require OS services during their execution in user-space. For example, OS kernel services may prevent low level hardware and their controllers from being erroneously accessed by programs/applications, and instead, hardware and controllers are only directly managed by OS kernel services while data, events, and hardware interrupts and the like from such hardware and/or controllers are exposed to user-space applications/programs only through the OS of “kernel” e.g., OS services, OS processing, and their OS system calls.

A conventional SMP OS running over and resource managing a large numbers of processor cores create special challenges in OS kernel based contentions and overhead in cache data movements between and among cores for shared kernel facilities. Such shared kernel facilities may include kernel's critical code segments, which may be shared among cores and kernel threads, as well as kernel data structures, and input/output (I/O) data and processing and the like, which may be shared among multiple kernel threads executing concurrently on such processor cores as a result of a kernel thread executing on a kernel-executing core. These challenges may be especially severe for server-side software and large number of software containers that process large amounts, for example, of I/O, network traffic and the like.

One conventional technique for reducing the processing overhead of such OS kernel contentions, and/or the processing overhead of cache coherence and the like, is server virtualization, based on the concept and construct of virtual machines (VMs), each of which may contain a guest operating system, which may be the same or different from the host OS, together with the user-space software programs to be virtualized. A set of VMs may be managed by a virtualization kernel, often called a hypervisor.

A further improvement has been developed in which software programs may be virtually encapsulated, e.g., isolated from each other—or grouped—into software abstractions, often called “containers”, by the host SMP OS, which executes in an SMP mode over a set of interconnected multi-core processors and their processor cores in shared-memory mode. In this approach, the OS-level and container-based virtualization facilities may be included in the SMP OS kernel facilities for resource isolation.

However, to make such OS-level virtualization techniques reliable and relatively easier to develop, and to introduce resource isolations and therefore OS-level virtualization facilities, new data structures or modified data structures such as namespaces and their associated kernel code/processing were introduced into existing kernel facilities, e.g., network stack, file system, and process-related kernel data structures. However, kernel locking and synchronization, cache data movement, synchronization and pollution, and resource contentions in a SMP OS, remains a substantial problem. Such problems are especially severe when a large number of user-space processes (containers, and/or applications/programs) are executed over a large number of processor cores. Unfortunately, this approach may actually make kernel locking and synchronization overheads and cache problems and resource contentions worse because now with resource isolations, containers (which run in user-space) can and do consume kernel data and resources and kernel processing.

### SUMMARY

Methods and systems are disclosed for executing software applications in a computer system including one or more multi-core processors, main memory shared by the one or more multi-core processors, a symmetrical multi-processing (SMP) operating system (OS) running over the one or more multi-core processors, one or more groups, each including one or more software applications, in a user-space portion of main memory, and a set of SMP OS resource management services in a kernel-space portion of main memory, by intercepting, in user-space, a first set of software calls and system calls directed to kernel-space during execution of at least a portion of one or more of the software applications in the first one of the one or more groups, to provide resource management services required for processing the first set of software calls and system calls and redirecting the first set of software calls and system calls to a second set of resource management services, in user-space, selected for use during execution of software applications in the first group.

A second set of software calls and system calls occurring during execution of at least a portion of a software application in a second group of applications may be intercepted and redirected to a third set of resource management services different from the second set of resource management services. At least portions of the first group of applications may be stored in a first subset of the use-space portion of main memory isolated from kernel space portion, the first set of software calls and system calls may be intercepted and redirected to the second set of resource management services to use the resources management services of the first set of management services, in the first subset of user space in the main memory.

A second subset of user space in main memory, isolated from the first subset and from kernel space, may be used to store at least portions of a second group of applications and a second set of resource management services, and resource management in the second subset of main memory may be used for execution of at least a portion of an application stored in the second group of applications.

The first and second subsets of main memory may be OS level software abstractions such as software containers. At least a portion of one software application in the first group may be executed on a first core, of the multi-core processor, The firs core may be used to intercept and redirect the first set of software calls and system calls and to provide resource management services therefore from the first set of resource management services.

At least a portion of one software application in the first group may be executed exclusively with a first core of the multi-core and execution may be continued on the same first core to intercept and redirect the first set of software calls and systems and to provide resource management services from the second set of resource management services. Inbound data, metadata and events related to the at least a portion of one software application for processing by the first core while inbound data, metadata and events not related to a different portion of the software application or a different software application may be directed for processing by a different core of the multi-core processor. Such inbound data, metadata and events may be so redirected by dynamically programming I/O controllers associated with the computer system.

A second software application, selected to have similar resource allocation and management resources to the at least one software application, may be provided to the same group. The second software application may advantageously be selected so that the at least one software application and the second software application are inter-dependent and inter-communicating with each other.

A first subset of the SMP OS resource management services may be provided in user space as the first set of resource management services. A second subset of the SMP OS resource management services may be used for providing resource management services for software applications in a different group of software applications. The first set of resource management services, may provide some or all of the resource management services required to provide resource management for execution of the first group of software applications while excluding at least some of the resource management services available in the set of SMP OS resource management services in a kernel space portion of main memory.

Methods of operating a shared resource computer system using an SMP OS may include storing and executing each of a plurality of groups of one or more software applications in different portions of main memory, each application in a group having related requirements for resource management services, each portion wholly or partly isolated from each other portion and wholly or partly isolated from resource management services available in the SMP OS, preventing the SMP OS from providing at least some of the resource management services required by said execution of the software applications and providing at least some of the resource management services for said execution in the portion of main memory in which said each of the software applications is stored. The software applications in different groups may be executed in parallel on different cores of a multi-core processor. Data for processing by a particular software applications, received via I/O controllers, may be directed to the cores on which the particular applications are executing in parallel. A set of resource management services selected for each particular group of related applications may be used therefore. The set of resource management services for each particular group may be based on the related requirements for resource management services of that group to reduce processing overhead and limitations by reducing mode switching, contentions, non-locality of caches, inter-cache communications and/or kernel synchronizations during execution of software applications in the first plurality of software applications.

A method for monitoring execution performance of a specific software application in a computer system may include using a first monitoring buffer relatively directly connected to an input of the application to be monitored to apply work thereto, monitoring characteristics of the passage of work through the first buffer and determining execution performance of the software application being monitored from the monitored characteristic. A second monitoring buffer relatively directly connected to an output of the application to be monitored to receive work therefrom may be used, characteristic of the passage of work through the second buffer may be monitored and execution performance of the application being monitored may be determined by the monitoring characteristics of the passage of work through the first and second monitoring buffers as a measurement of execution performance of the application being monitored. The execution performance may be compared to an identified quality of service, such as QoS.

Monitoring may include comparing execution performance determinations made before and after altering a characteristic of the execution to evaluate the effect of the altering on the execution performance of the software application from the comparing. Altering a condition of the execution of the software application may include altering a set of resource management services used during the execution of the software application to optimize the set for the application being monitored. Execution performance of a software application may include determining execution performance metrics of the software application while being executed on a computer system.

Shared resources in the computer system may be altered while the application is being executed in response to the execution performance metrics so determined may be altered. Altering the shared resources may include controlling resource scheduling of one or more cores in a multi-core processor and/or controlling resource scheduling of events, packets and I/O provided by individual hardware controllers and/controlling resource scheduling of software services provided by an operating system running in the computer system executing the software.

A method of operating a computer system having one or more multicore microprocessors and a main memory to minimize system and software call contention, the main memory having a separate user space and a kernel space may include sorting a plurality of applications into one or more groups of applications having similar system requirements, creating a first subset of operating system kernel services optimized for a first application group of the one or more groups of software applications and storing the first subset of operating system kernel services in user space, intercepting a first set of software calls and system calls occurring during execution of the first application group in user space of main memory and processing the first set of software calls and system calls in user space using the first subset of the operating system kernel services and/or allocating a portion of the main memory to load and process each group of the one or more groups of applications.

A method of executing a software application may include storing a reduced set of resource management services separately from resource management services available from an OS running in a computer and increasing execution efficiency of a software application executable by the OS, by using resource management services from the reduced set during execution of the software application. The reduced set of shared resource management services may be a subset of shared resource management services available from the OS. Mode switching required between execution of the first application and providing shared resource management services may be reduced. The OS may be a symmetrical multiprocessor OS (SMP OS).

A method of executing software applications may include limiting execution of a first software application, executable by a symmetrical multiprocessor operating system (SMP OS), to execution on a first core of a multi-core processor running the SMP OS, limiting execution of a second of software application to a second core of the multi-core processor and executing the first and second software applications in parallel.

A method of executing software applications executable by a symmetrical multiprocessor operating system (SMP OS), may include storing software applications in different memory portions of a computer system and restricting execution of software applications stored in each memory portion to a different core of a multi-core processor running SMP OS.

A method of executing software applications may include executing first and second software applications in parallel on first and second cores, respectively, of a multi-core processor in a computer system, limiting use of resource management services available from an operating system (OS) running on the computer system during execution of the first and second applications by the OS and substituting resource management services available from another source to increase processing efficiency.

A method of operating a computer system using a symmetrical multiprocessor operating system (SMP OS) may include executing one or more software applications of a first group of software applications related to each other by the resource management services needed during their execution and providing the needed resource management services during said execution from a source separate from resource management services available from the SMP OS to improve execution efficiency.

A computer system for executing a software application may include shared memory resources including resource management services available from an OS running on the computer, one or more related software applications, and a reduced set of resource management services, stored therewith in main memory separately from the OS resource management services, the reduce set of resource management services selected to execute more efficiently during execution of at least a part of the one or more related software applications than the resource management services available from an OS running on the computer. The reduced set of resource management services may be a subset of the resource management services available from the OS which may be a symmetrical multiprocessor OS (SMP OS).

A computer system having shared resource managed by a symmetrical multiprocessor operating system (SMP OS) may include a first core of a multi-core processor constrained to execute a first software application or a part thereof and a second core of the multi-core processor may be constrained to execute another portion of the first software application or a second software application or a part thereof.

A computer system for executing software applications, executable directly by a symmetrical multiprocessor operating system (SMP OS), may include software applications stored in different portions of memory, one core of a multi-core processor constrained to exclusively execute at least a portion of one of the software applications; and another core of the multi-core processor constrained to exclusively execute a different one of software applications.

A computer processing system, may include a multi-core processor, a shared memory, an OS including resource management services and a plurality of groups of software applications stored in different portions of the shared memory; each of the groups constrained to exclusively execute on different core of the multi-core processor and to use at least some resource management services stored therewith in lieu of the OS resource management services.

A multi-core computer processor system may include shared main memory, a symmetrical multiprocessor operating system (SMP OS) having SMP OS resource management services stored in kernel space of main memory, a first core constrained to execute software applications or parts thereof using resource management services stored therewith in a first portion of main memory outside of kernel space, and a second core constrained to execute software applications or parts thereof using resource management services stored therewith in a second portion of main memory outside of kernel space, the first and second portions of main memory being wholly or partially isolated from each other and from kernel space.

A computer system may include one or more multi-core processors, main memory shared by the one or more multi-core processors, a symmetrical multi-processing (SMP) operating system (OS) running over the one or more multi-core processors, one or more groups, each including one or more software applications, each group stored in a different subset of a user-space portion of main memory, a set of SMP OS resource management services in a kernel-space portion of main memory, and an engine stored with each group using resource management services stored therewith to process at least some of the software calls and systems calls occurring during execution of a software application, or part thereof, in said group in lieu of OS resource management services in kernel space as directed by the SMP OS. The resource management services stored with each group of software applications may be selected based on the requirements of software in that group to reduce processing overhead and limitations compared to use of the OS resource management services.

A system for monitoring execution performance of a specific software application in a computer system may include an input buffer applying work to the software application to be monitored, an output buffer receiving work performed by the software application to be monitored and an engine, responsive to the passage of work flow through the input and output buffers, to generate execution performance data in situ for the specific software as executing in the computer system.

A system for monitoring execution performance of a specific software application in a computer system may include an input buffer applying work to the software application to be monitored, an output buffer receiving work performed by the software application to be monitored and an engine, responsive to the passage of work flow through the input and output buffers and a performance standard, such as quality of service, QoS execution, to determine in situ compliance with the performance standard.

A system for evaluating the effects of alterations made during execution of a specific software application in that computer system may include a processor, main memory connected to the processor, an OS for executing a software application and an engine directly responsive in situ to the passage of work during execution of the software application at a first time before the alteration is made to the computer system and at a second time after the alteration has been made. A plurality of alterations may applied by the engine to a set of resource management services used during execution of the software application to optimize the set for the application being monitored.

A computer system with shared resources for execution of a software application may include an engine for deriving in situ performance metrics of the software application being executed on a computer system and an engine for altering the shared resources, while the application is being executed, in response to the execution performance metrics.

A computer system may a multi-core processor chip including on-chip logic connected to off-chip hardware interfaces and a first main memory segment including host operating system services. The main memory may include a plurality of second memory segments each including a) one or more software applications, and b) a second set of shared resource management services for execution of the one or more software applications therein. The host operating system services may include a first set of shared resource management services for execution of software applications in multiple second memory segments.

A computer system may include one or more multicore microprocessors, a main memory having an OS kernel in user space and a plurality of related application groups in kernel space, a first subset of operating system kernel services, optimized for a first application group, stored with the first application group in user space and an engine stored with the first application group for processing the first set of software calls and system calls in user space in lieu of kernel space.

A computer system may include a multi-core processor chip, main memory including first plurality of segments each including one or more software applications, and a set of shared resource management services for execution of the one or more software applications therein and the system may also include an additional memory segment providing shared resource management services for execution of applications in multiple segments.

A computer system may include a multi-core processor chip including on-chip logic connected to off-chip hardware interfaces and a first main memory segment including host operating system services. The main memory may also include a plurality of second memory segments each including one or more software applications, and a second set of shared resource management services for execution of the one or more software applications therein. The host operating system may include a first set of shared resource management services for execution of software applications in multiple second memory segments.

Devices and methods are described which may improve software application execution in a multi-core computer processing system. For example, in a multi-core computer system using a symmetrical multi-processing operating system including OS kernel services in kernel space of main memory, execution may be improved by a) intercepting a first set of software calls and system calls occurring during execution of a first plurality of software applications in user-space of main memory; and b) processing the first set of software calls and system calls in user-space using a first subset of the OS kernel facilities selected to reduce software and system call contention during concurrent execution of the first plurality of software applications.

Devices and methods are described which may provide for computer systems and/or methods which reduce system impacts and time for processing software and which are more easily scalable. For example, techniques to address the architectural, software, performance, and scalability limitations of running OS-level virtualization (e.g., containers) or similar groups of related applications in a SMP OS over many interconnected processor cores with shared memory and cache coherence are disclosed.

Techniques are disclosed to address the architectural, software, performance, and scalability limitations of running OS-level virtualization (e.g., containers) in a SMP OS over many interconnected processor cores and interconnected multi-core processors with shared memory and cache coherence.

Method and apparatus are disclosed for executing a software application, and/or portions thereof such as processes and threads of execution by storing a reduced set of resource management services separately from resource management services available from an OS running in a computer and increasing execution efficiency of a software application executable by the OS, by using resource management services from the reduced set during execution of the software application. The reduced set of shared resource management services maybe a subset of shared resource management services available from the OS. Execution efficiency may be improved by reducing mode switching between required between execution of the first application and providing shared resource management services, for example in a system running a symmetrical multiprocessor OS (SMP OS).

Method and apparatus are disclosed for executing a software application, and/or portions thereof such as processes and threads of execution by storing a reduced set of resource management services separately from resource management services available from an OS running in a computer and increasing execution efficiency of a software application executable by the OS, by using resource management services from the reduced set during execution of the software application. The reduced set of shared resource management services maybe a subset of shared resource management services available from the OS. Execution efficiency may be improved by reducing mode switching between required between execution of the first application and providing shared resource management services, for example in a system running a symmetrical multiprocessor OS (SMP OS).

Software applications may be executed while limiting execution of a first software application, executable by a symmetrical multiprocessor operating system (SMP OS), to execution on a first core of a multi-core processor running the SMP OS and/or limiting the execution of a second software application to a second core of the multi-core processor while executing the first and second software applications separately and in parallel on these cores.

Software applications, executable by an SMP OS, may be executed by storing software applications in different memory portions of a computer system and restricting execution of software applications stored in each memory portion to a different core of a multi-core processor running SMP OS.

Software applications may also be executed by executing first and second software applications in parallel on first and second cores, respectively, of a multi-core processor in a computer system, limiting use of resource management services available from an operating system (OS) running on the computer system during execution of the first and second applications by the OS and substituting resource management services available from another source to increase processing efficiency.

A computer system using an SMP OS may be operated by executing one or more software applications of a first group of software applications related to each other by the resource management services needed during their execution and providing the needed resource management services during said execution from a source separate from resource management services available from the SMP OS to improve execution efficiency.

A computer system may include at least one multi-core processor, main memory shared among cores in processor, and among all processors, if more than one processor is present with core-wide cache coherency, with SMP OS running over the cores and processor(s) and resource-managing them, software may be executed by storing a first group of one or more software applications in and executing them in and out of a user-space portion of main memory and a set of SMP OS resource management services in and out of a kernel space portion of main memory, intercepting a first set of software calls and system calls occurring during the execution of at least one software application in the first group and directing the intercepted set of software calls and system calls to a first set of resource management services selected and optimized to provide resource management services for the first group of applications more efficiently, with more scalability, and with stronger core(s)-based locality of processing in user space than such resource management services can be provided by the SMP OS in kernel space, so that effectively, for the said first resource management services, they bypass their SMP OS equivalent processing, from hardware directly to/from user-space.

A method for improving software application execution in a computer system having at least one multi-core processor, shared main memory (among cores in processor, and among all processors, if more than one processor), core-wide cache coherent, and a symmetrical multi-processing (SMP) operating system (OS) running over the said cores and processor(s) and resource-managing them, the main memory including a first group of one or more software applications executing in and out of a user-space portion of main memory and a set of SMP OS resource management services in and out of a kernel space portion of main memory, the method may include intercepting a first set of software calls and system calls occurring during the execution of at least one software application in the first group and directing the intercepted set of software calls and system calls to a first set of resource management services selected and optimized to provide resource management services for the first group of applications more efficiently, with more scalability, and with stronger core(s)-based locality of processing in user space than such resource management services can be provided by the SMP OS in kernel space, so that effectively, for the said first resource management services, they bypass their SMP OS equivalent processing, from hardware directly to/from user-space.

The method may also include intercepting a second set of software calls and system calls occurring during execution of a software application in a second group of applications and directing the second set of intercepted software calls and system calls to a second set of resource management services different from the first set of resource management services.

The first group of applications may be stored in and executing out of a first subset of the use-space portion of main memory isolated from kernel space portion on a set of core(s) belonging to one or more processors and the method may include intercepting the first set of software calls and system calls called by the said first group of applications during its execution, redirecting the intercepted first set of software calls and system calls to the first set of resource management services, and executing the resources management services of the first set of management services out of the first subset of user space in the main memory and the associated cache(s) of the said core(s) locally to maximize locality of processing.

The method may also include using a second subset of user space in main memory, isolated from the first subset and from kernel space, to store a second group of applications and a second set of resource management services, and providing resource management in the second subset of main memory and associated cache(s) of the core(s) on which this second group of applications are executing, for execution of an application in the second group of applications. The first and second subsets of main memory may be OS level software abstractions including but not limited to two address spaces of virtual memory of the SMP OS. The first and second groups of applications may be Linux or software containers (two containers containing the applications, respectively), or just standard groups of applications without containment.

The method may include executing the at least one software application (or at least one thread of execution of this one application) in the first group on a first core of the multi-core processor and using the first core to intercept and redirect the first set of software calls and system calls and to provide resource management services from the first set of resource management services.

The method may include executing the at least one software application (or at least one thread of execution of this one application) in the first group exclusively on a first core of the multi-core processor from a first cache of the first core connected between the first core and main memory through some cache hierarchy and cache coherent protocol and continuing execution on the same first core to intercept and redirect the first set of software calls and systems and to provide resource management services from the first set of resource management services.

The method may include directing I/O data and metadata, events (hardware and software), requests, and general data and metadata inbound to the computer system and related to the at least one software application (or one thread of execution) to the first cache, while directing I/O data and metadata, events (hardware and software), requests, and general data and metadata inbound to the computer system and related to a different software application from a different group of applications to a different cache associated with a different core of the multi-core processor. The method may also include dynamically programming I/O controllers associated with the computer system to automatically direct (e.g., hardware data-path or hardware processing, without software/OS intervention) the I/O data and metadata, events (hardware and software), requests, and general data and metadata inbound to the computer system and related to the at least one software application to the first cache. Criteria for the automatic directing may be associated with the type of the application's processing and in any case application-specific and native to the application, and these criteria can be dynamically modified and updated as the application executes. The method may include programming I/O controllers such that the I/O data and metadata, events (hardware and software), requests, and general data and metadata inbound to the first application are mostly if not exclusively processed on the first core by both the first resource management and the application, with maximal locality of processing.

The method may include providing a second software application in the first group selected to have similar resource allocation and management resources to the at least one software application and/or selecting a second software application so that the at least one software application and the second software application are inter-dependent and inter-communicating with each other. Directing the intercepted set of software calls and system calls to a first set of resource management services may include providing in user space an equivalent and behaviorally invariant (i.e., transparent to the first application) first subset of the SMP OS resource management services as the first set of resource management services and/or providing an equivalent and behaviorally invariant (i.e., transparent to the second application) second subset of the SMP OS resource management services as a second set of resource management services for use in providing resource management services for use with software applications in a different group of software applications.

Directing the intercepted set of software calls and system calls to a first set of resource management services further may further include the step of including, in the first set of resource management services, some or all of the resource management services required to provide resource management for execution of the first group of software applications while excluding at least some of the resource management services available in the set of SMP OS resource management services in a kernel space portion of main memory.

A method of operating a shared resource computer system using an SMP OS may include storing and executing each of a plurality of groups of one or more software applications in different portions of main memory and different processor caches, each application in a group having related requirements for resource management services, each portion partly or wholly isolated from each other portion and partly or wholly from resource management services available in the SMP OS, preventing the SMP OS from providing at least some of the resource management services required by said execution of the software applications and providing at least some of the resource management services for said execution in the portion of main memory and processor caches in which said each of the software applications is stored and executed out of.

The method may further include executing software applications in different groups in parallel on different cores of one or more shared-memory and cache coherent multi-core processors in said computer system, with minimized/no interference or mutual exclusion or synchronization or communication, or with minimized/no software and execution interaction, between the concurrent software execution of the said groups, in which said interference and interaction eliminated or minimized are typically forced on by the said SMP OS's resource management services or a portion of them.

The method may include applying and steering inbound (towards said computer system) data, metadata, requests, and events bound for processing by particular software applications, received via I/O controllers and associated hardware, to the specific cores on which the particular applications are executing in parallel, effectively bypassing the overheads and architectural limitations, for those data, metadata, requests, and events, of the said SMP OS and a portion of its native resource management services; and this applying and steering is symmetrically done (from said applications on said cores to said I/O controllers and said hardware) in reverse after the said applications are done processing the said data, metadata, requests, and events

The method of may also include running a selected and optimized set of resource management services specific to the said application groups in user-space to process the said data, metadata, requests, and events in concurrently executing and group-specific resource management services with minimized/zero interaction or interference among the said group-specific resource management services, before the said data, metadata, requests, and events reach the said application groups for their processing, such that these parallel resource management services can be more efficient and optimized equivalents to at least a portion of the SMP OS's native resource management services.

The method may also include the use of application group specific queues and buffers—for application-specific data, metadata, requests, and events—such that said parallel and emulated resource management services have (non-interfering) group-specific and effective way to deliver data, metadata, requests, and events post processing to and from the said applications, without or with minimal mutual interaction and interference between these queues and buffers that are local and bound to application groups' memory and cache portions, for maximally parallel processing.

Providing at least some of the resource management services for execution of a particular software application in the portion of main memory in which the particular software application is stored may include using a set of resource management services selected for each particular group of related applications, such that these group- or application-specific (and user-space based) resource management services, which executes in parallel like their associated application groups, are more optimized and more efficient equivalents (semantically and behaviorally equivalent for applications) of the said SMP OS's resource management services in kernel-space.

Using a set of resource management services selected for each particular group may include selecting a set of resource managements services to be applied to execution of software applications in each group (and thereby selectively replacing and emulating the SMP OS's native and equivalent resource management services), based on the related requirements for resource management services of that group, to reduce processing overhead and architectural limitations of SMP OS's native resource management services by reducing mode switching, contentions, non-locality of caches, inter-cache communications and/or kernel synchronizations during execution of software applications in the first plurality of software applications.

### BRIEF DESCRIPTION OF THE DRAWINGS

FIG. 1 is a high level block diagram of multi-core computer processing system 10 including multi-core processors 12 and 14, main memory 18 and a plurality of I/O controllers 20.

FIG. 2 is a block diagram of cache contents 12c in which portions group 22, which may at various times be in cache 28 are illustrated in greater detail (as if concurrently present in cache 28) while application group or container 22 is processed by core 0 of processor 12.

FIG. 3 is a block diagram of computer system 80 including kernel bypass 84 to selectively or fully avoid or bypass OS kernel facilities 107 and 108 in kernel space 19.

FIG. 4 is a block diagram of computer processing system 80 including a representations of user-space 17 and kernel space 19 illustrating cache line bouncing 130, 132, and 136 as well as contentions 140, 142 and 143, which may be resolved by kernel bypass 84.

FIG. 5 is an illustration of multi-core computer system 80 including both computer hardware and illustrations of portions of main memory indicating the operation of OS kernel bypasses 51, 53 and 55 as well as I/O paths 41, 43 and 45 and parallel processing of containers 90, 91 and 92 separately, independently (of OS and OS-related cross-container contentions, etc.) and concurrently in cores 0, 1 and 3 of processor 12.

FIG. 6 is an block diagram illustrating one way to implement monitoring input buffer 31 and monitoring output buffers 33.

FIG. 7 is a block diagram illustration of cache space 12c in which portions of group 22 which may reside in cache 28 at various times during various aspects of executing application 42 of application group 22 in core 0 of multi-core processor 12, are shown in greater detail (as if concurrently present in cache 28) to better illustrate techniques for monitoring the execution performance of one or more processes or threads of software application 42.

FIG. 8 is a block diagram illustration of multi-threaded processing on computer system 80 of FIG. 3.

FIG. 9 is a block diagram illustration of alternate processing of the kernel bypass technique of FIG. 3.

FIG. 10 is a detailed block diagram of the ingress/egress processing corresponding to the kernel bypass technique of FIG. 3.

FIG. 11 is a block diagram illustrating the process of resource scheduling system 114 of using metrics such as queue lengths and their rates of change.

FIG. 12 is a block diagram illustrating the general operation of a tuning system for a computer system utilizing kernel bypass.

FIG. 13 is a block diagram illustrating latency tuning in a computer system utilizing kernel bypass.

FIG. 14 is a block diagram illustrating latency tuning for throughput-sensitive applications in a computer system utilizing kernel bypass.

FIG. 15 is a block diagram illustrating latency tuning with resource scheduling of different priorities for data transfers to and from software processing queues in order to accommodate the QoS requirements in a computer system utilizing kernel bypass.

FIG. 16 is a block diagram illustrating scheduling data transfers with various different software processing queues in accordance with dynamic workload changes in a computer system utilizing kernel bypass.

FIG. 17 is a block diagram of multi-core, multi-processor system 80 including a plurality of multi-core processors 12 to n each including a plurality of processor cores 0 to m, each such core associated with one or more caches 0 to m which are connected directly to main processor interconnect 16. Main memory includes a plurality of application groups as well as common OS and Resource services. Each application group includes one more applications as well as application group specific execution, optimization, resource management and parallel processing services.

FIG. 18 is a block diagram of a computer system including on-chip I/O controller logic.

### DETAILED DISCLOSURE OF PREFERRED EMBODIMENTS

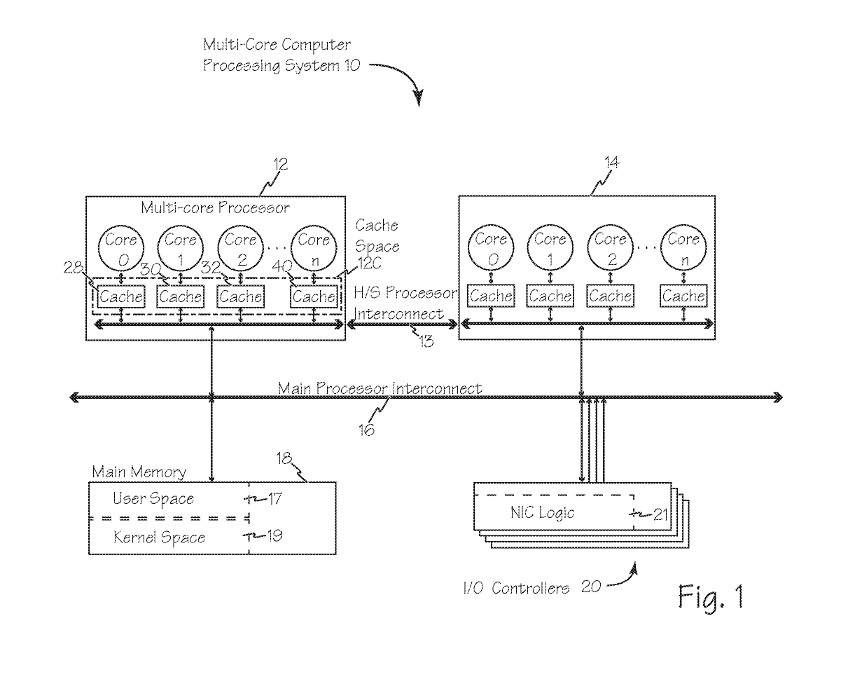

Referring now to FIG. 1, multi-core computer processing system 10 includes one or more multi-core processors, such as multi-core processor 12 and/or multi-core processor 14. As shown, processors 12 and 14 each include cores 0, 1, 2 . . . n. Processors 12 and 14 are connected via one or more interconnections, such as high speed processor interconnect 13 and main processor interconnect 16 which connect to shared hardware resources such as (a) main memory 18 and (b) a plurality of low level hardware controllers illustrated as I/O controllers 20 or other suitable components. Effectively all cores (0, 1, . . . n) of both multi-core processors 12 and 14 may be able to share hardware resources such as main memory 18 and hardware I/O controllers 20 to maintain cache coherence. Various paths and interconnections are illustrated with bidirectional arrows to indicate that data and other information may flow in both directions. In the context of this disclosure, cache coherency refers to the requirement to have data processed by a core in the cache associated with that core to be transferred and synchronized with other cores' caches and main memory because of sharing of data among cores' core-specific OS kernel services and data.

Any suitable symmetrical multi-processing (SMP) operating system (OS), such as Linux®, may be loaded into main memory 18 and processing may be scheduled across multiple CPU cores to achieve higher core and overall processor utilization. The SMP OS may include OS level virtualization (e.g., for containers) so that multiple groups of applications may be executed separately in that the execution of each group of applications is performed in a manner isolated from the execution of each of the other groups of applications in containers as in a Linux® OS, for security, efficiency or other suitable reasons. Further, such OS level virtualization enables multiple groups of applications to be executed concurrently in the processing cores, OS kernel and hardware resources, for example, in containers in a Linux® OS, for security, efficiency, scalability or other suitable reasons.

In particular, user space 17 may include a plurality of groups of related applications, such as groups 22, 24 and 26. Applications within each group may be related to each other by their needs for the same or similar shared resource management services. For example, applications within a group may be related because they are inter-dependent and/or inter-communicating such as a web server inter-communicating with an application server intercommunicating with to provide e-commerce services to a person using the computer system. All applications in a group are considered related if there is only one application in that group, i.e., resource management services required by all applications in that group would be the same.

Resource management services applications in a group such as a Linux container, are conventionally provided by the operating system or OS in kernel space 16, often simply called the “kernel” and/or the “OS kernel”. For example, an OS kernel for an SMP OS provides all resource management services required for all applications directly executable on the OS as well as all combinations of those applications. The term “directly executable” as used herein refers to an application which can run without modification on a multi-core computer system using a conventional SMP OS, similar to system 10 shown in FIG. 1 without modification.

For example, the term “directly executable” would apply to an application which could run on a conventional multi-core computer processing system using an unmodified SMP OS. This term is intended to distinguish, for example, from an application that runs only a software abstraction, such a VMware virtual machine, which may be created by a host SMP OS but emulates a different OS within the VM environment in order run a software application which cannot not run directly on the host OS unless modified.

As described below in greater detail, an SMP OS kernel will likely include resource management services to manage contentions to prevent conflicts between activities occurring as a result of execution of a single application in part because the execution of that application may be distributed across multiple cores of a multi-core processor.

As a result, OS kernels, and particularly SMP OS kernels, include many complex resource management functions which utilize substantial processing cycles and include locks and other complex resource management functions which add to the processing used during execution and thereby offset many of the advantages of execution distributed across multiple cores. As described further herein, many improvements may be made by using one or more of techniques described herein, many of which may be used alone and/or in combination with other such techniques.

For example, techniques are disclosed providing for execution of applications in a particular group of applications to use application group specific resource management services in lieu of the more cumbersome OS kernel based resource services which are OS specific rather than related application specific. Further, such application group specific resource services may be located within the portion of memory in which the group of related applications, thereby further improving execution efficiency for example by reducing context or mode switching. This technique may be used alone or when combined with limiting execution of applications in a group of related applications to a single core of a multi-core processor in a computer system running an SMP OS. The technique allows operation of one core of a multi-core processor to execute an application simultaneously with the execution of a different software application another core of the multi-core processor.

A person of ordinary skill in the art of designing such systems will be able to understand how to use the techniques disclosed herein separately or in various combinations even if not such particular use is not separately described herein.

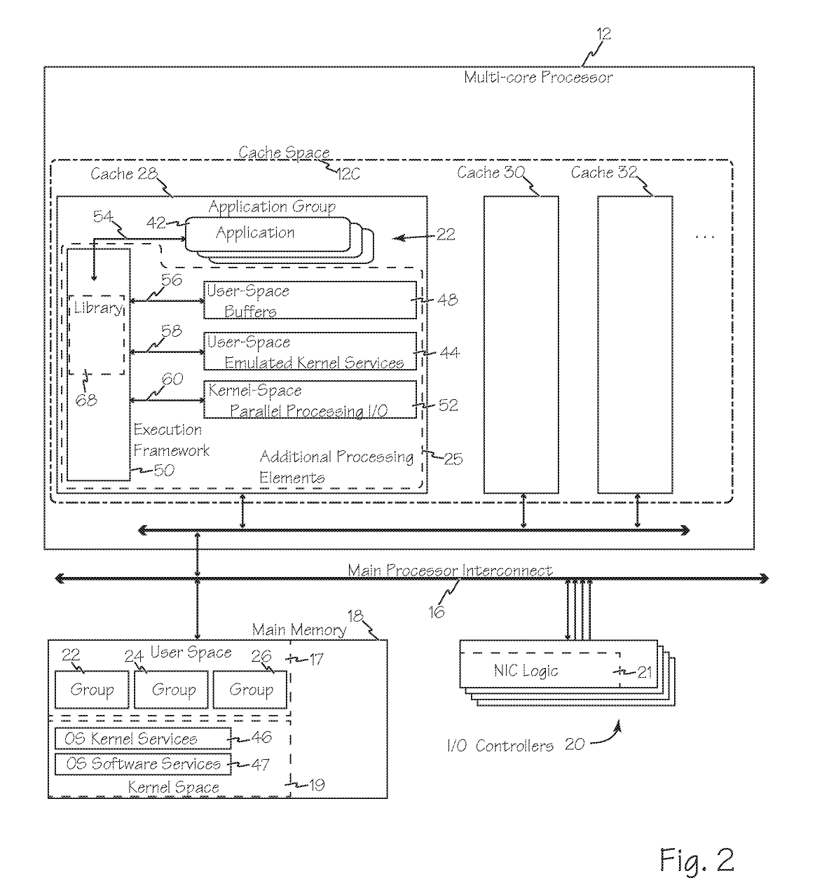

Referring now to FIG. 2, when an SMP OS is loaded and operating in multi-core computer processing system 10 of FIG. 1, the SMP OS loads resource management and allocation controls, such as OS kernel services 46 in kernel-space 19 of main memory 18 to manage resources and arbitrate contentions and the like, mediating between concurrently running applications and their shared processor/hardware resources. Main memory 18 may be implemented using any suitable technology such as DRAM, NVM, SRAM, Flash or others. Various software applications (and/or containers and/or app groups such as application groups 22, 24 and 26) may then be loaded, typically into user-space 17 of main memory 18, for processing. During processing a software application, such as application 42, software calls and system calls and the like as well as I/O and events are typically processed by kernel services 46 many times for the software application during its execution in order to provide the software application with kernel services and data while managing multi-core contentions and maintaining cache coherence with other kernel and/or software execution not related to the processing software application.

Additional processing elements 25, such as emulated kernel services 44, kernel-space parallel processing 52 and user-space buffers 48, may be loaded into user-space 17 and/or kernel space 19 of main memory 18, and/or otherwise made available for processing in one or more of the cores of at least one multi-core processor, such as core 0 multi-core processor 12, to substantially improve processing performance and processing time of software applications, software application groups, and containers running concurrently and/or sequentially under control of the SMP OS and its cores, and otherwise reduce processing overhead costs by at least selectively, if not substantially or even fully, reducing processing time (e.g., including processing time previously spent in waiting and blocking due to kernel locking and/or synchronization) related to OS kernel services 46 and/or I/O processing and/or event and interrupt processing and/or data processing and/or data movement and/or any processing related to servicing software applications, software app groups, and containers.

Additional processing elements 25 may also include, for example, elements which redirect software calls of various types to virtual or emulated, enhanced kernel services as well as maintaining cache coherence by operating some if not all of the cores 1 to n as parallel processing cores. These additional elements, for use in processing application group or container 22, may include emulated kernel services 44 and buffers 48, preferably loaded in user-space 17, execution framework 50 which may primarily loaded in user-space 17 with some portions that may be loaded in kernel space 19, as well as parallel processing I/O services which may preferably be loaded in kernel space 19.

As illustrated in FIG. 1 and FIG. 2, application group 22 may be processed solely on core 0, application group 24 may be processed on core 1 while application group 26 may be processed on core 2. In this way, cores 0, 1, 2 . . . n are operated as concurrently executing parallel processors. Each processor with its emulated and virtual services operating without contentions for one or more software applications independent of other cores' and their applications. In contrast to having one or more software applications processed across cores 0 . . . n operating symmetrically, e.g., operating sequentially. Additional processing elements 25 control low level hardware, such as each of the plurality of I/O or hardware controllers 20, so that I/O events and data related to the one or more software applications in group 22 are all directed to cache 28, used by core 0, so that cache locality may be optimized without the need to constantly synchronize caches (a source of overhead and contentions) via cache coherence protocols. The same is true for application group 24 processed by core 1 using cache 30 and application group 26 processed by core 2 using cache 32. The contents of the various caches in processor 12 reside in what may be called cache space 12c.

It is beneficial to organize software applications into application groups in accordance with the needs of the applications for kernel services, resource isolation/security requirements and the like so that the emulated, enhanced kernel services 44 used by each application group can be enhanced and tailored (either dynamically at run time or statically at compile time or a combined approach) specifically for the application group in question.

Each core is associated and operably connected with high speed memory in the form of one or more caches on the integrated circuit die. Core 0 has a high-speed connection to cache memory 28 for data transfers during processing of the one or more applications in application group 22 to optimize cache locality and minimize cache pollution. The emulated, enhance kernel services provided for application group 22 may be an enhanced/optimized related subset of similar (functionally and/or interface agnostic) kernels services that would otherwise be provided by OS kernel services.

However, if the applications in group 22 require extensive memory-based data transfer or data communication services among themselves (and are less likely to require some other, potentially contention rich and/or processing intensive kernel services), the emulated, services related to group 22 may be optimized for such transfers. An example of such data transfers would be inter-process communication (IPC) among software (Unix®/Linux®) processes of the applications group 22. Further, the fact that cache locality may be maintained in cache 28 for applications in group 22 means that, to some extent, data transfers and the like may be made directly from and within cache 28 under control of core 0 rather than requiring further, processing and communication intensive overhead costs including communication between caches of different cores using cache coherence protocols.

The contents of group 22 are allocated in portions of user-space 17 along with some application code and data, and/or kernel-space 19 of main memory 18. Various portions of the contents of application group 22 may reside at the same or different times in cache 28 of cache space 12c while one or more applications 42 of application group 22 are being processed by core 0 of processor 12. Application group 22 may include a plurality of related (e.g., inter-dependent, inter-communicating) software applications, such as application 42 selected for inclusion in group 22 at least in part because the resource allocation and management requirements of these applications are similar or otherwise related to each other so that processing grouped applications in emulated kernel services 44 may be beneficially enhanced or optimized compared to traditional processing of such applications in OS kernel services 46, e.g., by reducing processing overhead requirements such as time and resources due to logical and physical inter-cache communications for data transfers and kernel-related synchronizations (e.g., locking via spinlocks).

For example, the kernel services and processing required for resource and contention management, resource scheduling, and system calls processing for applications 42 in group 22 in emulated kernel services and processing element 44 (e.g., implemented via emulated system calls and their associated kernel processing) may only be a semantically and functionally/behaviorally equivalent subset of those that must be included in conventional OS kernel services 46 to accommodate all system calls. These included and emulated services and kernel processing would be designed and implemented to avoid the overheads and limitations (e.g., contentions, non-locality of caches, inter-cache communications, and kernel synchronizations) of the corresponding conventional OS 46 services and processing (e.g., original system calls). In particular, conventional (SMP) OS kernel services 46 must include all resource management and allocation and contention management service services and system calls and the like known to be required by any software application to be run on the host OS of multi-core computer processing system 10, such as SMP Linux® OS.

That is, OS kernel services 46, typically loaded in kernel space 19 and running in the unrestricted “privileged mode” on the processors of processor system 10 must include all the types of network stacks, event notifications, virtual file systems (e.g., VFS), file systems and for synchronization, all the types of various kernel locks used in traditional SMP OS kernel-space for mutual exclusion and protected/atomic execution of critical code segments. Such locks may include spin locks, sequential locks and read-compare-update (RCU) mechanisms which may add substantial processing and synchronization overhead time and costs when used to process, resource-manage and schedule all user-space applications that must be processed in a conventional multi-processor and/or multi-core computer system.

Emulated or virtual kernel services 44 may include a semantically and behaviorally equivalent but optimized, re-architected, re-implemented and reduced (optional) set of kernel-like services/processing and OS system calls requiring (but not only limited to) substantially few, if any, of the locks and similar processing intensive synchronization mechanisms, and much less actual synchronization and cache coherent protocol traffic and non-local (core-wise) processing and the like required and encountered in conventional OS kernel services 46.

Conventional, unmodified software applications are typically loaded in user-space 17 to prevent their execution from affecting or altering the operation of OS kernel services 46 in kernel space 19 and in some privileged mode of multi-core processor and/or multi-processor system.

For example, two representative, processing intensive, activities that occur during execution of software application(s) 42 in application group 22, and any other concurrently running application groups such as groups 24 and 26 in user-space 17, i.e., using SMP OS kernel services 46 in kernel space 19, will first be discussed. SMP processing, that is symmetrical multi-processing through a single SMP-based OS 46 executing over cores 1 to n of processors 12 and 14 to resource-manage concurrently executing applications groups 22, 24, 26 etc. on both processors for improving software/execution parallelism and core utilization incurs substantial processing, synchronization and cache coherence overheads for resource-managing and arbitrating cores' execution (at each time instance each core executing either kernel thread, or application thread) as well as scheduling and constant mode switching. These various processing overheads and limitations are compounded by mode switching, i.e. switching between processing in user-space 17 and processing in kernel-space 19, and copying data across the different spaces.

However, because applications 42 in group 22 have related resource allocation and management requirements, most if not all of which may be provided in emulated kernel services 44 in conjunction with conventional OS services 46 (for those services not emulated), kernel service processing time may be substantially reduced. Because emulated kernel services 44 may be processing in user-space 17, substantial mode switching may be avoided. Because application group 22 is constrained, for example, to process locally on a single core, such as core 0 of processor 12, synchronization, scheduling for data and other cache transfers between cores 1 to n to maintain cache coherency such transfers, non-local processing (e.g., OS kernel services executing on one core while app group on another core as in SMP OS kernel services 46) and related mode switching may be substantially reduced.

Still further, parallel processing I/O 52, which may be partly or wholly loaded in kernel-space 19, dynamically instructs controllers 20 to use their hardware functionalities to direct I/O and events and related data and the like specifically destined for application group 22 from controllers 20 related to application group 22 without invoking software processing (conventionally done in SMP OS kernel) in the actual actions (data-path) of directing and moving those I/O, events, data, metadata, etc. to application 22 and its associated execution framework 50 and so on in user-space. Dynamic instruction of controllers 20 is accomplished by processing the software behavior of application group 22 via control-plane like operations such as programming hardware tables. This helps maximize local processing while minimizing cache pollution and SMP OS related processing/synchronization overheads and permits faster I/O transfers. For example from one of I/O controllers 20 directly to cache 28 by data direct I/O (DDIO). Similarly, data transfers related to application group 22 from main memory 18 can also be made directly to cache 28, associated with core 0.

Some processing time is required for execution framework 50 to coordinate and schedule these activities. A conventional host SMP OS includes, creates and/or otherwise controls facilities which direct software calls and the like (e.g., system calls) between applications 42 and the appropriate destinations and vice versa, e.g., from applications 42 to and from OS kernel services 46. Execution framework 50 may include corresponding facilities (through path 54) which supersede the related host OS, system, call direction facilities to redirect such calls, for example, to emulated kernel services 44 via paths 54 and 58. For example, execution framework 50 can implement a selective system call interception to intercept and respond to specifically pre-determined system calls called by applications 42 using emulated kernel services 44, thereby providing functionally/behaviorally invariant kernel-emulating services 44.

Execution framework 50, for example via a portion thereof loaded in kernel-space 19, may intercept and/or direct I/O data and events from parallel processing I/O 52 on path 60 to core 0 of processor 12.

Software (system) calls initiated by applications 42 on path 54 may first be directed by execution framework 50 via path 56 to one or more sets of input and output buffers 48 which may be thereby be used to reducing processing overhead, for example, by application and/or group specific batch processing calls, data and events. For example, execution framework 50 and buffers 48 may change (minimize) the number of software calls from applications 42 to various destinations to more efficiently process the execution of such calls by reducing mode switching, data copying and other, application and/or group specific techniques. This is a form of transparent call batching enabled by the execution framework 50, where transparency means applications 42 don't need to be modified or re-compiled and therefore this batching is binary compatible.

Application groups 24 and 26 may each execute on a single core, such as cores 1 and 2, respectively, and each may include different or similar groups of related applications as well as sets of input and output buffers, emulated kernel services, parallel processing I/O and execution framework facilities appropriate for the associated application group.

By design and implementation, I/O buffers 48 in user-space, emulated kernel services 44, parallel processing I/O 52 and execution framework 50 and other facilities appropriate for the associated application groups should have minimal interference (e.g., cache coherency traffic, synchronization, and non-locality etc.) with each other as they execute on their respective CPU cores. This is different from conventional design and implementation of SMP OS such as Linux® where those corresponding interference is common.

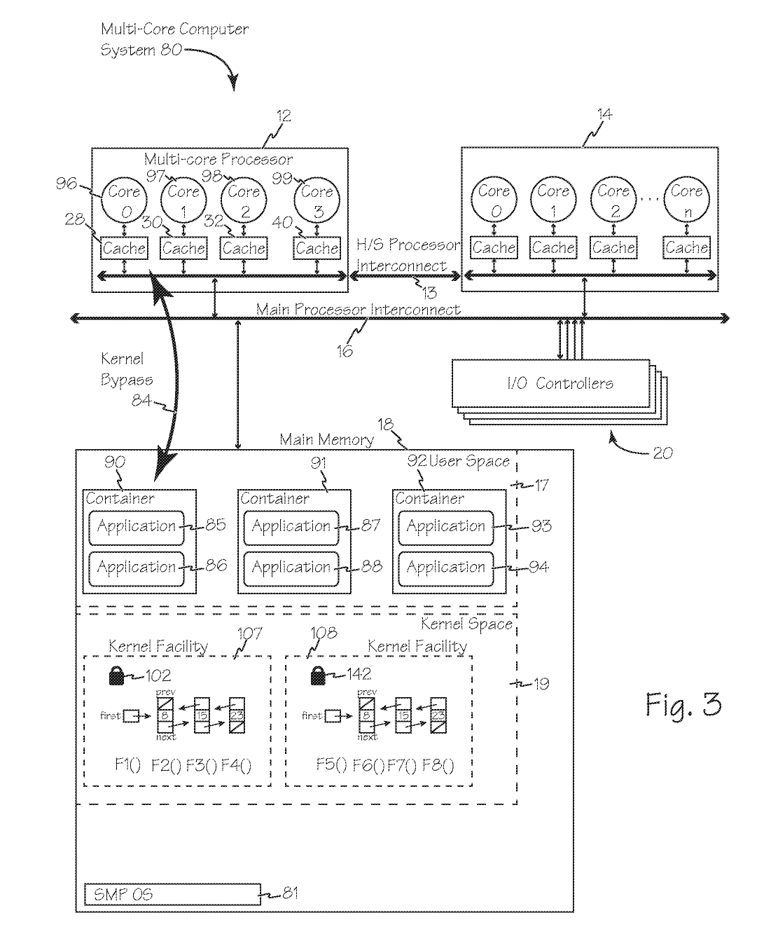

Referring now to FIG. 3, methods and apparatus for an improved computer architecture, such as computer system 80, are disclosed in which at least some of the operating system (OS) services of symmetrical processing or SMP OS 81, generally provided by OS programming and processing in kernel-space 19 of main memory 18, such as DRAM, are provided in user-space 17 of main memory 18 by software programming and processing. For convenience, such programming and processing may be called user-space emulated kernel services such as emulated kernel services 44 of FIG. 2. Such user-space emulated kernel services, when executing on a particular processing core, may redirect software calls, e.g. system calls, traditionally directed to or from OS kernel-space services 81, for example, to one or more processing cores of processor 12 for execution without the use of the OS kernel-space services 81 or at least with reduce use thereof.

This emulation approach is illustrated as kernel bypass 84 and, even on a single processor core, may save substantial computing overhead by reducing processing overhead, such as mode switching and the associated data copying between the two contexts, required to switch between user-space and kernel-space contexts. For example, the user-space kernel services may operate on such software calls in an enhanced, optimized or at least more efficient manner by batching calls, limiting data copying and the like further reducing the overhead of conventional SMP operating systems.

In particular, user-space kernel service emulation may beneficially redirect software calls to and from a particular software application to a particular one or more processor cores. In some SMP OSs, groups of related software applications such as applications 85 and 86, may be segregated in a particular application group, such as container 90, from one or more other software applications which may or may not also be segregated in another application group, such as container 91. Kernel bypass 84, kernel emulation, may beneficially be used with such separate software applications, application groups as well as with a combination thereof.

Regarding in general the distinction between user-space 17 and kernel-space 19, the host OS generally provides facilities, processing and data structures in kernel-space to contain resource allocation controls (for software processes operating outside of kernel space), such as network stacks, event notifications, virtual file systems (VFS). The facilities provided by the host OS are concurrently shared among all the processor cores such as cores.

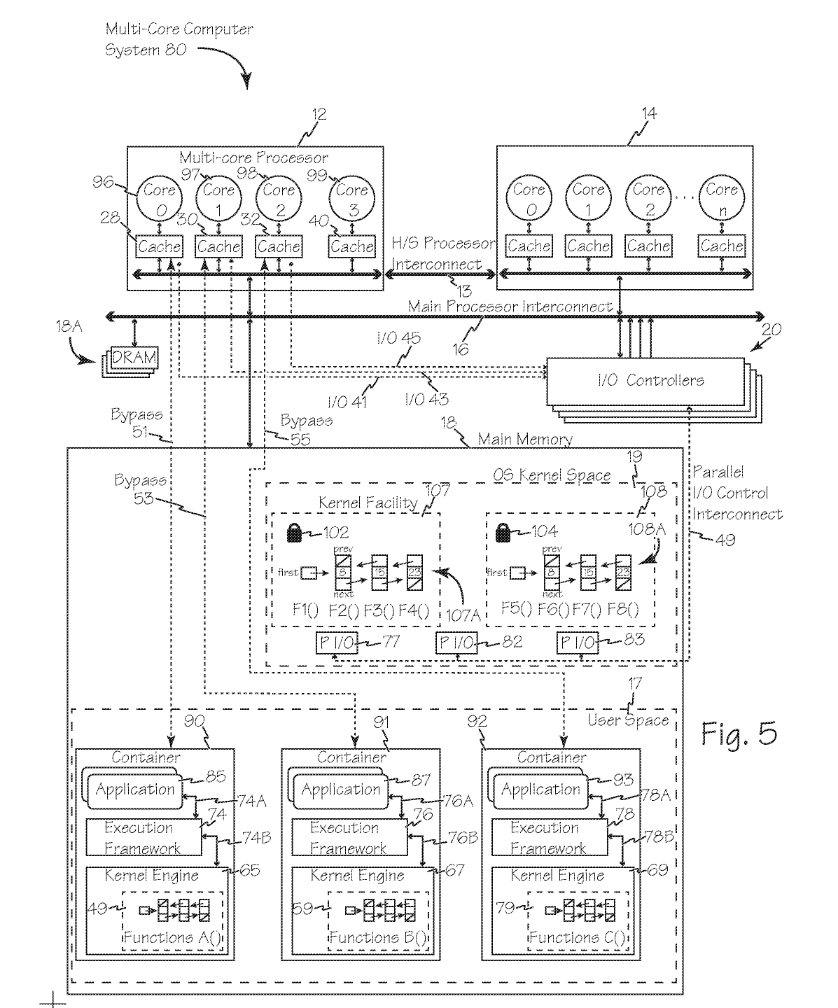

User-space 17 provides an area outside of kernel-space 19 for execution of software programs so that such execution does not interfere with the resource management and synchronization of execution of code segments and other resource management facilities in kernel-space 19, e.g., user-space process execution is prevented from directly altering the code, data structures or other aspects. In a single core processor all data and the like resulting from execution of processes in user-space 17 may traditionally be prevented from directly altering facilities provided by the OS in kernel-space 19. Further all such data and the like resulting from execution of processes in user-space 17, requiring access to OS kernel resources such as kernel facilities 107 and 108 and hardware I/O 20, may be made to transfer such data to kernel space 19 via data copying and mode switching. Kernel bypass 84 may substantially reduce the overhead costs of at least some of data copying and mode switching and thereby reducing, to the extent processing of such data, and the like, utilize user-space emulated kernel services 44, and/or kernel space parallel processing 54 (both shown in FIG. 5) for kernel resources in lieu of OS kernel resources.

One aspect of processing overhead cost associated with transfers of data between processes (executing in user-space), and their resources via kernel-space facilities, is mode switching between user-space and kernel space associated with data copying which is generally implemented as system calls. In particular, processes executing in user-space are actually executing in a processor core with associated core cache(s) to the extent permitted by locality and cache sizes. Thereafter, when user-space processed request OS services such as through system calls, resource management required for such data and the like in kernel-space facilities requires core processing time. As a result, a change operation of the core from processes/applications execution to resource management execution in the operating system requires processing time to move data in and out of the cache(s) related to the processor core performing such execution and switching from user-space to kernel-space and back. These overhead costs may be called mode switching.

In an operating system, such as SMP OS 81, the required executions of software processes in user-space 17 and resource management processes and the like in kernel-space 19 are typically symmetrically and concurrently multi-processed across multiple cores. For example, multi-core processor chip 12 may include cores 96, 97, 98 and 99 on a single die or chip. As a result, mode switching may be somewhat reduced but is still an overhead cost during process execution.

Another and substantial processing overhead cost comes from traditional resource management. For example, traditional kernel facilities process at least some, if not most, of the data and the like to be allocated to resources to be processed in a sequential fashion. For a simple example, if execution of processes during SMP processing requires main memory resources, sequential or serial resource allocation may be required to make sure that contentions from concurrent attempts to access main memory are managed and conflicts resolved and prevented.

A traditional technique for managing contentions due to synchronization and multiple accesses to prevent conflicts such as attempting to read and to write data simultaneously are locks, such as lock 102 in traditional kernel facility 107 and lock 104 in traditional kernel facility 108. These and other mechanisms in traditional kernel space facilities are used to resolve and prevent concurrent access to kernel data structures and other kernel facilities such as kernel functions F1( ) through F4( ) in facility 107 and functions F5( ) through F8( ) in facility 108.

The distinction between user-space 17 and groups of related software processes and/or containers 90 and 92 may be generally described in light of the discussion above. Containers 90, 91 and 92 operate as kernel-managed resource isolation in which execution of processes may be provided in a manner in which process execution in one such container does not interfere with, contaminate (in a security and resource sense) and/or provide access to processes executing in other containers. Containers may be considered smaller resource isolation and security sandboxes used to divide up the larger sandbox of user-space 17. Alternately, containers 90, 91 and 92 may be considered to be, and/or implemented to be, multiple and at least partially separate versions of user-space 17.

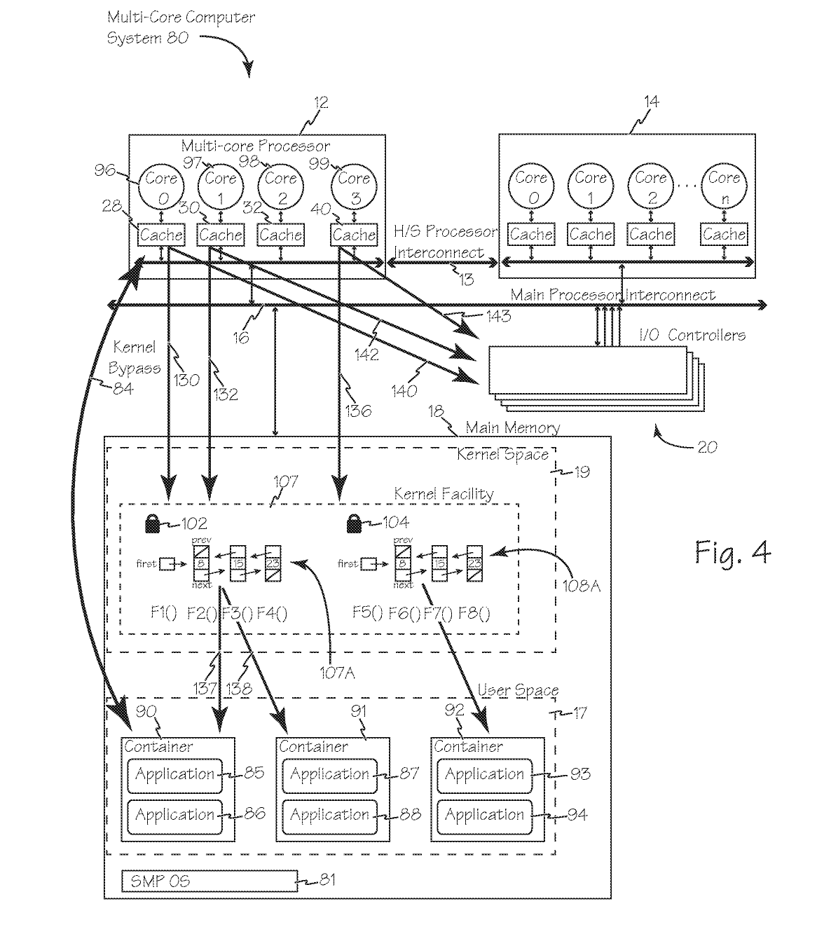

As discussed below in more detail with respect to FIGS. 4 and 5, each container may include a group of applications related to each other, for example with regard to resource allocation, contention management and application security that would be implemented during traditional kernel space 19 processing and resource management. For example, applications 85 and 86 may be grouped in container 90 in whole and/or in part because both such applications may require the use of functions F1( ) and F2( ). Applications 87 and 88 may be grouped in container 91 in whole and/or in part because both such applications may require the use of functions F2( ) and F3( ). As discussed above locks and other mechanisms in traditional kernel space facilities are used to resolve and prevent concurrent access to kernel data structures, facilities and functions.

It may be beneficial to group such applications in different application groups especially if for example, a kernel facility can be formed for use by container 90 which performs functions F1( ) and F2( ), without having to perform functions F3( ) and/or F4( ), more efficiently than kernel space facility 107, for example by not requiring as much if any use of kernel space locks or similar mechanisms such as lock 102, and/or a kernel facility can be formed for use by container 91 which performs functions F5( ) and F6( ), without having to perform functions F7( ) and/or F8( ), more efficiently than kernel space facility 107, for example by not requiring as much if any use of kernel space locks or similar mechanisms such as lock 104.

When a group of related applications, related by resource allocation, cache/core locality and contention managements functions required, as shown for example by applications 85 and 86 in container 90, at least some of the processing overhead costs such as cache line bouncing, cache updates, kernel synchronization and contentions may be reduced by providing the required kernel functions in a non-kernel-space facility as part of kernel bypass 84. Similarly, when a group of applications, related by their requirements for OS kernel resources, e.g. resource allocation, cache/core locality and contention managements functions required, for shown for example by applications 87 and 88 in container 91, at least some of the processing overhead costs such as cache line bouncing, cache updates, kernel synchronization for cache contents and contentions may be reduced by providing the required kernel functions in a non-kernel-space facility as part of kernel bypass 84.

In some operating systems, e.g. the Linux® OS, it may be possible to dynamically add additional software to kernel-space without requiring kernel code to be modified and recompiled. Adding non-native OS kernel services, not specifically shown in this figure, may be beneficially provided in kernel-space, e.g., related to I/O signals. When executing on a particular processor core such as core 96, non-native OS kernel services in kernel-space, in addition to kernel space services 107 and 108, are useful to direct I/O signals, data, metadata, events and the like related to one or more particular software applications, to or from one or more specific processing cores.

When user-space kernel services 107 and 108 and non-native OS space kernel services are both used, software calls, hardware events, data, metadata and other signals, specific to application 85 or group 90, may be redirected to a particular processing core, such as core 96, so that application 85 or group 90 runs exclusively on processing core 96. This is referred to as locality of processing. Similarly, application 87 or group 91 may be caused to run exclusively on a different processing core, such as core 97, in parallel with running application 85 on core 96.

That is, in a computer with multi-processors, and/or multicore processors running an SMP OS 81, such as Linux® and the like, application software such as applications 85 and 86 in container 90, application 87 and 88 in container 91 and applications 93 and 94 in container 92, written for execution on SMP OS 81 may be executed in a parallel fashion on different ones such multiple processors or cores. Advantageously, neither the application software 85, 86, 87, 88, 93 and/or 94 nor SMP OS 81 have to be changed in a manner requiring recompiling that software, thereby providing binary invariance for both applications and OSs. This approach may be considered an application and/or application group specific kernel bypass with parallel processing including OS emulations and it produces substantial reductions in processing overhead as well as improvements in scalability and the like.

As a result, distributed and parallel computing and apparatus and methods for efficiently executing software programs may be achieved in a server OS, such as SMP OS 81 using groups of related processes of software programs, e.g., in containers 90, 91 and 92 over modern shared-memory processors and their shared-memory clusters.

The architectural, implementation, performance, and scalability limitations of traditional SMP OS in virtualizing and executing software programs over shared-memory, multi-core processors and their clusters. Such improvements may involve what may be called micro-virtualization, i.e., operating within an OS level virtualized container or similar groups of related applications. Such improvements may include an execution framework and its software execution units (emulated kernel facilities engines, typically and primarily in user-space) that together transparently intercept, execute, and accelerate software programs' instructions and software calls to maximize compute and I/O parallelism, software programs' concurrency, and software flexibility so that a SMP OS's resource contentions and bottlenecks from its kernel shared facilities, shared data structures, and shared resources—traditionally protected by kernel synchronization mechanisms—are optimized away and/or minimized. Also, through these methods, mode-switching and data copying related and other OS related processing overheads encountered in the traditional SMP OS may be minimized when executing software programs. The results are core/processor scalable, more processor efficient, and higher performance executions of software programs in SMP OSs and their associated OS-level virtualization environments (e.g. containers) over modern shared-memory processors and processor clusters, without modifications to existing SMP OSs and software programs.

Techniques for executing software programs, within groups of related applications such as virtualized containers, unmodified (i.e., in standard binary and without re-compilation)—may be achieved at high performance and with high processor utilization—in an SMP OS and its OS-level virtualization environment (e.g., or other techniques for forming groups of related applications). Each group may be executed, at least with regard to traditional OS kernel processing, in an enhanced or preferably at least partially or fully optimized manner by use of application group specific, emulated kernel facilities to provide resource isolation in such containers or application groups, rather than using OS based kernel facilities, typically in kernel-space which are not specific for the application or groups of applications.

Modern Linux® OS (version 3.8 and onward) and Docker® are examples of SMP OS with OS-level virtualization facilities (e.g., Linux® namespaces and cgroups) used to group applications, and packaging and management framework for OS-level virtualization, respectively. Often, OS-level virtualization is broadly called “container” based virtualization, as opposed to the virtual machine (VM) based virtualization from of VMware®, KVM and the like. (Docker is a registered trademark of Docker, Inc., VMware is a registered trademark of VMware, Inc.)

Techniques are disclosed to improve scaling and to increase performance and control of OS-level virtualization in a shared-memory multi-core processors, and to minimize OS kernel contentions, performance constraints, and architectural limitations imposed by a today's Unix-like SMP OS (e.g., Linux) and its kernel facilities—in performing OS-level virtualization and running software programs in application groups, such as containers, over modern shared-memory processor architecture, in which many processor cores, both on processor die and between interconnected processor dies, are managed by the SMP OS which is in turn supported by the underlying hardware-driven cache coherence.

These techniques include three primary methods and/or architectural components.

1. Micro-virtualization engines may perform call-by-call and/or instruction-by-instruction level processing for OS-level virtualization containers and their software programs, effectively replacing software calls processing traditionally handled by a SMP OS kernel and its kernel facilities, e.g., network stack, event notifications, virtual file system (VFS), etc. These user-space micro-virtualization engines may be instantiated for, and bound to, user-space OS-level virtualization containers and their software programs, such that during the containers' execution, software programs initiated library calls, system calls (e.g., wrapped in library calls), and program instructions traditionally processed by the OS kernel or otherwise (e.g., standard or proprietary libraries) are instead fully or selectively processed by the micro-virtualization engines. Conversely, traditional OS event notifications or call-backs (including interrupts) normally delivered by the OS kernel to the containers and their software programs are instead selectively or fully delivered by the micro-virtualization engines to the running containers.

2. A micro-virtualization execution framework may transparently and in real-time intercepts system calls, and function and library calls initiated by the virtualization containers and their software programs during their execution, and diverts these software calls to be processed by the above micro-virtualization engines, instead of by traditional means such as OS kernel, or standard and proprietary software libraries, etc. Conversely, traditional OS event notifications or call-backs (e.g., interrupts) delivered by the OS kernel to the containers and their software programs are instead selectively or fully delivered by the micro-virtualization framework and the micro-virtualization engines to the running containers and their software programs.

3. Parallel I/O and event engines move and process I/O data (e.g., network packets, storage blocks) and hardware or software events (e.g., interrupts, and I/O events) directly from low-level hardware to user-space micro-virtualization engines running on specific processor cores or processors, to maximize data and event parallelism over interconnected processor cores, and to minimize OS kernel contentions and to bypass OS kernel and its data copying and movement and processing, imposed by the architecture of traditional SMP OS kernel running over shared-memory processor cores and processors.

The execution framework intercepts software calls (e.g., library and system calls) initiated by the virtualization containers and their software programs during their execution, and diverts their processing to the high-performance micro-virtualization engines, all in user-space without switching or trapping into the OS kernel, which is the conventional routes taken by system and library calls. Micro-virtualization engines also deliver events and call backs to the running containers, instead of the traditional delivery by the OS kernel. Parallel I/O and event engines further move data between the user-space micro-virtualization engines and the low-level hardware, bypassing the traditional SMP OS kernel entirely, and enabling data and event parallelism and concurrency.

In shared-memory processor cores and processors, one or more micro-virtualization engines can be instantiated and bound to each processor core and each container (running on the core), for example, with a corresponding set of parallel I/O and event engines that move data and events between I/O hardware and micro-virtualization engines. These micro-virtualization engines, through their micro-virtualization execution framework, can process selective or all software calls, events, and call backs for the container(s) specific to a processor core. In this way, execution, data, and event parallelization and parallelism are maximized over containers running over many cores, and relative to the handling and software execution of traditional contention-limiting SMP OS kernel, which contains many synchronization points to protect kernel data and execution over processor cores in SMP.

Effectively, each container can have its own micro-virtualization engines and parallel IO/event engines, under the overall management of the micro-virtualization execution framework. Processing and I/O events of each container can proceed in parallel to those of any other container, to the extent allowed by the nature of the software programs (e.g., their system calls) encapsulated in the containers and the specific implementations of the micro-virtualization engines. This level of container-based parallelism over shared-memory processor cores or processors can reduce contentions in a traditional lock-centric and monolithic SMP OS kernel like Linux®.

In this way, a container's software execution and I/O and events may be decoupled from those of another container, over all containers running in an OS-level virtualization environment, and from the traditional shared and contention-limiting SMP OS facilities and data structures, and can proceed in parallel with minimized contention and increased parallelism, even as the number of containers and even as the number of processor cores (and/or interconnected processors) increase with advances in processor technology and processor manufacturing.

Software programs to be virtualized as container(s) may not need to be re-compiled, and can be executed as they are, by micro-virtualization. Furthermore, to support micro-virtualization, no re-compilation of today's SMP OS kernel is expected, and dynamically loadable kernel modules (e.g., in Linux) may be used. Micro-virtualization is expected to be transparent and non-intrusive during deployment, and all components of micro-virtualization can be dynamically loaded into an existing SMP OS with OS-level virtualization support.

Techniques are provided for virtualizing and executing software programs unmodified (standard binary; without re-compilation)—at high performance, with high processor utilization, and core/processor scalable—in an SMP OS and its OS-level virtualization environment. OS-level virtualization refers to virtualization technology in which OS kernel facilities provide OS resource isolation and other virtualization-related configuration and execution capabilities so that generic software programs can be virtualized as groups of related software applications, e.g., containers, running in the user-space of the OS. Modern Linux® OS (kernel version 3.8 and onward) and Docker® are examples of SMP OS with OS-level virtualization facilities (e.g., Linux® namespaces and cgroups), and packaging and management framework for OS-level virtualization, respectively. Often, OS-level virtualization may broadly called “containers”, as opposed to the VMs based virtualization of the earlier generation of server virtualization from the likes of VMware® and KVM, etc. (VMware® is a registered trademark of VMware, Inc.). Although the following discussion illustrates an embodiment implemented on a Linux® OS in which containers are created, or virtualized, for groups of software applications, the described techniques are applicable to other SMP OS systems.

Techniques are provided to scale and to increase the performance and the control of OS-level virtualization of software programs in shared-memory multi-core processors, and to minimize OS kernel contentions, performance constraints, and architectural limitations—imposed by conventional Unix®-like SMP OS (e.g., Linux®) and its kernel facilities—in performing OS-level virtualization and running virtualized software programs (containers) over modern shared-memory processor architecture, in which many processor cores, both on the processor die and between interconnected processor dies, are managed by the SMP OS which is in turn supported by the underlying hardware-driven cache coherence.

Referring now more specifically to FIG. 3, conventional shared-memory 18 and server processor 18, such as an Intel Xeon® processor, typically integrate multiple (4 or more) processor cores such as cores 96, 97, 98 and 99 on a single processor die, with each processor core 96, 97, 98 and 99 endowed with one or more multiple levels of local and shared caches 28, 30, 32 and 40, respectively. Cache coherence is preferably maintained for all on die core caches 28, 30, 32 and 40 and between all on-die caches and main memory 18. Cache coherence can preferably be maintained across multiple processor dies and their associated caches and memories via high-speed inter-processor interconnects (e.g., Intel QuickPath Interface) or QPI) and hardware-based cache coherence control and protocols, not shown in this figure.

In this type of hardware configuration, usually a single Unix-like OS 81 (e.g., Linux) executing in SMP OS mode traditionally runs on and manages all processor cores and interconnected processors in their shared memory domain. Traditional SMP OS 81 offers a simple and standard interface for scheduling and running software processes and/or programs such as applications 85, 86, 87, 88, 93 and 94 (Unix/OS processes) in user-space 17 over the shared-memory domain, main memory or DRAM 18.

Main memory 18 includes kernel-space 19 which has a plurality of software elements for managing software contentions, including for example kernel structures 107 and 108. A plurality of locks 102 and 104 and similar structures are typically provided for synchronization in each such contention management element 107 and 108, together with other software elements and structure to manage such contentions, for example, using functions F1( ) to F8( ).

Techniques are discussed below in greater detail with regard to other figures to effectively bypass the OS kernel services 107 and 108 (and others) in kernel-space 19, as illustrated by conceptual bi-directional arrow 84, to substantially reduce processing overhead caused, for example, by processing illustrated for example as kernel functions F1( ) to F8( ) and the like, as well as delays and wasted processor cycles caused for example, by locks such as locks 102 and 104. Although some OS kernel services or functions may not be bypassed in some instances, even bypassing some of the OS kernel services may well provide a substantial reduction in processing overhead of computer system 80. As a corollary, by benchmarking and investigating what conventional kernel services are most contention and lock prone, emulated kernel services (in user-space) can be designed and implemented to minimize the overhead of conventional kernel services.

Referring now to FIG. 4, computer processing system 80 includes SMP OS 81 stored primarily in kernel-space 19 of main memory 18 and executing on multi-core processor 12 to manage multiple, shared-memory processor cores 96, 97, 98 and 99 to execute applications 85 and 86 in container 90, application 87 in container 91, as well as applications 93 and 94 in container 92. SMP OS 81 may traditionally manage multiple and concurrent threads of program execution in user-space or context 17 and/or kernel context or space 19 on all processor cores 96, 97, 98 and 99. The resultant multiple and concurrent kernel threads of execution shared among all cores are managed for contention by OS kernel data structures 107A and 108A in shared, common kernel facility 107 of kernel-space 19.

For synchronization, various types of kernel locks 102 and 104 are commonly used in traditional SMP OS kernel-space 19 (e.g., in Linux® OS) for mutual exclusion and protected/atomic execution of critical code segments. Conventional kernel locks 102 and 104 may include spin locks, sequential locks, and RCU mechanisms, and the like.

As more processor cores and more software programs (e.g., standard OS/Unix® processes) such as related processes 85 and 86 in container or application group 90, process 87 in container or application group 91, and related processes 93 and 94 in container or application group 92 are conventionally all managed by SMP OS 81 services in kernel-space 19 resulting in increasing processing overhead costs and performance limitations due for example to locks 102 and 104 locking operations and the like.

One example of the overhead processing costs is illustrated by cache line bouncing 130 and 132 in which more than one set of data tries to get through kernel facility 107 at the same time. If contention-limiting SMP OS facilities and data structures 107A, in kernel facility 107, are used for applications in both container 90 and container 91, cache line bouncing may occur. At some point in time during operation of SMP OS 81, core 96 may happen to be processing in cache(s) 28 some data or a call or event or the like, which would then normally be transferred over cache line 130 to be managed for contention in SMP OS facilities and data structures 107A.

At that same time, however, container 91 may also happen to be processing in cache(s) 30 some data or a call or event or the like, which would then normally be transferred over cache line 132 to be managed for contention in the same SMP OS facilities and data structures 107A. SMP OS facilities and data structures 107A and 108A are designed so that it cannot and probably will not try to process two data and/or call and/or events at the same time. Under some circumstances, one of cache lines 130 or 132 may succeed in transferring information to SMP OS facilities and data structures 107A and 108A for contention management for example if one such cache line is faster, has more priority or other similar reason. Under many circumstances, however, neither cache line may be able to get through and both cache lines 130 and 132 may be said to bounce, that is, not be accepted by the targeted SMP OS facilities and data structures 107A and 108A. As a result, the operations of cache lines 130 and 132 have to be repeated later, resulting in an unwanted increase in processing overhead.

However, even if at the same time, core 99 may also happen to be processing in cache(s) 40 some data or a call or event or the like, which would then normally be transferred over cache line 136 to be managed for contention in SMP OS facilities and data structures 108A, there would be no problem. In SMP processing, the processing is attempted to be symmetrically spread across all the cores, i.e., cores 96, 97, 98 and 99 of processor 12. As a result, it's hard to manage or reduce such cache line bouncing because it may be very difficult to predict which core is processing which container and when information must be transferred over a cache line.

Even when protected, execution of critical (atomic) code segments, protected by kernel services in kernel facility 107, contentions in information flow from kernel facility 107 to containers 90, 91 and 92 may would grow exponentially, leading to substantial contentions; for example contentions 137 in container 90 and contentions 138 in container 91 which add to processing overhead. While kernel contentions increase, program and software concurrency decrease, because some cores have to wait for some other cores to finish protected and atomic accesses and executions. That is, the data required for action by core 96 may be in cache 30 rather than in cache 28 when needed by core 96, resulting in time delays and additional data transfers. Kernel bypass 84 may reduce at least some of these contentions, for example non-I/O based contentions, by emulating at least a portion of kernel facility 107 in user-space 17 as shown in more detail below with regard to FIG. 5.

Further, the movement of high-speed I/O data and events, such as I/O data and events 140, 142 and 143, moving low level hardware controllers 20 (e.g., network controllers, storage controllers, and the like) and software programs 85 and 86 in application group 90, application 87 in application group 91, and applications 93 and 94 in application group 94, causes further increases in contentions, such as contentions 137 and 138.

The problem of increasing kernel concurrency problems and overhead costs is particularly troublesome in conventional SMP processing in which there are no guarantees that local (core) I/O processing I/O data and events 140 and 142, such as interrupt processing and direct memory access (DMA), will be executed on the same core(s) as that on which software programs 85 and 86, in container 90, software program 87 in container 91, and software programs 93 and 94, in container 92, ultimately process those data and events. This uncertainty results in cache bouncing as well as processing overhead costs to maintain cache coherence. Again, as the number of cores and containers increase, these I/O and event related cache updates may increase exponentially, compounded by the ever increasing speed of I/O and events to/from I/O hardware 20.

Referring now to FIG. 5, multi-core computer processing system 80 includes at least one or more multi-core processors such as processors 12 and 14, a plurality of I/O controllers 20 and main memory 18, all of which are interconnected by connection to main processor interconnect 16. Some of the elements discussed here with regard to main memory 18 as processed, illustrated for example as main memory portions may also be included in, or assisted by, other hardware and/or firmware components (not shown in this figure) such as an external co-processor, firmware and/or included within multi-core processor 12 or provided by other hardware, firmware or memory components including supplemental memory such as DRAM 18A and the like.

An image of at least a portion of the software programming present in main memory 18 is illustrated in kernel space 19 and user space 17 which is shown as a rectangular containers. Main memory is conceptually divided into OS kernel-space 19 with OS kernel facilities 107 and 108 which have been loaded by the host OS, e.g. SMP Linux®.

Main memory includes user-space 17, a portion of is illustrated as including software programs which have been loaded (e.g., for the user) such as word processors, browsers, spreadsheets and the like illustrated by applications 85, 87 and 93. As shown in this figure, these user software applications are separated into applications groups which are organized, for example as SMP Linux® host OS containers 90, 91 and 92 respectively. These applications or the application groups in containers 90, 91 and 92 may be groups of related applications and processes organized in any other suitable paradigm other than in containers as illustrated. It must be noted that such groups of related applications may have more than one application in some or all of these application groups as shown in various figures herein. Only one application per application group is depicted in this figure for clarity of the figure and related descriptions.

As will be discussed in greater detail below, kernel bypass facilities primarily active upon application execution are also illustrated in main memory in user-space 17, such as engines 65, 67 and 69, together with execution framework portions 74, 76 and 78 organized within application groups or containers 90, 91 and 92, respectively, as shown in the figure. OS kernel facilities such as OS kernel facilities 107 and 108 are loaded by the host OS for system 80, e.g., Linux SMP OS8, in OS kernel-space 19. Bypass facilities are also provided in OS kernel-space 19 such as parallel I/O 77, 82 and 83.

During operation of computer processing system 80, portions of the applications, engines and facilities stored in main memory 18 are loaded via main processor interconnect 16 into cache(s) 28, 30, 32 and 40 which are connected to cores 96, 97, 98 and 99, respectively. During execution of user software applications, e.g., applications 85, 87 and 93, other portions of the full main memory, illustrated in this figure as main memory 18, may be loaded under the direction of the appropriate core or cores of multi-processor 12 and are transferred via main processor interconnect 16 to the appropriated cache or caches associated with such cores.

Kernel facilities 107 and 108 and containers 90, 91 and 92 are the portions of main memory 18 which are transferred, at various times, to such cache(s) and acted upon by such core(s) which are useful in describing important aspects of the operation of kernel bypasses 51, 53 and 55 for selectively bypassing OS kernel facilities 107 and 108, including locks 102 and 104, and/or I/O bypasses 41, 43 and 45, which are loaded into OS kernel-space 19 under the direction of the host SMP OS, such as SMP Linux®.

It should be noted that computer processing system 80 may preferably operate cores 96, 97, 98 and/or 99 of multi-core processor 12 in parallel for processing of software applications in user-space 17. In particular, software applications in related application group 90 illustrated for convenience as a container, such as a Linux® container, e.g., user software application 85, are processed by core 96 and associated cache(s) 28. Similarly software applications in related application group or container 91, such as user software application 87, are processed by core 97 and associated cache(s) 30.

In this figure, no application group is shown to be associated with core 99 and related cache(s) 40 to emphasize the parallel, as opposed to the symmetrical multi-processing or SMP operation, of the cores of multi-core processer 12. Core 99 and related cache(s) 40 may be used as desired to execute another group of related applications (not shown in this figure), for overflow or for other purposes. Software applications in related application group or container 92, such as user software application 93, are processed by core 98 and associated cache(s) 32.

In general, each application group such as container 90, may, in addition to one or more software applications such as application 85, be provided with what may be considered an emulation of a modified and enhanced version of the appropriate portions of OS kernel facilities 107 and 108 of OS kernel-space 19 and illustrated as engine 65. Similarly, engines 67 and 69 may be provided in containers 91 and 92.

Each application group in user-space 17, may further be provided with an execution framework portion, such as execution frameworks 74, 76 and 78 in containers 90, 91 and 92 respectively. Further, parallel I/O facilities or engines such as 77, 82 and 83 are provided in OS kernel-space 19 for directing I/O events, call backs and the like, to the appropriate core and cache combination as discussed herein. I/O facilities or engines are not typically located within OS kernel space or facilities such as kernel space 19 or facilities 107 and 108.

Software call elements and I/O events moving in one direction will be discussed with reference to the operation of bypasses 51, 53 and 55, the operation of the engines and frameworks in user-space 17 working together with the parallel I/O facilities in kernel-space of computer system 80. However, as illustrated by the bi-directional arrows in this and other figures, such calls and events typically move in both directions.

When a core, such as core 96 is executing a process one or more software calls such as calls 74A, are generally issued from application 85 to a library, directory or similar mechanism in the host OS which would traditionally direct that call to OS kernel-space 19 for processing by host OS kernel facilities 107, 108 and the like. However, execution framework 74 intercepts call 74A, for example, by overriding or otherwise supplanting the host OS library, directory or other mechanism with a mechanism which redirects call(s) 74A as call(s) 74B to non-OS engine 65 which may provide an enhanced or optimized processing of call 74B using bypass 51 than would be provided in OS kernel-space facilities 107, 108 and the like.

Because appropriate portions of engine 65, framework 74 and application 85 are actually in cache(s) 28 being processed under the control of core 96, mode switching back and forth between user and kernel-space is required and the high overhead processing costs associated with contention processing through OS kernel-space facilities 107, 108 and the like may be reduced by the application or application group specific processing provided in user-space non-OS engine 65. Engine 65 also performs other application and/or group 90 specific enhanced or at least more optimized processing including, for example, as batch processing and the like.

Caches for each core in multi-core processor, such as processor 12, are typically very fast and are connected directly to main memory 18 via main processor interconnect 16. As a result, the overhead costs of transferring data resulting from a software call and the like, such as retrieving and storing data, may be vastly reduced the techniques identified as bypasses 51, 53 and 55.

A similar optimizing approach may be taken with respect to I/O bypasses 41, 43 and 45 of computer processing system 80. The operation of parallel I/O facilities 77, 82 and 83 in kernel-space 19, will be optimized for I/O events moving in one direction. However, as illustrated by the bidirectional arrows in this and other figures, such events typically move in both directions.

Referring now to P I/O 77, 82 and 83 in kernel-space 19, it must be noted that these elements are part of the traditional OS kernel that are loaded when a traditional operating system such as SMP Linux® is loaded as the host OS. P I/O 77, 82 and 83 in kernel-space 19 perform a similar function to that of execution frameworks 74, 76 and 78 that are added in container space 90, 91 and 92 in user-space 17. That is, P I/O 77, 82 and 83 serve to “intercept” events and data from one or more of a plurality of I/O controllers 20 so that such events and data are not processed by OS kernel facilities 107, 108 or the like nor are they then applied in a symmetrical processing or SMP fashion across all cores of multi-core processor 12.

In particular, P I/O 77, 82 and 83 facilities in kernel-space 19 may part of a single group of functions, and/or otherwise in communication with execution frameworks 74, 76 and 78, and/or engines 65, 67 and 69 in order to identify the processor core (or cores) on which the applications of an application group are to be processed. For example, as shown in this figure, a portion of application 85 is currently being processed in cache(s) 28 of core 96. Although it may be useful to sometimes move application for processing to another cache/core set, such as core 99 and cache(s) 40, it is currently believed to be desirable to maintain correspondence between application groups and will be described that way herein. It is quite possible to vary this correspondence under some circumstances, e.g., when one core cache(s) set is underperforming and similarly when more processing is needed than be achieved by a single processor.

In particular, when one or more applications in application group 90, such as application 85, has been assigned to core 96 in a parallel processing mode, P I/O 77, via parallel I/O control interconnect 49, programs one or more I/O controllers in I/O controllers 20 in order to have I/O related to that application and core routed to the appropriate cache and core. In particular, as illustrated by I/O 41, I/O controllers related to application 85 would be routed to cache(s) 28 associated with core 96 as indicated by the bidirectional dotted line shown as I/O 41. Similarly, I/O from I/O controllers 20 related to application group 91 are directed to cache(s) 30 and core 97 as represented by I/O 43. I/O 45 represents directing I/O controllers related to application group 92 to cache(s) 32 for processing by core 98.

It should be noted that in the same manner that software call bypasses 51, 53 and 55, shown as bi-direction dotted lines, represent call, data and the like actually moving between multi-core processor 12 and main memory 18, I/O bypasses 41, 43 and 45 represent I/O events, data and the like also actually moving between multi-core processor 12 and main memory 18 along main processor interconnect 16.

As a result, to the extent desired, software calls may be processed by a specific core without all of the overhead costs and other undesirable results of passing through kernel facilities 107 and 108 and related I/O events are processed by the same core to maintain cache coherency and also the eliminate substantial overhead costs and other undesirable results of passing through kernel facilities 107 and 108.

That is, each of the cores within multi-core processor 12 may be operated as a separate or parallel processor used for a specific application group or container and the I/O related to that group without the substantial overhead costs and other undesirable results of passing through kernel facilities 107 and 108.

Continuing to refer to FIG. 5, computer processing system 80 may conveniently be implemented in one or more SMP servers, for example in a computer farm providing cloud based computer servers, to execute unmodified software program, i.e. software written for SMP execution in standard binary without modification. In particular, it may be convenient, based on currently available operating systems, to use a Unix®-like SMP OS which provided OS level facilities for creating groups of related applications which can be operated in the same way for kernel and I/O bypass.

Linux® OS (at least version 3.8 and above) and Docker® are examples of currently available OS which conveniently provide OS level facilities for forming application groups, which may be called OS level virtualization. The term “OS level facilities for forming application groups” in this context is used to conveniently distinguish from prior virtualization facilities used for server virtualization, such as virtual machines provided by VMware and KVM as well as others.

For example, computer processing system 80 may conveniently be implemented in a now current version of SMP Linux® OS using Linux® namespaces, cgroups as well as packaging and management framework for OS-level virtualization to form groups of applications, e.g., in a Linux® “container”. The term “micro-virtualization” in this description is a coined phrase intended to refer to the creation (or emulation) of facilities in user-space 17 within application groups such “virtualized” containers 90, 91 and 92. That is, the phrase micro-virtualization is intended to bring to mind creating further, “micro” virtualized facilities, such as execution framework 74 and engine 65, within one or more already “virtualized” containers, such as container 90.

Other ways of forming related application groups which will operate properly, for example, with execution frameworks 74, 76 and 78 in containers or groups 90, 91 and 92 in user-space 17 to provide the functions of bypass 51, 53 and 55. As discussed below, P I/O 77, 82 and 83 are conveniently implemented in SMP Linux® OS in OS kernel-space 19, but may be implement in other ways, possibly in user-space 17, I/O controllers 20 or other hardware or firmware to provide the functions of I/O 41, 43 and 45.

Now with regard to reductions in kernel concurrency and processing overhead costs, these results may be achieved, as discussed herein, by the combination of:

a) selective kernel avoidance,

b) parallelism across processor cores and

c) fast I/O data and events.

Achieving selective kernel avoidance may include, real-time processing (e.g., system call by system call) using purpose built or dynamically configured, non-OS kernel software such as execution frameworks 74, 76 and 78 in user-space 17. Such frameworks intercept various software calls, such as system calls or their wrapper calls (e.g., standard or proprietary library calls), and the like, initiated by software programs such as applications 85, 87 and/or 93 within application groups such as containers 90, 91 and 92 running in a SMP OS user-space 17.

Engines 65, 67 and 69 may conveniently use custom-built, enhanced and preferably optimized user-space software (e.g., emulated kernel facilities or engines) to handle and execute application software calls in batch mode, mode-switch minimizing modes, and other call-specific enhancement and/or optimization modes, rather than using traditional SMP OS's kernel facilities 107 and 108 in OS Kernel-space 19, to handle and execute those software programs' software calls. Call and program handling and execution may bypass contention-prone kernel data structures and kernel facilities inside the SMP OS kernel (e.g. SMP OS's kernel facilities 107 and 108 in OS Kernel-space 19), which is running over a group of shared-memory processor cores and processors.

For example, bypass 51 represents, by a bi-directional dotted line, that calls 74A issued by application 85 in container 90 may be intercepted by execution framework 74 and forwarded, as illustrated by path 74B, for processing by emulated kernel engine 65. As noted above, kernel space 19 and user space 17 are portions of software of interest within main memory 18 which are processed by multi-core processor 12.

As a result, at various times, such portions of the contents of container 90 including application 85, calls 74A and 74B, execution framework 74 and engine 65, when being executed, are in memory cache(s) associated with multi-core processor 12 which is connected via main processor interconnect 16 to main memory 18. Therefore, when execution framework 74 intercepts calls 74A for processing by engine 65, this occurs within multi-core processor 12, so that the results may be transferred directly via interconnect 16 to main memory 18, completely avoiding processing by OS kernel facilities 107, 108 and the like and thereby avoiding some or all of the overhead costs of processing in a one size fits all, OS kernel which is not enhanced or optimized for application group 90.

In particular, engines 65, 67 and 69 may be implementation-specific, depending on the containers and their software programs under virtualization or otherwise within a group of selected, related applications. As a result, selected calls or all system calls, library calls, and other program instructions etc., may be processed by engines 65, 67 and 69 in order to minimize mode-switching between user-space processes and minimize user-space to kernel-space mode switching as well as other processing overhead and other costs of processing in the one size fits all, OS based kernel facilities (e.g., facilities 107, 108 and the like) loaded by the host OS without regard to the particular processing needs of the later loaded applications and/or other software such as virtualization or other software for forming groups of related applications.

Operation of application groups 91 and 92 are very similar to that for application group 90 described above. It is important to note however, that the enhancement or optimization of each emulated kernel engine, such as engines 65, 67 and 69, may preferably be different and is based on the processing patterns and needs of the one or more applications in each such application group 90, 91 and 92. As noted, although only single applications are illustrated in each application group, such groups may be formed based on the patterns of use, by such applications, of traditional OS kernel facilities 107 and 108 and the like when executing.

Software applications (for processing in a selected computer or groups of computers), which use substantially more memory reads and writes than other applications to be so processed, may for example be formed into one or more application groups whose engines are enhanced or optimized for such memory reads or rights while applications which for example may use more system calls of a particular nature may be formed into one or more application groups whose engines are enhanced or optimized for such system calls. Some applications, such as browsers, may have substantially greater I/O processing and therefore may be placed in a container or application group which includes an engine enhanced or optimized for handling I/O events and data, for example related to Ethernet LAN networks connected to one or more I/O controllers 20.

For example, one or more applications such as application 85 which heavily use memory reads and writes may be collected in container 90, one or more applications such as application 87 which heavily use memory reads and writes may be collected in container 91, and one or more applications such as application 93 which heavily use TCP/IP functions may be collected in container 92.

It must be noted again that I/O processing, as well as application calls, are typically bi-directional as illustrated by the bi-directional arrows.

Further, applications written for execution on computer systems running an SMP OS may be executed without modification one or more multi-cores processors, such as processor 12, on an SMP OS more efficiently executed as discussed above. A further substantial improvement may result from operating at least some of the cores, of such multi-core processors, as parallel processors as described herein and particularly herein below.

Related application groups, such as containers 90, 91 and 92, and their one or more software programs, may be instantiated with their own call-handling engines, such as engines 65, 67 and 69 in the above sense. As a result, each application group or container may use its own virtualized kernel facility or facilities for resource allocation when executing its user-space processes (containers and software programs) over processor cores and processor, individual containers with their own call-handling engines effectively decouple the containers' main execution from the SMP OS itself. In addition, each emulated kernel facility may be enhanced or optimized in a different way to better process the resource management needs of the applications, which may be grouped with regard to such needs, for further and easily updated, resource related needs.

As a result, each container and its software program and its call-handling engine(s) can be executed on an individual shared-memory processor core with minimal kernel contentions and interference from other cores and their caches (that are running and serving other containers and their programs), because of core affinity and because of the absence of using a shared SMP OS particularly for resources allocation. This kernel bypass and core-affinity based user-space execution enable containers and their software programs and their call-handling engines to execute concurrently, and in parallel, with minimal contentions and interference from each other and from blocking/waiting brought about by a shared SMP OS kernel, and cache related overheads.

I/O (input/output) data and asynchronous events (e.g., interrupts and associated processing) from low level processor hardware, such as network (Ethernet) controller, storage controller, or PCI-Express® controllers and the like represented by I/O controllers 20, may be moved directly from such low-level hardware, and their buffers and registers and so on, to user-space's call-handling engines 65, 67 and 69 and their containers 90, 91 and 92, including one or more software programs such as applications 85, 87 and 93, respectively. (PCI-Express® is a registered trademark of PCI-SIG). These high-speed data and event movements are managed and controlled by such engines 65, 67 and 69, with the full support of the underlying processor hardware, such as DMA and interrupt handling. In this way, traditional data copying and movements and processing in OS kernel facilities 107 and 108 and the like, and their contentions, are substantially reduced. From user-space 17, these data and events may be served directly to the user-space containers via bypass 51, 53 and 55 without interventions from OS kernel facilities 107, 108 and the like.

Such actions (e.g., software calls, event handling, etc.), events, and data, may be performed in both directions, i.e., from user-space containers 90, 91 and 92 and their software programs such as applications 85, 87 and 93 to the processor cores of multi-core processor 12 and associated hardware, and vice versa. In particular, application 85 is executed on core 96 with caches 28, application 87 is processed on core 97 with caches 30 while application 93 is processed on core 98. Such techniques may be implemented without requiring OS kernel patches or OS modifications for the mainstream operating systems (e.g., Linux®), and without requiring software programs to be re-compiled.

As illustrated in FIG. 5, kernel bypassing may include three main techniques and architectural components for processing OS-level/container-based virtualization of software programs 85, 87 and 93 in containers 90, 91 and 92, including

a) user-space kernel services engines 65, 67 and 69,

b) execution frameworks 74, 76 and 78, and

c) parallel I/O and event engines P I/O 77, 82 and 83.

For convenience of disclosure, where possible, these actions are often discussed only in one direction even though they are bi-directional as indicated by the bi-directional arrows shown in this and other figures.

User-space kernel services engines 65, 67 and 69 may be instantiated in user-space and performed on an event by event basis, e.g., on as software system call by system call and/or function call by function call and/or library call by library call (including library calls that serve as wrappers of system calls), and/or program statement by statement and/or instruction by instruction level basis. Engines 65, 67 and 69 perform this processing for groups of one or more related applications, such as applications 85, 87 and 93, shown in OS-level virtualization containers 90, 91 and 92, respectively. User-space non-OS kernel engines 65, 67 and 69 use processing functionalities and data structures and/or buffers 49, 59 and 79, respectively, to perform some or all of the tradition software calls and/or program instructions processing performed in kernel-space by OS kernel 19 and its kernel facilities 107 and 108, e.g., network stack, event notifications, virtual file system (VFS), and the like. Engines 65, 67 and 69 may implement highly enhanced and/or optimized processing functionalities and data structures and/or buffers 49, 59 and 79 when compared to that traditionally implemented in the OS kernel facilities 107 and 108 which may include, for example, data structures 107A and 108A as well as locks 102 and 104.

Engines 65, 67 and 69 in user-space 17 are instantiated for—and bound to —OS-level containers or application groups 90, 91 and 92 in user-space 17 and their software programs. During their execution in cores 96, 97, 98 and 99, library calls, function calls, system calls (e.g., those wrapped in library calls) from or to software programs 85, 87 and 93 in containers 90, 91 and 92, as well as program instructions and statements—traditionally processed by the SMP OS kernel 19 (or otherwise e.g., standard or proprietary libraries)—are instead fully or selectively handled and processed by engines 65, 67 and 69, respectively, in user-space.

Traditional I/O event notifications and/or call-backs (e.g., interrupts handling) normally delivered by OS kernel 19 to encapsulated software programs 85, 87 and 93 in containers 90, 91 and 92, respectively, are instead selectively or fully delivered by engines 65, 67 and 69 to encapsulated software programs 85, 87 and 93 in containers 90, 91 and 92, respectively. In particular, I/O events 51, 53 and 55, originating in one or more low level hardware controllers such as I/O controller 80, may be intercepted in kernel-space 19 before processing by kernel-space OS facilities 107 and 108. This interception avoids the overhead costs of traditional OS kernel processing including, for example, by locks 102 and 104. As described in greater detail below, the interception and forwarding may be accomplished by P I/O 77, 82 and/or 83 which have been added into OS kernel-space 19 as non-OS kernel facilities, e.g., outside of OS kernel facilities 107 and 108. P I/O 77, 82 and/or 83 then forward such I/O events in the form of I/O events 41, 43 and 45 to containers 90, 91 and 92, respectively, for processing by engines 65, 67 and 69, respectively, which may be been enhanced and/or optimized for faster, more efficient I/O processing as discussed in more detail herein below.

Execution frameworks 74, 76 and 78 may be part of a fully distributed software execution framework, primarily located in user-space 17, running primarily inside containers 90, 91 and 92, with configuration and/or management components running outside user-space, and/or over processor cores. Execution frameworks 74, 76 and 78, transparently and in real-time, intercept system calls, function and library calls, and program instructions and statements, such as call paths 74A, 76A and 78A, initiated by software programs 85, 87 and 93 in containers 90, 91 and 92 during the execution of these applications. Execution frameworks 74, 76 and 78, transparently, and in real-time, divert these software calls and program instructions illustrated as calls 74B, 76B and 788 for processing to engines 65, 67 and 69.

After processing calls 74A, 76A and/or 78A from applications 85, 87 and/or 93, respectively, engines 65, 67 and 69 return the processing results via bi-directional I/O paths 74B, 768 and/or 78B to execution frameworks 74, 76 and 78 which return the processing results via call paths 74A, 76A and/or 78A, respectively, for further processing by applications 85, 91 and/or 92, respectively. It is important to note that most if not all of this call processing occurs within the application group or container to which the application is bound.

In particular, calls issued by application 85 follow bidirectional path 74A to framework 74 via path 74B to engine 65 and/or in the reverse direction, substantially all within container 90. When more than one program or process or thread is contained which container 90, e.g., another program related to application 85, such calls will follow a similar path to execution framework 74, engine 65 and/or in the reverse direction. Similar bidirectional paths occur in containers 91 and 92 as shown in the figure. The result is that such calls to and from applications 85, 91 and 92 stay at least primarily within the associated container, such as containers 90, 91 and 92, respectively and are substantially if not fully processed with each such associated container without the need to access OS kernel space.

As a result, to the extent desired, such calls may processed and returned without processing by OS kernel-space facilities 107 and 108 and the like. Under some conditions, depending upon the hardware, software, network connections and the like, it may be desirable to have some, typically small number if any of such calls processed in OS kernel-space 19 by kernel-space facilities 107 and 108.

However, bypassing SMP Kernel OS 19 has substantial benefits, such as reducing the overhead costs of unnecessary contention processing and related overhead costs resulting from processing calls 74A, 76A and 78A in kernel facilities and data structures 107 and 108 and locks 102 and 104 of SMP OS kernel 19. Engines 65, 67 and 69 may be considered to be emulations, in user-space 17 of SMP OS Kernel 19. Because engines 65, 67 and 69 are implemented in user-space 17 and are created for specific types of applications and processes, they may be implemented separated as different, purpose-built, enhanced and/or optimized and high-performance versions of some of the portions of kernel facilities traditionally implemented in the SMP OS kernel 19.

As basic examples of some of the benefits of processing calls 74A, 76A and 78A in user-space 17, rather than in OS kernel 19, such calls may be processed with fewer, if any, processing by locks equivalent in overhead costs to locks 102 or 104 in kernel-space 19, the overhead costs of the mode switching required between user-space 17 and kernel-space 19 and the processing of such calls may be at least enhanced and preferably optimized by batching and similar techniques.

Parallel I/O and event engines P I/O 77, 82 and 83 provide similar benefits by bypassing the use of OS kernel facilities 107 and 108, for example by reduced mode switching, as well as using the on chip cores of multi-core processor 12 in a more efficient manner by parallel processing.

Parallel I/O and event engines 77, 82 and 83 usually execute in kernel-space 19, typically in Linux® as dynamically loadable kernel modules, but can operate in part in user-space 17. P I/O engines 77, 82 and 83 move and process—or control/manage the movement and processing of—data and I/O data (e.g., network packets, storage blocks, PCI-Express data, etc.) and hardware events (e.g., interrupts, and I/O events). Such I/O events 41, 43 and/or 45 may be delivered relatively directly, from one or more of a plurality of low-level processor hardware, e.g., one or more I/O controllers 20 such as an Ethernet controller, to engines 65, 321 and/or 325 while such engines are executing on processor cores 96, 97 and/or 98, respectively.

It should be noted, that although the host OS for computer processing system 80 may conveniently be an SMP OS, such as SMP Linux®, application 85 in container 90 runs on core 0, i.e. core 96 of multi-core processor 12, while applications 87 and 93 run on cores 97 and 98, respectively. Nothing in this figure is shown to be running on core 99 which may, for example, be used for expansion, for handling overload from another application or overhead facility and/or for handling loading in an SMP mode for example by symmetrically processing application 87 together with core 97.

It is important to note that:
1) In this figure, cores 96, 97, 99 (if operating) and/or 98 are operating as parallel processors, even though they are individual cores of one or more multi-core processors,
2) the host OS in computer processing system 80 may be a traditional SMP OS which would normally symmetrically utilize all cores 96, 97, 98 and 99 for processing applications 85, 87 and 93 in containers 90, 91 and 92, and
3) applications 85, 87 and 93 in containers 85, 91 and 92 may be written for execution for SMP processing and are not required to be written or modified, in order to operate in a parallel processing mode on cores of a multi-core processor such as multi-core processing system 80.

Cores 96, 97 and 98 are advantageously operated as parallel processors in computer processing system 80 in part in order to maximize data and event parallelism over interconnected processor cores, and to minimize OS kernel 19 contentions and data copying and data movement, and cache lines updates which occur because of local cache updates of shared cache lines of the processor cores, imposed by the architecture of traditional SMP OS kernel running.

P I/O engine 77 programs I/O controller 20, via interconnect 49, so that data bound for container 90 and its software program 85 are transferred by DMA directly on I/O path 41 from I/O controllers 20 (e.g., DMA buffer) to core 96's cache(s) 28 and thereby user-space kernel engine 65 before execution framework 74 and engine 65 deliver the data to the software program 85.

In this way, OS kernel 19 may be bypassed completely or partially for maximal I/O performance, see for example bypass 51 in FIG. 5.

Similarly, P I/O engine 82 programs one or more of I/O controllers 20, via parallel I/O control interconnect 49, so that data bound for container 91 and its software program 87 are sent via I/O path 43 (i.e., via connections to main processor interconnect 16) to processor core 97's caches 30 and user-space kernel engine 67. Further, P I/O engine 83 programs one or more of I/O controllers 20, via parallel I/O control interconnect 49, so that data bound for container 92 and its software program 93 are sent via I/O path 45 (i.e., via connections to main processor interconnect 16) to processor core 98's caches 32 and user-space kernel engine 69.

In these examples, container 90 executes on core 96, container 91 executes on core 97 and container 92 executes on core 98. Most importantly, data movements and DMAs and interrupts stream 41, 43 and 45 can proceed in parallel and concurrently without contention in hardware or software (e.g. OS kernel-space facilities 107, 108 and the like in SMP OS kernel space 19), thereby maximizing parallelism and I/O and data performance, while ensuring that containers 90, 91 and 92, their software programs 85, 87 and 93, respectively, may execute concurrently with minimal interference from each other for data and I/O related and other processing.

In addition to maximizing data and event parallelism over interconnected processors cores, user-space enhanced and/or optimized kernel engines 65, 67 and 69 run separately, that is in parallel processing, on processor cores 96, 97 and 98 which minimizes SMP OS kernel-space 19 contentions and related data copying and data movement. Further cache line updates are substantially minimized when compared to the local cache updates of shared cache lines of the processor cores that would otherwise be imposed by the architecture of traditional OS kernel 19 and kernel facilities 107 and 108 therein including, for example, locks 102 and 104.

User-space virtualized kernel engines 65, 67 and 69 are usually implemented as purpose-built, enhanced and/or optimized and high-performance versions of kernel facilities 107, 108 and the like, traditionally implemented in the OS kernel in kernel-space 19. Virtualized user-space kernel engines 65, 67 and 69 may include, as two examples, an enhanced and/or optimized, user-space TCP/IP stack and/or a user-space network driver in user-space kernel facilities 49, 59 and/or 79.

User-space kernel facilities 49, 59 and/or 79 in user-space kernel engines 65, 67 and 69, respectively, are preferably relatively lock free, e.g., free of locks such as kernel spin locks 102 and 104, RCU mechanisms and the like included traditional OS kernel-space kernel functions, such as OS kernel facilities 107 and 108. OS kernel-space facilities 107 and 108 often utilize kernel locks 102, 104 and the like to protect concurrent access to data structures 107A and 108A and other facilities. User-space kernel facilities 49, 59 and 79 are configured to generally include core data structures 107A and 108A of the original kernel data structures in OS kernel-space 19 for compatibility reasons.

The same principle of compatibility applies generally to system calls and library calls as well—these are enhanced and/or optimized and duplicated and sometimes modified for implementation in the user-space micro-virtualization engines to dynamically replace the original and traditional kernel calls and system calls when containers and processes initiates their system, library, and function calls. Other more specialized and case-by-case enhancements and/or optimization and re-architecting of kernel functionalities are expected, such as I/O and event batching to minimize overheads and speed up performance.

User-space, virtualized kernel engines 65, 67 and 69 are executed in user-space 17 and preferably with only one type of user-space kernel engine executing on each processor core. This one to one relationship minimizes contention processing in user-space 17 related to scheduling complexities that would otherwise result from running on a single core. That is, avoiding OS kernel processing with an emulated user-space kernel may reduce overhead processing costs, but in a parallel processing configuration as discussed above, scheduling difficulties for processing multiple types of user-space kernels on a single core could obviate some of the kernel bypass reductions in overhead processing costs if multiple types of user-space engines were used.

One of the original benefits of SMP OS processing was that tasks were symmetrically processed across a plurality of cores rather than being processed on a single core. The combination of bypassing OS kernel facilities 107 and 108 in kernel-space for processing in enhanced and/or optimized user-space kernel engines (e.g., in engines 65, 67 and 69), as described herein, substantially reduces processing overhead costs, e.g., by batch processing, reduced mode switching between user and kernel-space and the like. Using at least some of the multiple cores in multi-core processor 12 in a parallel mode provides substantial advantages, such as with I/O processing, scaling, providing additional cores for processing were needed for example for poor performance on another core and the like. Restricting the processing of groups of related applications, such as application 85 and other applications in container 90, to processing on a single core using virtual user-space kernel facilities provided by engine 65, may provide substantial additional benefits in performance. For example, as noted immediately above, using a single type of user-space engine, such as engine 65, with a related group of applications in container 90 such as application 85, further improves processing performance by minimizing scheduling and other complexities of executing on a single core, i.e., core 96.

For example, core 96 has only engine 65 executing thereon. Micro-virtualization or user-space kernel engines of the same or similar type running in different processor cores (e.g., engines 65 and 67 running on cores 96 and 97, respectively) execute concurrently and in parallel to minimize contentions. Micro-virtualization engines 65 and 67 are bound to software programs 85 and 87, respectively in containers 90 and 91, respectively. Traditional OS IPC (inter process communication) mechanisms may be used to bind micro-virtualization non-OS kernel engines to their associated software programs, which in turn may be encapsulated in their containers. More specialized message passing software and mechanisms may be used for the bindings as well.

Micro-virtualization engines, such as user-space kernel engines 65, 67 and 69, like their OS kernel counterparts, such as OS kernel-space facilities 107 and 108 in OS kernel-space 19, which they dynamically replace, are bidirectional in that software calls, e.g., calls 74A, 76A and 78A initiated by software programs 85, 87 and 93 respectively. Similarly, I/O data and events, destined for theses software programs, are handled by user-space kernel engines 65, 67 and 69. For example, traditional SMP OS event notification schemes can be implemented in a non-OS, user-space kernel services engine for high performance processing and minimizing kernel execution as well as mode switching.

Non-OS, user-space, kernel emulation engines 65, 67 and 69 may be dynamically instantiated for containers and their software programs. Such micro-virtualization engines may be transparent to the SMP OS kernel in that they do not require substantial if any kernel patches or updates or modifications and may also be transparent to the containers' software programs, i.e., no modification or re-compilation of the software programs are needed to use the micro-virtualization engines. OS reboot is not expected when new micro-virtualization engines are instantiated and created. Software programs are expected to restart when new micro-virtualization engines are instantiated and bound to them.

Execution frameworks 74, 76 and 78, in engines 65, 67 and 69 may part of a distributed software that dynamically and in real time intercepts software calls—such as system, library, and function calls—initiated by the software programs 85, 87 and 93 in application groups 90, 91 and 92. This execution framework typically runs in user-space, and diverts these software calls and program instructions from the software programs 85, 87 and 93 in containers 90, 91 and 92 to non-OS, user-space kernel emulation engines 65, 67 and 69, respectively, for handling and execution in order to bypass the traditional contention-prone, OS kernel facilities and data structures 107 and 108 with locks 102 and 104, respectively in OS kernel-space 19. Data and events are delivered by frameworks 74, 76 and/or 78 to the one or more corresponding software programs in each container, such as (as illustrated in this figure), programs 85, 87 and 93 in containers 90, 91 and 92.

Parallel I/O and event engines 77, 309A and 83 program low-level hardware, such as I/O hardware controllers 20, which may include one or more Ethernet controllers, and control and manage the movement of data and events so that they are transported directly from their low-level hardware buffers and embedded memory and so on to the user-space, bypassing the overheads and contentions of SMP OS kernel related processing traditionally encountered. Traditional interrupts related handling and DMAs are examples of low-level hardware to user-space speedup and acceleration that can be supported by the parallel I/O and event engines 77, 82 and 83.

Parallel I/O and event engines 77, 82 and 83 also program hardware such that data and events can be transported in parallel and concurrently over a set of processor cores to independent containers and their software programs. For example, I/O data and events from I/O controllers 20, destined for container 90 and its software programs and micro-virtualization engines 65, 67 and 69 are programmed by P I/O 77 to interrupt only core 96 and are transported directly to caches 28 of core 96, without contenting and interfering with the caches and execution of other cores in multi-core processor 18, such as cores 97, 99 and 98.

Similarly, P I/O 82 programs I/O controllers 20 so that data and events destined for container 91 are to interrupt only core 97 and are moved directly to the caches 30 of core 97, without contenting and interfering with the caches and execution of other cores in multi-core processor 18, such as cores 96, 99 or 98. In the same manner, P I/O 83 programs I/O controllers 20 so that data and events destined for container 92 interrupt only core 98 and are moved directly to caches 32 of core 98, without contenting and interfering with the caches and execution of other cores in multi-core processor 18, such as cores 96, 97 and/or 98.

Parallel I/O and event engines P I/O 77, 82 and 83, non-OS user-space kernel emulation engines 65, 67 and 69, and execution frameworks 74, 76 and 78 are bidirectional as indicated by the bi-directional arrows applied to them.

Parallel I/O and event engines P I/O 77, 82 and 83 can be implemented as OS kernel modules for dynamic loading into the OS kernel 19. User-space parallel I/O and event engines or user-space components of parallel I/O and event engines may be implementation options.

Parallel I/O and event engines may be dynamically instantiated and loaded for containers and their software programs. Parallel I/O and event engines are transparent to the SMP OS kernel in that it does not require kernel patches or updates or modifications, except as dynamically loadable kernel modules. Parallel I/O and event engines are also transparent to the containers' software programs, i.e., no modification or re-compilation of the software programs are needed to use the parallel I/O and event engines. OS reboot is not expected when new parallel I/O and event engines are instantiated and created. Software programs are expected to restart when a new parallel I/O and event engine is instantiated and loaded, and certain localized hardware related resets may be required.

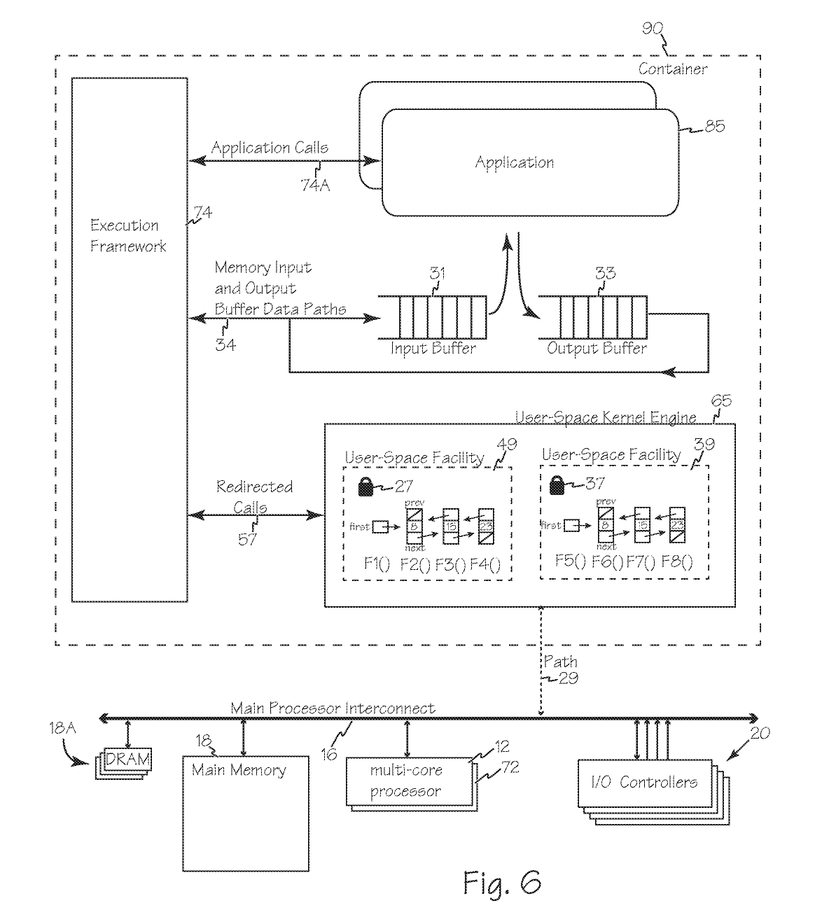

Referring now to FIG. 6, monitoring input and output buffers 31 useful as part of a technique for monitoring the execution performance of an application, such as application 85, may be implemented in a group of related applications e.g., container 90 using some or none of the techniques for improving application performance discussed herein. Such monitoring techniques are particularly useful in the configuration described in this figure for monitoring execution performance of a specific application when the application is used for performing useful work.

It is important to note that such monitoring techniques may also be useful as part of the process of creating, testing and/or revising a group or container specific set of shared resource management services such as group specific, user-space resource management facilities 49 and 39 illustrated in user-space kernel engine 65. For example, software application 85 may be caused to execute in a manner selected to require substantial resource management services in order to determine the effectiveness of a particular configuration of user space kernel engine 65. Similarly another application such as software application 83 may be included in container 90 and processed in the same manner, but with its own set of monitoring buffers, to determine if the resource management requirement of applications 83 and 85 are in fact sufficiently related to each other to form a group.

Further, a comparison of execution as monitored when the same input is applied and/or removed from the monitoring buffers from different sources and routing may provide useful information for determining the of application specific execution performance of such different sources and/or routing and/or of the same sources and/or routing at the same or different traffic levels. Such monitoring information may therefore be useful for evaluating execution performance improvement of a particular application in terms of the configuration of a user-space kernel engine, and may also be useful for evaluating a particular implementation of the application during development, testing and installing updates, as well as components such as routers and other aspects of the internet or other network infrastructure.

In operation as shown in this figure, monitoring buffers 31 and 33 are placed as closely as possible to the input and output of the application to be monitored, such as application 95. For example, having a direct path, such as path 29 between the output of input monitoring buffer 12 and the input of application 85 may provide the best monitoring accuracy. For example, a very useful location would be one in which data moved from buffer 31 to application 85 would cause application 85 to wake up if it were in a dormant mode. When the monitoring buffers are further removed from what may be considered a direct connection between monitoring buffers 31 and 33 and the relevant inputs and outputs of application 85, the more chance of degrading the monitoring accuracy by, for example, contamination from the operation of any intermediary elements.

Unless aggregated data including monitoring of more than one application is desired (which could be useful for example, for monitoring performance of multiple applications), each application to be monitored for execution performance requires is own set of monitoring buffers such as input and output buffer 31 and 33.

In the example shown in this figure, the movement of digital information to and from monitoring buffers is provided by execution framework 74 via monitoring path 34. The source and/or destination of the digital data may be any of the shared resources which provide the digital data to input buffer 31 as work to be done by application 85 during execution. Such work to be done may be data being read in or out of main memory 18 or other memory sources, and/or events, packet s and I/O controllers 20 and the like.

As discussed above, a group of related applications, such as container 90, includes software program 85 therein (for example, under micro-virtualization or other suitable mechanism). Inside container 90, in addition to software program 85 such as a Unix®/Linux®/OS process, or a group of processes, (under virtualization and containment), non-OS, user-space, kernel emulation engine 65 may execute as a separate Unix®/Linux®/OS process implementing core processing functionalities and data structures 49 and/or 39, in which locks 27 and/or 37 may or may not be present, depending for example on sharing constraints. Worker portion of execution framework 74 may or may not be an independent OS process depending on implementation. The execution and processing of application 85 in container 90 are under the control of execution framework 74 that intercepts, processes, and responds as/to applications calls (e.g. system calls) 74A, processes and moves various events and data into and out of input and output buffers 31 and 33 and forwards intercepted/redirected software calls 74A to user-space emulated OS/kernel services engine 65.

Data and/or events may be forwarded to and/or retrieved from software program 85 in user-space via shared memory input and output buffers 31 and 33, respectively. Software program 85 may make function, library, and system calls 74A during execution of application 85 which may be intercepted by execution framework 74 and dispatched as redirected calls 57 to non-OS, user-space kernel engine 65 for handling and processing. Processing by engine 65 may involve manipulating and processing and/or generation of data and events in the user-space input and output buffers 31 and 33.

The various processes in container 90, when executed by multi-processor 12, may operate for example on one or more cores therein in combination with associated data. Multi-core processor 12, main memory 18 and I/O controllers 20 are all connected in common via main processor interconnect 16. Data, such as the output of memory output buffer 33, may be processed by engine 65 and dispatched relatively directly via multi-core processor 12.

For example, data in output buffer 33 may be sent via data paths 34 through engine 65 after processing to main memory 18 and/or low level hardware, such as main memory 18 and/or I/O controllers 20 via path 29, for example. Path 29 is shown in the form of a dotted line to indicate that the physical path for path 29 is more likely to be between one or more caches in multi-core processor 12, related to the one or more cores processing container 90, via main processor interconnect path 16 to main memory 18 and/or one or more of I/O controllers 20. Path 29, as well as the unlabeled connections between processor 12, main memory 18 and I/O 20, are illustrated with arrows at both ends to indicate that the data (and or event) flow is bidirectional.

In particular, data and events arriving via path 29 at container 90 are deposited (e.g., by DMA) using data paths 34 at the input of input buffer 31. These data, for example, can be processed by engine 65 before being delivered to the software program 85.

Asynchronous events arriving from low level hardware, such as I/O controllers 20, (e.g., DMA completions) can be batched and buffered before execution framework 74 delivers aggregated events and notifications to software program 85. Event notifications traditionally implemented in OS kernel facilities, such as facilities 107 and 108 implemented event notifications, can be instead implemented within the non-OS engine 65, buffers 31 and 33 using execution framework 74, so that registration between event notifications from software program 85 and the actual event notifications to program 85 are handled and processed by non-OS, user-space emulation kernel engine 65.

It is important to note that buffers 31 and 33 may be used for other purposes than monitoring and/or buffers or queues already used for other purposes may also serve as monitoring buffers. Monitoring uses information from buffers relatively directly connected to the inputs and outputs of a single application and therefore may be used even without the kernel bypassing and/parallel run processing on separate cores. Preferably all work to be done by the application to be monitored would flow through the buffers to be monitored, such as input and output buffers 31 and 33. However,

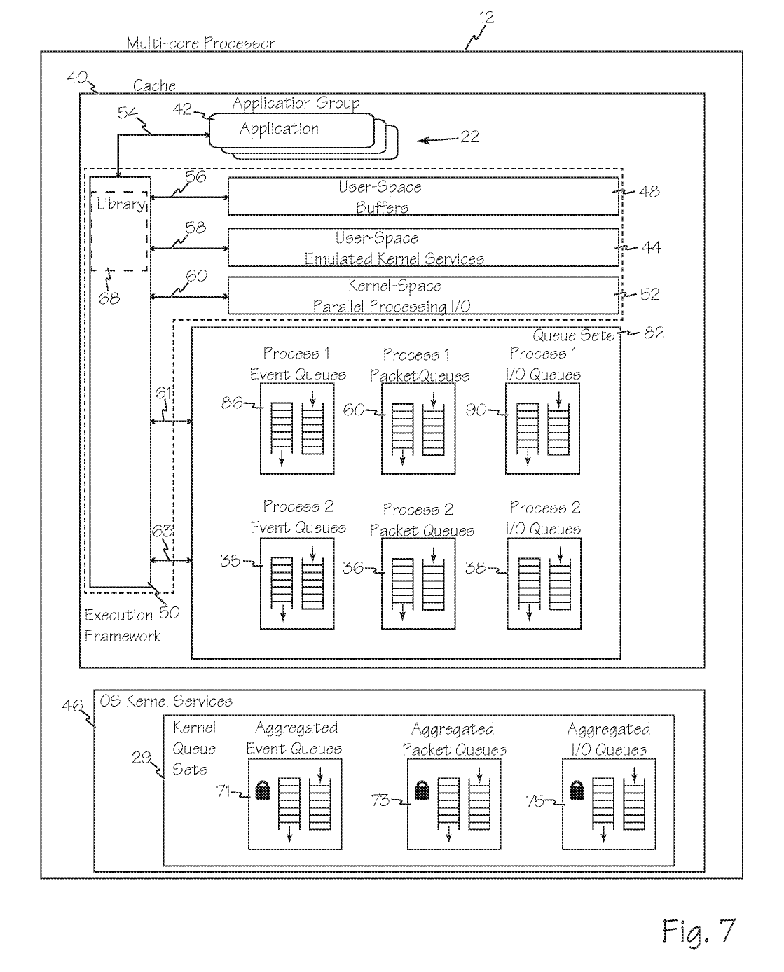

Referring now generally to FIGS. 7-11, it has long been an important goal to improve computer performance in running software applications. Conventional techniques include monitoring and analyzing software application performance as such applications execute on computer hardware (e.g., processors and peripherals) and operating system software (e.g., Linux). Often, an application's resource consumption such as processor or processor core cycle utilization and memory usage are measured and tracked. Given higher (or “wasteful”) resource consumption, corresponding low application performance (e.g., quality-of-service, QoS) is often taken to be either slow application response (e.g., indicated by longer application response time in processing requests or doing useful work) or low application throughput, or both.

When an application (and/or its components and threads of execution) is shown to be using substantial amounts of currently allocated resources (e.g., processors/processor cores and memories), additional resources would often be dynamically or statically (via “manual” configurations) added to avoid or minimize application performance degradations, i.e., slow application or low application throughput, or both.

Many conventional information technology (IT) devices (e.g., clients such as smartphones, and servers such as those in data centers) are now connected via the Internet, and its associated networking including switching, routing, and wireless networking (e.g., wireless access), which require substantial resource scheduling and congestion control and management to be able to process packet queues and buffers in time to keep up with the growing and variable amounts of traffic (e.g., packets) put into the Internet by its clients and servers and the software running on those devices. As a result, computer and software execution efficiency, especially between Internet connected clients and servers, is extremely important to proper operation of the Internet.

Conventional software application monitoring and analysis techniques are limited in their usefulness for use in improving computer performance, especially when executing even in part between (and/or on) clients and servers connected by the Internet. What are needed are improved application monitoring and analysis techniques which may include such improvements as more accurate, congestion indicative and/or workload-processing indicative, and/or real time in situ methods and/or apparatus for monitoring and analyzing actual application performance, especially for Internet connected clients and servers.

A need for monitoring and analyzing software applications' performance in situ and in real-time of software applications executing on conventional servers (e.g., particularly high core count, multi-core processors), symmetric multi-processing operating systems, and virtualization infrastructures have become increasing important. The ever increasing processing loads related to emerging cloud and virtualized application execution and distributed application workloads at cloud- and web-scale levels make the need for improved techniques for such monitoring and analyzing of increasing importance, especially since such software components from operating systems to software applications may be running on and may be sharing increasing hardware parallelism and increasingly shared hardware resources (e.g., multi-cores).

When considering both software and Internet efficiency and their optimization, and for resource management issues, the underlying issue is how the user of resources, i.e., the software application and/or the Internet, perform useful work in a responsive way by keeping up with the incoming workloads continuously assigned to such software and/or hardware, given a fixed set of resources. In the case of the Internet, the workloads are typically Internet datagrams (e.g., Internet Protocol, IP, packets), which routers and switches for example need to process, and keep up with, without overflowing their packet queues (e.g., buffers) as much as hardware buffers and packet volume will allow.

For software applications, the most direct measurement of whether an application can keep up with the workloads assigned to it on an ongoing basis and in real time may be available by monitoring software processing queues that are specifically constructed and instantiated for intelligent and direct resource monitoring and/or resource scheduling, with workloads which may be represented as queue elements and types of workload which may be represented as queues.

Similar to their counterparts in the Internet, software processing queue based metrics may provide much more direct indicators of whether an application can keep up with its dynamically assigned workloads (within acceptable software QoS and QoE levels), and whether that application needs additional resources, than conventional techniques.

Direct QoS and QoE measurements and related resource management may therefore preferably made for the software and virtualization worlds, using QoE and QoS related indicators or observables that are reconstructed by measuring and analyzing user-space software processing queues instantiated for these purposes and directly associated with the actual execution of applications even when used between Internet connected devices.

Workload processing centric, application associative, application's threads-of-execution associated, and performance indicative software processing queues of various types and designs (e.g., workload queues), and their real-time statistical analysis area may be produced and used during the application's execution. Software processing queues and their real-time statistical analyses may provide data and timely (and often predictive) insights into the application's in situ performance and execution profile, quality-of-service (QoS), and quality-of-execution (QoE), making possible dynamic and intelligent resource monitoring and resource management, and/or application performance monitoring, and/or automated tuning of applications executing on modern servers, operating systems (OSs), and conventional virtualization infrastructures from hypervisors to containers.

Examples of such software processing queues may include purpose-built and non-multiplexed (e.g., application, process and/or thread-of-execution specific) user-space event queues, data queues, FIFO (first-in-first-out) buffers, input/output (I/O) queues, packet queues, and/or protocol packet/event queues, and so on. Such queues and buffers may be of diverse types with different scheduling properties, but preferably need to be emptied and queue elements processed by an application as such application executes. Generally, each queue element represents or abstracts a unit of work for the application to process, and may include data and metadata. That is, an application specific workload queue may be considered to be a sequence of work, to be processed by the application, which empties the queue by taking up the queue elements and processing them.

Examples of software applications beneficially using such techniques may include standard server software running atop operating systems (OSs) and virtualization frameworks (e.g., hypervisors, and containers), such as web servers, database servers, NoSQL servers, video servers, general server software, and so on. Software applications executing on virtually computer system may be monitored for execution efficiency, but the use of monitoring buffers relatively directly connected between the inputs and outputs of a single application can be used to provide monitoring information related to the execution efficiency of that application. The accuracy and usefulness of the monitoring results may be affected by the directness of the connection between the monitoring buffers and the application as well as the operation of any required construct, such as execution framework 74, used to provide and remove digital data from the monitoring buffers.

Referring now in particular to FIG. 7, portions of group 22 in main memory 18 may reside in cache 28 at various times during execution of applications in group 22. Such portions are shown in detail to illustrate techniques for monitoring the execution performance of one or more processes or threads of software application 42 of application group 22 executing in core 0 of multi-core processor 12. Application 42 may be connected via path 54 to execution framework 50 which may be separate from, or part of, execution framework 50 shown in FIG. 2.

Execution framework 50 may include, and/or provide a bi-directional connection with, interception mechanism 68. Intercept 68 may be an emulated replacement for the OS library or other mechanism in the host OS to which software calls and the like from application 42 would be directed, for example, to OS kernel services 46 for resource and contention management and/or for other purposes. Emulated library or other interception engine 68 redirects software calls from application 42 to buffers 48 via path 56, and/or emulated kernel services 44 via path 58.

Emulated kernel services 44 serves to reduce the resource allocation and contention management processing costs, for example by reducing the number of processing cycles that would be incurred if such software calls had been directed to OS kernel services 46. For example, emulated kernel services 44 may be configured to be a subset of (or replacement for portions of) OS kernel services 46 and be selected to substantially reduce the processing overhead costs for application 42 when compared, for example, to such costs or execution cycles that would be accumulated if such calls were processed by OS kernel services 46.

Buffers 48, if present, may be used to further enhance the performance of emulated kernel services 44, for example, by aggregating sets of such calls in a batch mode for execution by core 0 of processor 12 in order to further reduce processing overhead, e.g., by reducing mode switching and the like.

Similarly, parallel processing I/O 52, connected via path 60 to framework 50, may be used to program I/O controllers 20 (shown in FIG. 1) to direct events, data and the like related to software application 42 to core 0 of processor 12 in the manners shown above in FIGS. 1 and 2 in order to maintain cache coherence by operating core 0 in a parallel processing mode.

In addition, queue sets 82 are interconnected with execution framework 50 via bidirectional path 61 for monitoring the execution and resource allocation uses of, for example, a process executing as part of application 42.

Referring now also to FIGS. 1 and 2, buffers 48, kernel services 44 and queue sets 82, and most if not all of execution framework 50 including library 68, are preferably instantiated in user-space 17 of main memory 18 while parallel I/O processing 52, although related to application group 24, may preferably be instantiated in kernel space 19 of main memory 18 along with OS kernel services 46.

Referring again specifically to FIG. 7, queue sets 82 may include a plurality of queue sets each related to the efficiency and quality of execution of software application 42. Application 42 may be a single process application, a multiple process or multi-threaded application. Queue sets 82 may, for example, include sets of ingress and egress queues which when monitored provide a reasonable indication of the quality of execution, QoE, and/or of quality of services, QoS, e.g., of one or more software applications, executing processes or thread for example for client server applications.

If, for example, application group 22 includes two software applications, two processes or two threads executing, the execution of one such application, process or thread, illustrated as process 1 may be monitored by event queues 86, packet queues 60 and I/O queues 90 via path 61 while the execution of another application, process or thread as illustrated as process 2 may be monitored by event queues 35, packet queues 36 and I/O queues 38 via path 61 and/or via a separate path such as path 63.

OS kernel services 46, typically in kernel space 19 (shown in FIG. 1), may include kernel queue sets 29 including for example, aggregate event queues 71, packet queues 73 and I/O queues 75 which monitor the total event, packet and I/O execution and may provide aggregated and multiplexed data about the total performance of multiple and concurrently running applications managed by the OS.

As noted elsewhere herein, emulated kernel services 44 may be configured to provide kernel services for some, most or all kernel services traditionally provided by the host OS, for example, in OS services 46. Similarly, queue sets 82 may be configured to monitor some or all event, packet and I/O or other queues for each process monitored. Information, such as QoS and/or QoE data, provided by queue sets 82 may be complemented, enhanced and/or combined with QoS and/or QoE data provided by kernel queue sets 29, if present, in appropriate configurations depending, for example, on the software applications, processes or threads in a particular application group.

Queue sets 82 and may be workload processing centric, application associative, application's threads-of-execution associated, and performance indicative software processing queues of various types and designs (e.g., workload queues), and their real-time statistical analysis during the application's execution. Such software processing queues and their real-time statistical analyses provide data and timely (and often predictive) insights into the application's in situ performance and execution profile, including quality-of-service (QoS), and quality-of-execution (QoE) data, making possible dynamic and intelligent resource monitoring and resource management, application performance monitoring, and enabling automated tuning of applications executing, for example, on modern servers, operating systems, as well as virtualization infrastructures from conventional hypervisors (e.g., VMware® ESX) as well as conventional OS-level virtualization such as Linux® containers and the like including Docker® and other container variants based on OS facilities such as namespaces and groups and so on.

Multiple, concurrent, and strongly application-associative software processing queues, as shown in queue sets 82, may each be mapped and bounded to each of an application's threads of execution (processes, threads, or other execution abstractions), for one or more applications running concurrently on the SMP OS, which in turn runs (with or without a hypervisor, if not present), over one or more shared memory multi-core processors. Each of such application-specific processing queues may provide granular visibility into when and how each of the application's threads of execution is processing the queue and the associated data and meta-data of each of the queue elements in real time (typically representing workloads for an application being executed), for many if not all applications and application threads of execution running on the SMP OS. The result may be that in situ performance profiles, workload handling, and QoE/QoS of the applications and their individual threads of execution can be measured and analyzed individually (and also in totality) on the SMP OS for granular monitoring and resource management in real time and in situ.

Application of QoS and QoE through software processing queues may include the following architectural and processing components.

Instantiate user-space and de-multiplexed software processing queues that are application workload centric: for each application's process (e.g., in a multi-process application) or thread (e.g., in a multi-threaded application), a set of software processing queues may be created for and associated with each application's process/thread. Each such processing queue may store a sequence of incoming workloads (or representation of workloads, together with data and metadata) for an application to process—e.g., such as packet buffers or content buffers, or events (read/write)—so that during an application's execution each queue is continually being emptied by the application as fast as it can (given resource constraints and resource scheduling) to process incoming workloads dynamically assigned to it (e.g., web requests or database request generated by its clients in a client-server world).

Examples of workloads can be events (e.g., read/write), packets (a queue could be a packet buffer), I/O, and so on. In this model, each application's thread of execution is continually processing workloads (per their abstractions, representations, and data in the queues) from parallel queues to produce results, operating within the constraints of the resources (e.g., CPU/cores, memory, and storage, etc.) assigned to it either dynamically or statically.

Compute running and moving statistical moments such as averages and standard deviations, etc. of software processing queues' queue lengths over time as an application executes: for each of the above workload- and application-specific software processing queue, compute a running average of its queue length over pre-set (or dynamically computed/optimized) time-based averaging and moving window, and at the same time, compute additional running statistical moments like standard deviation and/or higher order moments over the same moving/averaging window.

Compute and configure software processing queues' queue thresholds: for each of the above workload- and application-specific queue, construct and compute a workload-congestion indicative QoE/QoS threshold, for example, as a function of (a) the average queue length of the application, measured while “saturating” the CPU utilization or CPU core utilization on which the application or application's process/thread runs over a set duration, and (b) the standard deviation of the queue length of the preceding measurement. These constitute a processing queue threshold. Thresholds can be one for each software processing queue, or an aggregated one computed as a function of multiple queue thresholds for multiple software processing queues. Queue threshold can also be configured manually, instead of automatically via statistical analysis of measured data, etc.

Detect application workload QoE/QoS violations: in real-time compare the running averages of queue lengths with their thresholds. Statistically significant (compared with, or as a function of, the corresponding queue threshold related standard deviations) deviations of running average queue lengths from their queue thresholds for configurable durations means application's QoE and QoS degradations, or equivalently, the application is starting to fail in catching up with the workloads assigned to it in parts or in totality.

Detected application QoE/QoS violations indicate congested states for the application that is failing to catch up with its workloads (from single or multiple workload-centric software processing queues): these indications may be used as sensitive and useful metrics to detect congested states in application processing in situ and in real-time, and may be used for resource management and resource scheduling on a dynamic basis. Such metrics may provide indications of Internet congestions and Internet congestion (active) queue management and monitoring, e.g., indicating that the Internet or its pathways may be congested and failing to catch up with processing packets, leading to dropped packets and delayed delivery of packets (growing packet queues' lengths).

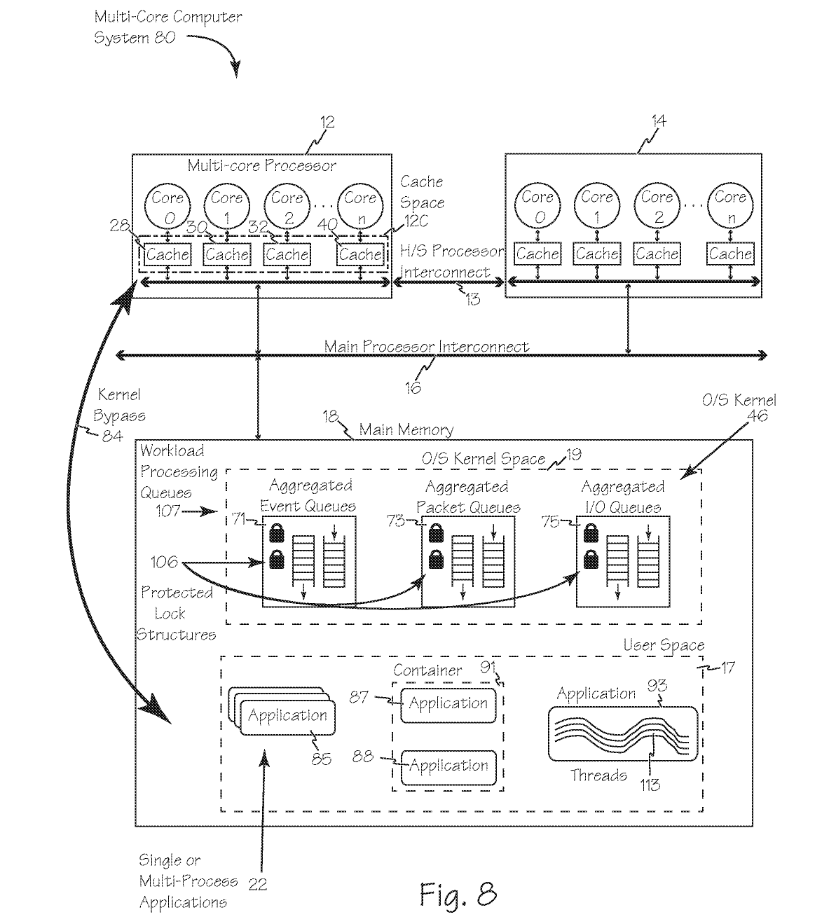

Referring now generally to FIGS. 8-11, execution monitoring operations may include processing centric, application associative, application's threads-of-execution associated, and performance indicative software processing queues of various types and design (e.g., workload queues), and their real-time statistical analysis during the application's execution. Processing queues and their real-time statistical analyses may provide data and just-in-time insights into the application's in situ performance and profile, quality-of-service (QoS), and quality-of-execution (QoE), which in turn may make possible dynamic and intelligent resource monitoring and management, performance monitoring, and automated tuning of applications executing on modern servers, operating systems (OSs), and virtualization infrastructures

Examples of such software processing queues may include purpose-built and de-multiplexed (i.e., application-specific, and application's thread-of-execution specific) user-space event queues, data queues, FIFO (first-in-first-out) buffers, input/output (I/O) queues, packet queues, and protocol packet/event queues, and so on—queues of diverse types with different scheduling properties—queues that need to be emptied and queue elements processed by an application as it executes. Examples of applications include standard server software running atop operating systems (OSs) and virtualization frameworks (e.g., hypervisors, and containers), like web servers, database servers, NoSQL servers, video servers, general server software, and so on.

Multiplexed forms of these software queues may be embedded inside the kernel of a traditional OS such as Unix®, and its variants such as Linux®, and provide aggregated and multiplexed data about the total performance of multiple and concurrently running applications managed by the OS, which in turn may be a symmetric multi-processing (SMP) OS in the increasingly multi-core and multi-processor world of servers and datacenters. Analyzing such OS-based queues with aggregated data does not provide each application's (i.e., de-multiplexed and detailed) performance and workload-processing ability and QoS, but rather the total performance of all “concurrently” running user-space applications on the SMP OS.

Multiple, concurrent, and strongly application-associative software processing queues may each be mapped and bounded to each of an application's threads of execution (processes or threads or other execution abstractions), for one or more applications running concurrently on the SMP OS, which in turn may run with or without a hypervisor over one or more shared memory multi-core processors. Each of these application-specific processing queues may provide granular visibility into when and how each of an application's threads of execution are processing the queue and the associated data and meta-data of each of the queue elements in real time (typically representing workloads for an application), for all applications and application threads of execution running on the SMP OS. The result is that in situ performance profiles, workload handling, and QoE/QoS of the applications and their individual threads of execution can be measured and analyzed individually (and obviously also in totality) on an SMP OS for granular monitoring and resource management in real time and in situ.

Referring now more specifically to FIG. 8, computer system 80 may include a single multi-core processor, e.g. processor 12 with CPU cores 0 to 3, or may include a plurality of multiple core processors e.g., processor 12 and processor 14 including cores 0 to 3, interconnected for shared memory by interconnect 13—such as a conventional Intel Xeon® processors. An SMP (symmetric multiprocessing) OS, such as Linux® SMP, may include in its kernel space, illustrated in this figure as OS kernel 46, used to run over many such CPU cores in their cache coherent domain as a resource manager. SMP OS kernel 46 may make available virtualization services, e.g., Linux® namespaces and Linux® containers. SMP OS kernel 46 may be a resource manager for scheduling single threaded applications (e.g., either single process or multi-process) such as the applications of group 22, multi-process application 93 with threads 113, as well as applications in an application group such as container 91, to execute in its user-space for horizontal scale-out and scalability and application concurrency, and in some cases, resource isolations (i.e., namespaces and containers).

In server/datacenter applications (as opposed to client-applications such as smartphones, in a client-server model) applications of group 22, container 91 an/or multithreaded application 93 may be processing workloads generated from clients or server applications—using the OS managed processer and hardware resources (e.g., CPU/core cycles, memories, and network and I/O ports/interfaces)—to produce useful results. For each “unit of workload” (henceforth, shortened to “workload”), an application needs to process to produce results, and as incoming workloads get assigned to an application on an ongoing basis, this processing can be modeled and may be implemented as a queue of workloads in a software processing queue, such as workload processing queues 107 illustrated in SMP OS kernel 46. In workload processing queues 107, first in, first out (FIFO) queues, such as event queues 71, packet queues 73, I/O queues 75 and/or other queues as needed, may be continually being emptied by the application (such as applications of group 22, container 91 and/or 93) by extracting queue elements one by one to process in that application as it executes. Each element in FIFO software processing queues 107 abstracts and represents a workload (a unit of work that needs to be done) and its associated data and metadata as the case maybe. Incoming queue elements in ingress processing queues 71, 73, 75 (if present) may be picked up by applications in groups or containers 22, 91 and/or 93 to be processed, and the processed results may be returned as outgoing queue elements in egress processing queues 71, 73 and/or 75 (if present) to be returned to the workload requesters (e.g., clients).

With resources, such as CPU cycles, memories, network/IO, and the like, are assigned by SMP OS kernel 46, applications in groups or containers 22, 91 and/or 93 need to empty and process the workloads of software processing queues 71, 73 and/or 75 fast enough to keep up with the incoming arrival rate of workloads. If the applications cannot keep up with the workload arrivals, then processing queues will grow in queue lengths and will ultimately overflow. Therefore, resource management in application processing in this context is about assigning minimally sufficient resources in real-time so that various applications on the SMP OS can keep up with the arrivals of workloads in the software processing queues.

Linux® is currently the most widely used SMP and will be used as the exemplar SMP OSs. Conventional SMP OSs may, inside SMP Linux® kernel 46, include workload processing queues 107 such as lock protected 106 data structures of various sorts including for example event queue 71, packet queue 73 and I/O queue 75 and the like. However, OS kernel queues, such as workload processing queues 107, are multiplexed and aggregated across applications, processes, and threads, e.g., all event workloads among all processes, applications and threads managed by SMP OS kernel 46, may be multiplexed and grouped into a common set of datastructures, such as an event queue.

Therefore, monitoring the queue performance and behavior of these shared, lock protected queues 71, 73 and 75, if implemented, primarily provides information and indications of the total workload processing capabilities of all the applications/processes/threads in the SMP OS, and provide little if any information about the individual workload processing performance and behavior of individual applications, individual processes, and/or individual threads. Hence application and application based performance, Quality of Execution (QoE) and Quality of Service (QoS) data from analyzing multiplexed OS kernel queues, such as queues 71, 73 and 75 and/or from their behavior, may be minimal and/or not very informative.

It is advantageous to monitor the performance of individual processes and individual threads and individual applications, each of which may be resource schedulable entities in the SMP OS. Without knowledge of their un-aggregated QoS (and violations thereof) it is difficult if not impossible to perform active QoS-based resource scheduling and resource management. The same applies to virtualization and OS-based virtualization, where hypervisors and SMP OSs may be used as another group of resource managers to manage resources of VMs and containers.

Kernel emulation/bypass 84 may provide more useful data, related to the execution performance of single or multi-process applications 22, applications 87 and 88 in container or application group 91, and/or the of threads 113 of multi-threaded application 93 than would be available from aggregated kernel queues 71, 73 and 75 in SMP OS kernel space 19. As noted above, data derived from SMP kernel space 19 are multiplexed and aggregated across applications, processes, and threads, e.g., all event workloads among all processes, applications and threads managed by SMP OS kernel 46. Kernel emulation or bypass 84 may provide, de-multiplexed, disaggregated FIFO queue data in user-space for individual processes during execution including data for a single process of a single application, multiple processes for a single application, each thread of a multi-threaded application and so on.

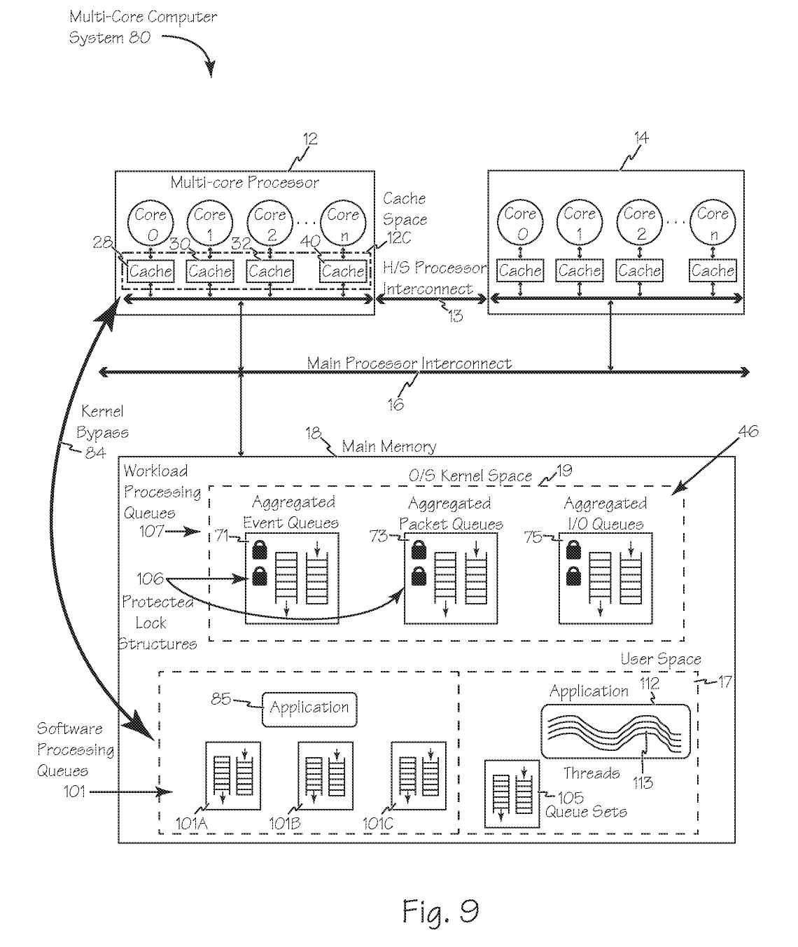

Referring now to FIG. 9, computer system 80, running any suitable OS 46, e.g., Linux®, Unix® and Windows® NT, provides QoS/QoE indicators and analysis for individual applications and their individual threads of execution (processes, and threads), by, for example, creating and instantiating non-multiplexed and un-aggregated sets of software processing queues 101 in user-space 17 for single process application 85 as well as queue sets 105 for threads 113 of multi-threaded application 112. (Windows is a registered trademark of Microsoft, Inc.) In particular, user-space queue set 101 may include ingress and egress event queues 101A, packet queues 101B and I/O queues 101C bound to application 85. The goal or task of the process of application 85 is to keep up with the workload arrivals into these processing queues 101A, 101B and 101C in order to perform useful work within the limitations of the resources provided thereto.

For a multiple process application 85, queue sets 101 may be provided for each process beyond the first process. Multi-threaded applications, such as application 93, queue sets 105 may include a set of ingress, egress and I/O queues (and/or other sets of queues as needed) for each thread 113.

For example, in queue sets 101, event-based processing queues 101A, packet-based processing queues 101B and/or one or more other processing queues 101C are instantiated in user-space 17 and associated or bound to the process execution for application 85 (assuming a single process application). Processing queues 101A, 101B and 101C may be emptied and their workload (queue elements) may be processed by single processor application 85, which gets notified of events (via event queue) and process packets (via packet queue), before returning results. The performance and behavior of these two event and packet processing queues are indicative of how and whether the application 85, given the resources allocated to it, can keep up with the arrivals of the workloads (events and packets) designated only for application 85. Monitoring and analysis of queues 101A, 101B and/or 101C may provide direct QoS/QoE visibilities (e.g., event/packet workload congestions) into the application 85.

Similar logic and design applies to multi-threaded application 93 and its de-multiplexed and disaggregated software processing queues 105.

It may be beneficial to create and instantiate workload types of specific relevance to an application. For example, for an application that is event and network (e.g., TCP/IP) driven, such as a web server or a video server, event and packet processing queues may beneficially be created. Thus, these software processing queues may be application workload specific. As a corollary, not all kernel queues need to be de-multiplexed, and some of those such as shared or kernel queues 101B not specific to particular application types, in the SMP OS kernel may be used even though protected, and limited, by lock structures 106.

Queue sets 101 and 105 may be created using user-space OS emulation and/or system call interception and/or advantageously by kernel bypass techniques as discussed above.

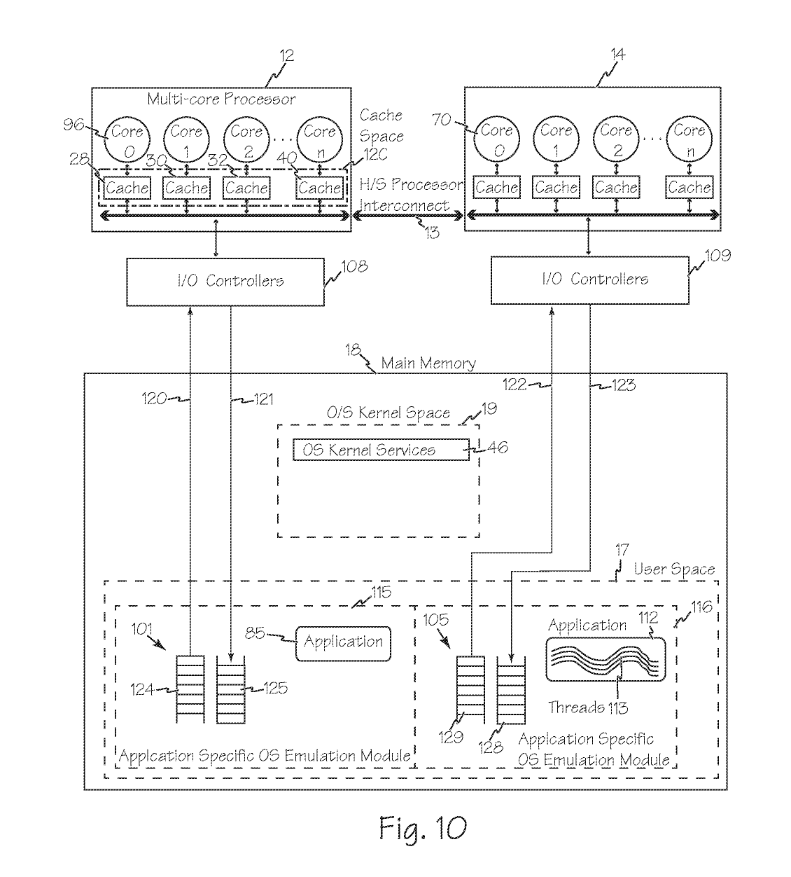

Referring now to FIG. 10, kernel bypass techniques are advantageously used to both a) instantiate user-space monitoring queues sets 101 and 105 in application specific OS emulation modules 115 and 116 respectively and operate individual cores and b) Emulation modules 116 and 115 may each be containers, other groups of related applications or the like as described herein. Kernel bypass techniques as discussed above may also be used advantageously to operate each of cores 0, 1, 2 and 3 of multi-core processor 12, and cores 0, 1, 2 and 3 of multi-core processor 14, in parallel.

As a result, user-space application, process and/or thread specific queues, such as queue sets 101 and 105 may be instantiated and to bound to individual applications, processes and/or threads such as one or more execution processes in application 85 and threads 113 of multi-threaded application 93. Queue sets 101 and 105 may be said to be de-multiplexed in that they are non-multiplexed and/or not aggregated application, process or thread specific workload processing queues as opposed to the multiplexed and aggregated workload queues, such as workload processing queues 107 in OS kernel 46, discussed above with regard to FIG. 9.

One of the major advantages of using kernel bypass techniques as described herein is that such non-multiplexed and non-aggregated workload processing queues may be operated while avoiding i.e., bypassing) the contention-based and contention-prone (e.g., kernel lock protected) queues that may be embedded in OS kernel 46. For example, software processing queues may be provided to perform kernel by-pass connections or routings such as kernel bypasses, 120, 121, 122 and 123 by OS emulation in the operating system's user-space, user-space 17.

For example, software processing queue sets 101 and 105 may be instantiated in user-space 17 and may include, for example, ingress queue 125 and egress queue 124 for application 85 and ingress queue 129 and egress queue 128 for application 93 and/or for sets of ingress and egress queues for each thread of application 93. Queue sets 101 and 105 may be embedded in user-space OS emulation modules (process or thread/library based) that intercept system calls from individual applications and/or threads such as process-based application 85 or thread-based application 93 including threads 113. Since OS emulation modules are application process/thread specific, the resulting embedded software processing queues are application process/thread specific.

Such software processing queues in many cases may be bi-directional, i.e., ingress queues 125 and 129 for arriving workloads, and egress queues 124 and 128 for outgoing results, i.e. after execution the application, process or thread of the relevant applications. OS emulation in this case may be principally responsible for intercepting standard and enhanced OS system calls (e.g., POSIX, with Linux® GNU extensions, etc.) from applications 85 as well as each of threads 113 of application 93 and for executing such system calls in their respective application-specific OS emulation modules 116 and 115 and associated software processing queues, such as queue sets 101 and 105, respectively. This way, queues and emulated kernel/OS threads of execution may be mapped and bounded individually to specific applications and their respective threads of execution.

Separating and de-multiplexing workloads, i.e., by creating non-multiplexed, non-aggregated queues, using user-space software processing queue sets 101 and 105 that are application and process/thread specific may require separating, partitioning, and dispatching various queue-type-specific workloads as they arrive at the processors' peripherals such as Ethernet controller 108 and Ethernet controller 109. In this manner, these workloads can reach the designated cores, core 96 (e.g., the 0th core of multiprocessor 12) for Ethernet controller 108 and core 70 (e.g., the 0th core of multiprocessor 14) for Ethernet controller 109 and their caches as well as the correct software processing queues 101 and 105 so that locality of processing (including that for the OS emulations) can be preserved without unnecessary cache pollution and inter-core communication (hardware-wise, for cache coherence).

Conventional programmable peripheral hardware (e.g., Ethernet controllers, PCIe controllers, and storage controllers, etc.), may dispatch software-controlled and hardware-driven event and data I/O directly to processor cores by programming (for example) forwarding, filtering, and flow redirection tables and DMA and various control tables embedded in the peripheral hardware such as Ethernet controller chips 108 and 109. These controller chips, can dispatch appropriate events, interrupts, and specific TCP/IP flows to the appropriate processor cores and their caches and therefore to the correct software processing queues for local processing of applications' threads of execution. Similar methods for dispatching events and data exist in storage and I/O related peripherals for their associated software processing queues.

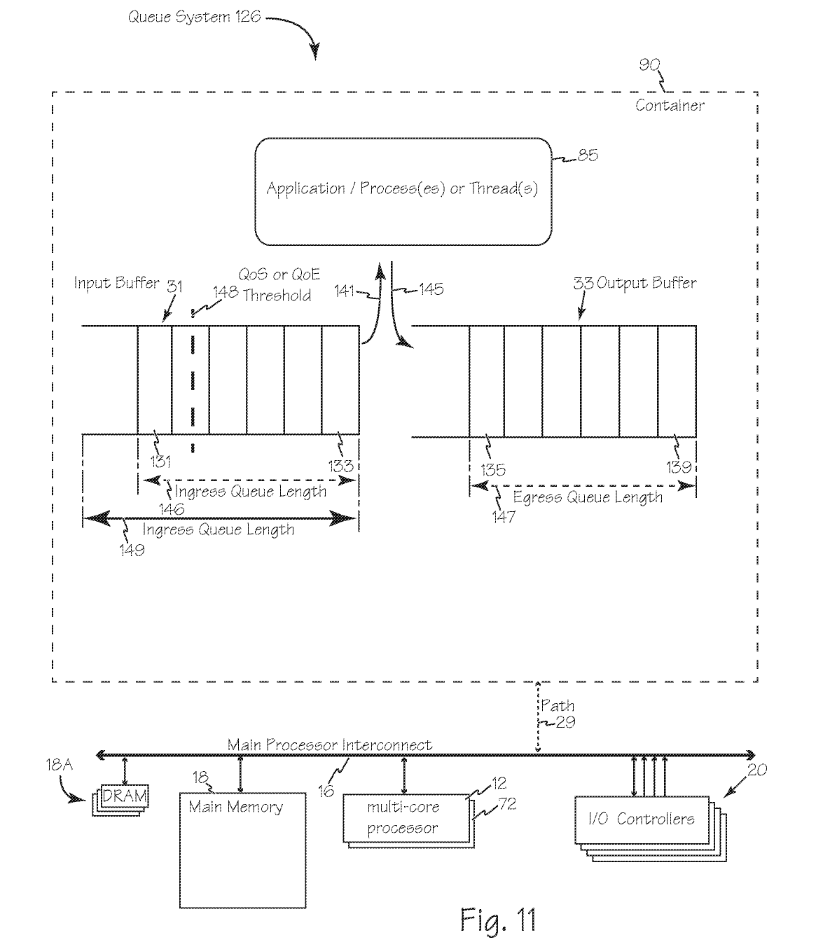

Referring now to FIG. 11 in queue system 126, ingress FIFO (first-in-first-out) software processing queue, buffer 31 may be associated with process or thread 85 for incoming workloads (e.g., packets) which area represented as arriving queue elements 131 being deposited into queue 31. Ingress queue element 133 is applied by input process 141 to process or thread 85 for execution. Upon execution of ingress queue element 133 by process or thread 85, output process 145 applies one or more queue elements 135 (the result of processing element 133) to the input of egress queue 33.

As a result, execution of queue element(s) 133 by process or thread 85 includes:

1) receiving arriving queue element 131 in arriving, input or ingress queue 31,

2) removing queue element(s) 133 from the arriving workloads buffered in ingress queue 31 in a first in, first out (FIFO) manner,

3) applying element(s) 133 via input process 141 to process or thread 85,

4) execution of element(s) 133 by thread or process 85 to produce one or more elements 135 (which may be the same as or different from element(s) 133),

5) applying element(s) 135 via output process 145 to the input of egress queue 33, and

6) once egress queue 33 is full, causing one or more queue elements 139, queue element(s) 139 being the earliest remaining queue element(s) in egress queue 33, to be removed from egress queue 33.

If process or thread 85 is non-blocking and event-driven software, ingress queue elements 131 may be applied to ingress queue 31 by system call interceptions, by kernel bypass or kernel emulation as described above. On removing a queue element 139 from egress queue 33 (together with its data and metadata, if any), application 85 would perform processing, and on completion of processing the specific workload represented by the queue element, application 85 would apply output processing 145 to move the corresponding results into egress queue 33.

From a resource management and resource monitoring perspective, with a set of assigned resources (e.g., CPU/core cycles, memories, network ports, etc.) application 85 may need to process the arriving workloads 131 in a “timely” manner, i.e., the processing throughput (per unit time) preferably matches the arrival rate of the workloads 131 being deposited into the ingress software processing queue 31. Processing timeliness (application responsiveness) is dearly relative and a trade-off against throughput, while persistent high arrival rate of workloads relative to application's processing rate would ultimately lead to queue overflow (e.g., when queue length 146 is greater than allocated queue depth 149) and dropped workload(s). Thus, it may be desirable for through-put sensitive applications to maximize the average queue length 146 without having the average queue 146 exceed or get too close to the allocated queue depth 149. For latency-sensitive applications, on the other hand, it may be desirable for queue length 146 and allocated queue depth 149 to be small, so that as workloads arrive they are not buffered (in queue 31) long at all and as soon as feasible are picked up application 85 for processing to minimize latencies.

With a set of assigned resources, application 85 may process workloads over a sliding time window (predefined, or computed), and end up in either of two ways. In the first way, application 85 may manage to keep up with processing the arriving workloads 131 in the queue 31 (of finite allocated queue depth 149), and in this case, using that sliding window to compute averages, the running average of the queue length 146 would not exceed a maximum value (in turn less than a pre-set maximum allocated queue depth 149) if the running average continues indefinitely, or equivalently, no queue elements (or workloads) would be dropped from the queue 31 due to overflows. Alternately, application 85 may fail to keep up (for a sufficient amount of, and/or for a sufficiently long, time) with the arrival of workloads 131, and in this case, the running average of queue length 146 would increase beyond the maximum allocated queue depth 149 and the last one or more queue elements (or workloads) 135 would be dropped due to queue overflow.

Therefore, computing and monitoring the running average queue length 146 (and running averages of higher-order statistical moments of the queue length 146 such as its running standard deviation and average standard deviation) of a software processing queue may provide useful, sensitive, and direct measures of the quality-of-service (QoS) and/or quality-of-execution (QoE) of application, process or thread 85 in processing its arriving workloads, given a set of resources (e.g., CPU/core cycles, and memories) assigned to it either statically or dynamically.

Similar measurements and/or data collection may be accomplished using egress queue length 147 and an appropriate QoE, QoS or other processing or resource related threshold.

QoS/QoE queue threshold 148 may be used to detect application's 85 (and its threads' of execution) QoS violations, degradations, or approach to degradations, for resource and application monitoring, and resource management and scheduling. Two methods in general can be used to compute or configure QoS threshold 148: (a) a priori manual configuration, and (b) automated calculation of threshold via statistical analysis of performance data.

Alternately, statistical computed queue threshold 148 may involve application-specific measurement and analysis either online or off-line, in which an instance of the application, such as application, process or thread 85, may be executed that fully utilizes all resources of a normalized resource set (e.g., of CPU/core cycles, memories, networking, etc.) under a measured “knock-out” workloads arrival rate, i.e., the rate of arrival of arriving queue elements 131 which results in an arriving queue element such as ingress queue 131 being dropped or queue overflow. The resulting average queue length 146 and its high-order statistical moment (e.g., standard deviation) may be measured and their statistical convergence tested. Queue threshold 148 can be computed as a function of the resulting measured/tested average and the resulting measured/tested statistical moment (e.g., standard deviation). A QoE/QoS violation signifying workload congestion of the application 85 may then be expressed as running average of queue length exceeding queue threshold for some pre-set or computed duration by some multiple of the “averaged” standard deviation for the application and hardware in question.

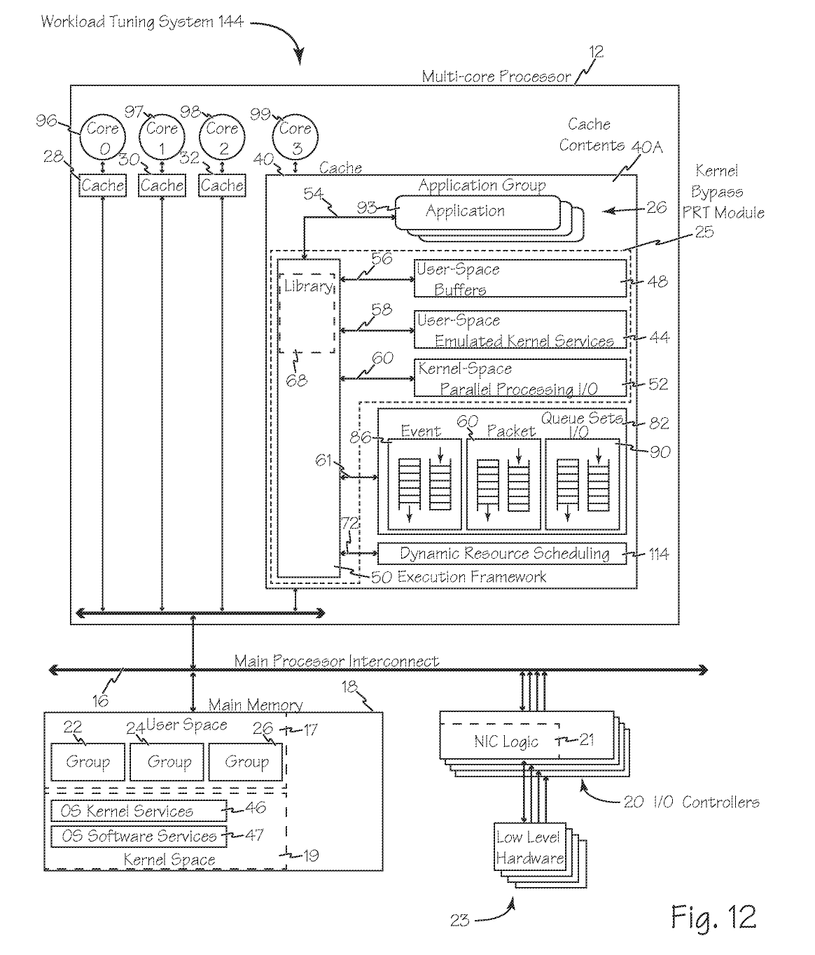

Referring now to FIG. 12, workload tuning system 144 may include one or more processors, such as multi-core processor 12 having for example cores 0 to 3 and related caches, as well as main memory 18 and I/O controllers 20, all interconnected via main processor interconnect 16. Parallel run time module (PRT) 25 may include user-space emulated kernel services 44, kernel space parallel processing I/O 52, execution framework 50 and user-space buffers 48. Queue sets 82 may include a plurality of event, packet and I/O queues 86, 60 and 90 respectively or similar additional queues useful for monitoring the performance of an application during execution such as process 1 of software application 87 of group 24.

Dynamic resource scheduler 114 may be instantiated in user-space 17 and combined with PRT 25, event, packet and I/O queues 86, 60 and 90 respectively of software processing queues such as queue sets 82 and the like, and one or more applications such as application 87 in group 24, executing on one of a plurality of processor cores, such as core 97, for example for exchanging data with Ethernet or block I/O controllers 20, to improve execution performance. For example, the execution of latency sensitive or throughput-sensitive applications as well as create execution priorities to achieve QoS or other requirements.

Dynamic resource scheduler 114 may be used with other queues in queue sets 82 for dynamically altering the scheduling of other resources, e.g. exchanging data with main memory 18. Scheduler may be used to identify, and/or predict, data trends leading to data congestion, or data starvation, problems between one or more queues, for example in queue sets 82, and relevant external entities such as low level hardware connected to I/O controllers 20.

In particular, dynamic resource scheduler 114 may be used to dynamically adjust the occurrence, priority and/or rate of data delivery between queues in queue sets 82 connected to one of I/O controllers 20 to improve the performance of application 87. Still further, dynamic resource scheduler 114 may also improve the performance of application 93 by changing the execution of application 87, for example, by changing execution scheduling.

Each application process or thread of each single-threaded, multi-threaded, or multi-process application, such as process 1 of application 87, may be coupled with to an application-associative PRT 25 in group 24 for controlling the transfer of data and events via one or more I/O controllers 20 (e.g., network packets, block I/O data, events). PRT 25 may advantageously be in the same context, e.g., the same group such as group 24 or otherwise in the application process address space, to reduce mode switching and reduce use of CPU cycles. PRT 25 may advantageously a de-multiplexed, i.e., non-multiplexed, application-associative module.

PRT module 25 may operate to control the transfer of data and events (e.g., network packets, block I/O data, events) from hardware 23 (such as Ethernet controllers and block I/O controllers 20 and software entities to software processing queues, such as event, packet and/or I/O queues 86, 60 and/or 90 associated with application 93. Data is drawn from one or more software processing, incoming queues of queue sets 82, to be processed by application 87 in order to generate results applied to a related outgoing queues. Resource scheduler 114, may be in the same or different context with application 87 and PRT 25, decides the distribution of resource to be made available to application 87 and/or PRT 25 and/or other modules, such as buffers 48, in application group 24.

User-space 17 may be divided up into sub-areas, which are protected from each other, such as application groups 22, 24 and 26. That is, programming, data, execution processes occurring in any sub-areas, such as in one of application groups 22, 24 and 26 (which may for example be virtualized containers in a Linux® OS system), are prevented from being altered by similar activities in any of the other sub-areas. Kernel-space 19, on the other hand, typically has access to all contents of user-space 17 in order to provide OS services.

Complete or partial application, and/or group specific, versions of PRT 25, workload queue sets 82 and dynamic resource scheduling engine 114 may be stored in application group 24 in user-space 17 of main memory 18, while parallel processing I/O 52 may be added to kernel space 19 of main memory 18 which may include OS kernel services 46 and OS software services 47 created, for example, by an SMP OS. Resource scheduler 114 may advantageously reside in the same context as application 87 and PRT 25. In appropriate configurations, scheduler 114 may reside in a different context space.

Kernel bypass PRT 25 may be configured, during start up or thereafter, to process application group 24 primarily, or only, on core 98 of processor 12. That is, PRT module 25 executes application 87, PRT 25 itself, as well as queue sets 82 and resource scheduling 114, on core 98. For example, PRT 25, using interceptor or library 68 or the like, may intercept some or all system calls and software calls and the like from application 87 and apply such system calls and software calls to emulated kernel services 44, and/or buffers 48 if present, for processing. Parallel processing I/O 52, programmed by PRT 25, will direct each of the controllers in I/O controllers 20 which handle traffic, e.g., I/O, for application 87, to direct all such I/O to core 98. The appropriate data and information also flows in the opposite direction as indicated by the bidirectional arrows in this and other figures herein.

As discussed above in various figures, the execution processing of applications in group 24 may advantageously be configured in the same manner to all or substantially all occur on core 0 of processor 12. The execution processing of applications in group 24 may advantageously be configured in the same manner to occur on core 1 of processor 12. As shown in FIG. 5, the execution processing of applications in group 24 may advantageously be configured in the same manner to all or substantially all occur on core 97 of processor 12.

As a result of the use of an application group specific version of PRT 25 in each of groups 22, 24 and 26, cores 0, 1 and 3 of processor 12 may each advantageously operate in a parallel run-time mode, that is, each such core is operated substantially as a parallel processor, each such processor executing the applications, processes and threads of a different one of such application groups.

Such parallel run-time processing occurs even though the host OS may be an SMP OS which was configured to run all applications and application groups in a symmetrical multi-processing fashion equally across all cores of a multi-core fashion. That is, in a conventional computer system running an SMP host OS, e.g., without PRT 25, applications, processes and threads of execution would be run on all such cores. In particular, in such a conventional SMP computer system, at various times during the execution of application 93, cores 0, 1, 2 and 3 would all be used for the execution of application 93.

PRT 25 advantageously minimizes processing overhead that would other result from processing execution related activities in lock protected facilities in OS kernel services 46 of kernel-space 19. PRT 25 also maintains and maximizes cache coherency in cache 32 further reducing processing overhead.

For convenience of description, portions of main memory 18, relevant to the description of execution monitoring and tuning 110, are shown included in cache contents 40A together although they may not be present at the same time in cache 32. Also for convenience, OS software services 47 and OS kernel services 46 of kernel-space 19 are illustrated in main memory 18, but not repeated in the illustration of cache contents 40A, even though some portions of at least OS software services 47 will likely be brought into cache 32 at various times and portions of kernel services 46 of kernel-space 19 may or advantageously may not brought into cache 32 during execution of software application 93 and/or execution of other software applications, process or threads, if any, in group 26.

In addition to portions of software application 93, cache contents 40A may include application and/or group specific versions of execution framework 50, software call interceptor 68 and kernel bypass parallel run-time (PRT) module 25 which advantageously reduces or eliminates use of OS kernel 47 and causes execution of process 1 on core 98 and cache 32, even though the host OS maybe an SMP OS. The operation of PRT module 25 in this manner substantially reduces processing time and provides for greater scalability especially in high processing environment, such as datacenters for cloud based computing.

In group 24, and therefore at times in cache 32 as shown in cache contents 40A, execution framework 50 may be connected to application specific, and/or application group specific, versions of buffers 48, emulated kernel services 44, parallel processing I/O 52, workload queue sets 82 and dynamic resource scheduling engine 114 via connection paths 54, 56, 58, 60, 61 and 63, respectively. Framework 50, application 93, buffers 48, emulated kernel services 44, queue sets 82 and resource scheduling 114 may be stored in user-space 17 in main memory 18 while kernel-space parallel processing I/O 52 may be stored in kernel space 19 of main memory 18.

Intercepted system calls and software calls, after applied to application or group specific emulated kernel services 44 for user-space resource and contention management rather than incurring the processing and transfer overhead costs traditionally encountered when processed by lock protected facilities in OS kernel services 46.

Processing in buffers 48, as well as in emulated kernel services 44, occurs in user-space 17. Emulated or virtual kernel services 44 is application or group specific and may be tailored to reduce overhead processing costs because software the applications in each group may be selected to be applications which have the same or similar kernel processing needs. Processing by buffers 48 and kernel services 44 is substantially more efficient in terms of processing overhead than OS kernel services 46, which must be designed to manage conflicts within each of the wide variety of software applications that may be installed in user-space 17. Processing by application or application specific buffers 48 and kernel services 44 may therefore be relatively lock free and does not incur the substantial execution processing overhead, for example, required by the repetitive mode switching between user-space and kernel-space contexts.

Execution framework 50, and/or OS software services 47, together with emulated kernel services 44 may be configured to process all applications, processes and/or threads of execution within group 24, such as application 93, on one core of multiprocessor 12, e.g., core 98 using cache 32 to further reduce execution processing overhead. Parallel processing I/O 52 may reside in kernel-space 19 and advantageously may program I/O controllers 20 to direct interrupts, data and the like from related low level hardware, such as hardware 23, as well software entities, to application 93 for processing by core 98. As a result, cache 32 maintains cache coherency so that the information and data needed for processing such I/O activities tends to reside in cache 32.

In a typical SMP OS system, in which multiple cores are used in a symmetrical multiprocessing mode, the data and information needed to process such I/O activities may be processed in any core. Substantial overhead processing costs are traditionally expended by, for example, locating the data and information needed for such processing, transferring that data out of its current location and then transferring such data into the appropriate cache. That is, using a selected one of the multiple cores, e.g. core 3 labeled as core 98, of multi-processor 12 for processing the contents of one application group, such as group 26, maintains substantial cache coherency of the contents of cache 0 thereby substantially reducing execution processing overhead costs.

The execution of software application 93, of group 26/container 93, in cache 40 is controlled by kernel-bypass, parallel run-time (PRT) module 25 which includes framework 50, buffers 48, emulated kernel services 52 and parallel processing I/O 52. PRT module 25 thereby provides two major processing advantages over traditional multi-core processor techniques. The first major advantage may be called kernel bypass, that is, bypassing or avoiding the lock protected OS kernel services 46 in kernel-space 19 by emulating kernel services 46 in kernel-space 19 optimized for one or applications in a group of applications related by their needs for such kernel services. The second major advantage may be called parallel run-time or PRT which uses a selected core and its associate cache for processing the execution of one or more kernel service related applications, processes or threads for applications in a group of related applications.

Execution monitoring and tuning system 114, to the extent described so far, provides a lower processing overhead cost, compared to traditional multi-core processing systems by operating in what may be described as a kernel bypass, PRT operating mode.

Queue sets 82 may be instantiated in cache 40 to monitor the execution performance of each of one or more applications, processes and/or threads of execution such as the execution of single process application 93. In addition to monitoring each of the applications, processes or threads in a container or group, such as group 24, the information extracted from queue sets 82 may advantageously be analyzed and used to tune, that is modify and beneficially improve, the ongoing performance of that execution by dynamically altering and improving the scheduling of resources used in the execution of application 93 in tuning system 144.

Cache contents 40A may also include an instantiation of dynamic resource scheduling system 114 from group 26 of user-space 17 of main memory 18. Resource scheduling 114, when in cache 40, and therefor at various times in cache contents 40A, may be in communication with execution framework 50 via path 63 and therefore in communication with parallel processing I/O 52 and queue sets 82 as well as other content in group 26.

Resource scheduling system 114 can efficiently and accurately monitor, analyze, and automatically tune the performance of applications such as application 93, executing on multi-core processor 93. Such processors may be used for example in current servers, operating systems (OSs), and virtualization infrastructures from hypervisors to containers.

Resource scheduling system 114 may make resource scheduling decisions based on direct and accurate metrics (such as queue lengths and their rates of change as shown in FIG. 11 and related discussions) of the workload processing centric, application associative, application's threads-of-execution associated, and performance indicative software processing queues of various types and designs such as queue sets 82. Queue sets 82 may, for example, include event queues 86, packet queues 60 and (I/O) queues 90. Each such queue may include an ingress or incoming queue and an egress or outgoing queue as indicated by arrows in the figure.

PRT module 25, discussed above, manages the software processing queues in queue sets 82, transferring information (e.g., events, and application data) from/to the queues in queue sets 82 effectively assigning work to and receiving results of the execution processing of application 93 from queue sets 18. Resource scheduling system 114 may enforce scheduling decisions via PRT 25, e.g. by programming I/O controllers 20 via main processor interconnect 16, for different types of applications, different quality-of-service (QoS) requirements, and different dynamic workloads. Such I/O programming may resides for example in network interface controller (NIC) logic 21.

In particular, resource scheduling system 114 may tune the performance of software applications, such as application 93, in at least four different scenarios as described immediately below.

For latency-sensitive applications, resource scheduler 114 may immediately schedule application 93 to execute data, upon delivery to input software queues of queues 86, 60 and/or 90 in queue sets 82. Resource scheduler 114 may also schedule data to be removed from output software queues of queues 86, 60 and 90 in queue sets 82 as fast as possible.

For throughput-sensitive applications, resource scheduler 114 may configure PRT 25 to batch a large quantity of data from/to the output/input queues of queue sets 82 to improve application throughput by, for example, avoiding unnecessary mode switches between application 93 and PRT 25.

Resource scheduling system 114 may also instruct other elements of PRT 25 to fill and empty certain input and output software processing queues in queue sets 82 in higher priority according to quality-of-service QoS requirements of application 93. These requirements can be specified to resource scheduler 114, for example from application 93, during application start-up time or run-time.

Resource scheduling system 114, may identify congestions or starvations on some software processing queues in queue sets 82. Similarly, scheduler 114 may identify real-time trending of data congestions/starvations between software queues 82 and relevant external entities, for example from the status of hardware queues such as input/output packet queues 60. Scheduler 114 can dynamically adjust the data delivery priority of the various input and output software processing queues via PRT 25 and change the execution of application 93 with regard to such queues, to achieve better application performance.

Schedulable resources that are relevant to application performance include processor cores, caches, processor's hardware hyper-threads (HTs), interrupt vectors, high-speed processor inter-connects (QPI, FSB), co-processors (encryption, etc.), memory channels, direct memory access (DMA) controllers, network ports, virtual/physical functions, and hardware packet or data queues of Ethernet network interface cards (NICs) and their controllers, storage I/O controllers, and other virtual and physical software-controllable components on modern computing platforms.

As illustrated in cache contents 40A, application 93 is coupled with parallel run-time (PRT) module 25 which is bound or associated therewith. PRT 25 may control transfer of data and events (e.g., network packets, I/O blocks, events) between by low level hardware as well as software entities, to and from queue sets such as queue sets 82 for processing. Application 93 draws incoming data from various input software processing queues, such as shown in event, packet or I/O queues 86, 60 and 90 respectively, to perform operations as required by the algorithmic logic and internal states run-time of application 93. This processing generates results and outgoing data and which are transferred out from the appropriate outgoing queues of event, packet or I/O queues 86, 60 and 90, for example, back to I/O controllers 20.

PRT 25, queue sets 82 and resource scheduler 114 may preferably execute within the same context (e.g., same application address space) as application 93, that is, with the possible exception of parallel processing I/O 52, may execute at least in part in user-space 17. Executing within the same context is substantially advantageous for execution performance of application 93 by maximizing data locality and substantially reducing, if not eliminating, cross-context or cross address space data movement.

Executing within the same context also minimizes the scheduling and mode switch overhead between the application 93, scheduler 114 and/or PRT 25. It is important to note, that PRT 25, queue sets 82 and scheduler 114 consume the same resources as application 93. That is, PRT 25, scheduler 114 and application 93 all run on core 98 and therefore must share the available CPU cycles, e.g. of core 98. Thus, it is desirable to achieve a balance between the resource consumption of scheduler 114, PRT 25 and application 93 to maximize the performance of application 93. The use of groups of programs, related by their types of resource consumption such as groups or containers 22, 24 and 26, and PRT 25 substantially reduces the resource consumption of application 93 by minimizing mode switching, substantially reducing or even eliminating use of lock protected resource management and maintaining higher cache coherency than would otherwise be available when executing in a multi-core processor, such as processor 12.

Referring now FIG. 12, the general operation of tuning system 144 of FIG. 5 is described in more detail. In particular, resource scheduler 114 may receive QoS or similar performance requirements 206 from application 93, or a similar source. Requirements 206 may be specified statically, e.g., during scheduler start-up time or dynamically, e.g., during run-time and/or both.

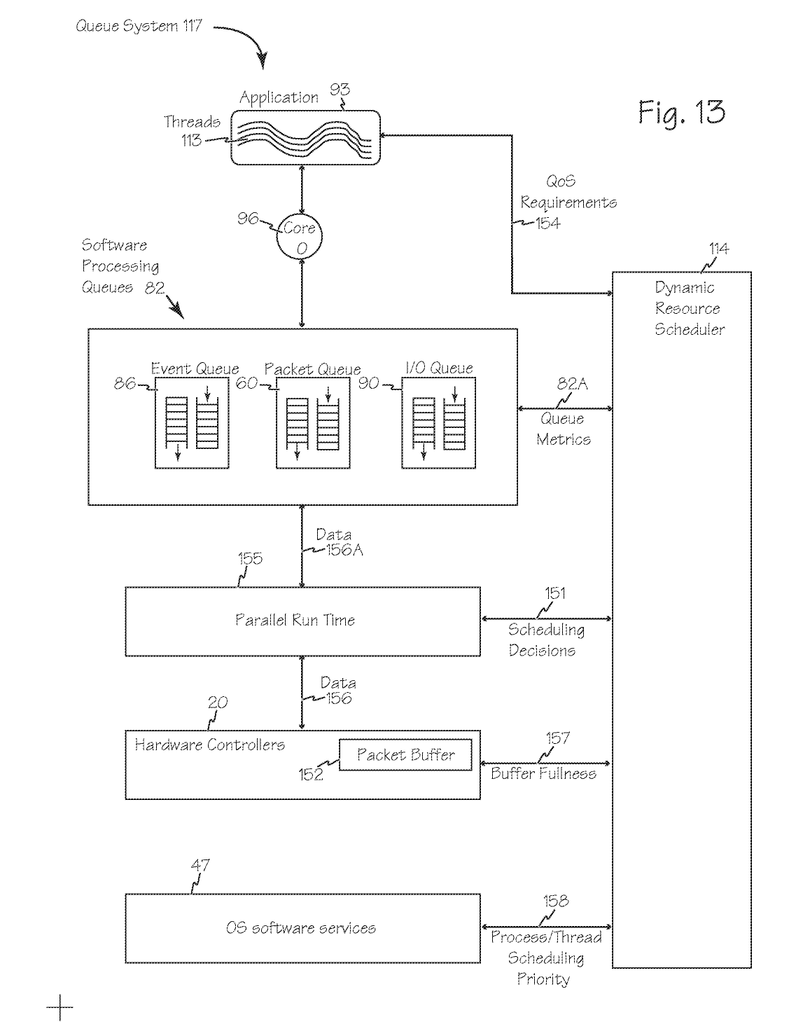

Referring now also to FIG. 13, resource scheduler 114 may monitor, or receive as an input, software processing metrics 82A related to software processing queues 82, e.g., event, packet and I/O queues 86, 60 and 90, respectively, to determine execution related parameters or metrics related to the then current execution of application 93. For example, scheduler 114 may determine, or receive as inputs, the moving average, standard deviation or similar metrics of ingress queue length 146 and/or egress queue length 40. Further, scheduler 114 may compare queue lengths 146 and/or 147 to allocated queue depth 149 and/or QoS or QoE thresholds 148 and/or or receive such information as an input.

Scheduler 114 may also determine, or receive as inputs, execution performance metrics related to hardware resource usage such as CPU performance counters, cache miss rate, memory bandwidth contention rate and/or the relative data occupancy 157 of hardware buffers such as NIC buffers or other logic 21 in I/O controllers 20.

Based on such metrics, scheduler 114 may apply resource scheduling decisions 151 to PRT 25, for example to maintain QoS requirements and/or improve execution performance. Resource scheduling decisions 151 may also be applied by programming hardware control features (e.g., rate limiting and filtering capability of NIC logic 21) and/or software scheduling functions implemented in PRT 25 and/or in OS software services 47. For example, PRT 25, and/or software services 47, may actively alter the resource allocation of core 98 to increase or decrease the number or percentage of CPU cycles to be provided for execution of application 93, and/or to be provided to the OS and other external entities, e.g., to alter process/thread scheduling priority 158 for example in OS software services 44. Resource scheduler 114 may allocate new or additional resources, such as additional CPU cycles of core 98, for processing application 93 if scheduler 114 determines or predicts resource bottlenecks that may, for example, interfere with achievement of QoS requirements 206 of application 93 which cannot otherwise be resolved by resource scheduler 114 using resources then currently in use.

For example, if scheduler 114 determines that input software processing queues, for example in software processing queues 82, are very long for an extended period of time, resource scheduler 114 may decide to reduce the CPU cycles used by PRT 25 in order to slow down the incoming data to input queues of software processing queues 82 and to allocate additional CPU cycles of core 98 for executing application 93 so that application 93 can empty out software processing queues 82 faster.

For example, in a Linux® implementation, resource scheduler 114 may invoke POSIX interfaces to reduce the execution priority of processes or threads within PRT 25 and/or actively command PRT 25 to sleep for some CPU cycles before polling data from hardware.

Referring now to FIG. 13, for latency-sensitive applications as shown in latency tuning operation 117, resource scheduler 114 may configure PRT 25 to deliver the data to one or more of the input software processing queues of queue sets 82 faster and distribute resources more immediately to application 93 so that the application 93 can process data in a timely fashion. Specifically, once PRT 25 delivers small amount of data to the input software queues, resource scheduler 114 may immediately schedules application 93 to processing such incoming data. Moreover, resource scheduler 114 may also schedules PRT 25 to empty out the output software processing queues as fast as possible once output data is available.

Resource scheduling for latency-sensitive applications must be balanced against wasting resources, such as CPU cycles, if such scheduling results in more frequent mode switches between application 93 and PRT 25 which may wasting more resources when using CPU cycles to make scheduling related mode switches. Timely data handling by PRT 25 could also introduce sub-optimal resource usage in the view of throughput, for example, frequently sending out small network packets resulting in a less than optimal use of network bandwidth. Thus, the tuning for latency-sensitive applications may be delimited by certain throughput thresholds of application 93.

The operation of scheduling decisions 151 for latency-sensitive applications, applied by dynamic resource scheduler 114 to PRT 25 and/or to the host OS, are described in this figure with regard to a time sequence series of views of relevant portions of execution monitoring and tuning system 144.

Resource scheduler 114 monitors the software processing queues, which of queue sets 82, for example for queue length moving average and/or standard deviation and the like as well as workload status such as the length of packet buffer 152 in one or more of the Ethernet or I/O controllers 20. Scheduler 114 may make resource scheduling decisions based on such metrics as QoS requirements 154 of application 93.

Resource scheduler 114 enforces decisions 151 by relying on hardware control features (e.g., rate limiting and filtering capability of one or more of the NICs or other controllers of hardware controllers 20. Resource scheduler 114 applies software scheduling functions, such as decisions 151, to be implemented in parallel run time 155 (e.g., PRT can actively yield CPU cycles to the application) and/or provided by OS and other external entities 85 (e.g., process/thread scheduling priority 158). The performance of application 93 is optimized by scheduler 114 by adjusting the distribution of resources between the PRT 155 and the application 93 and as well as data movement 156 from I/O controllers to PRT 155 and data movement 156A to software processing queues 82.

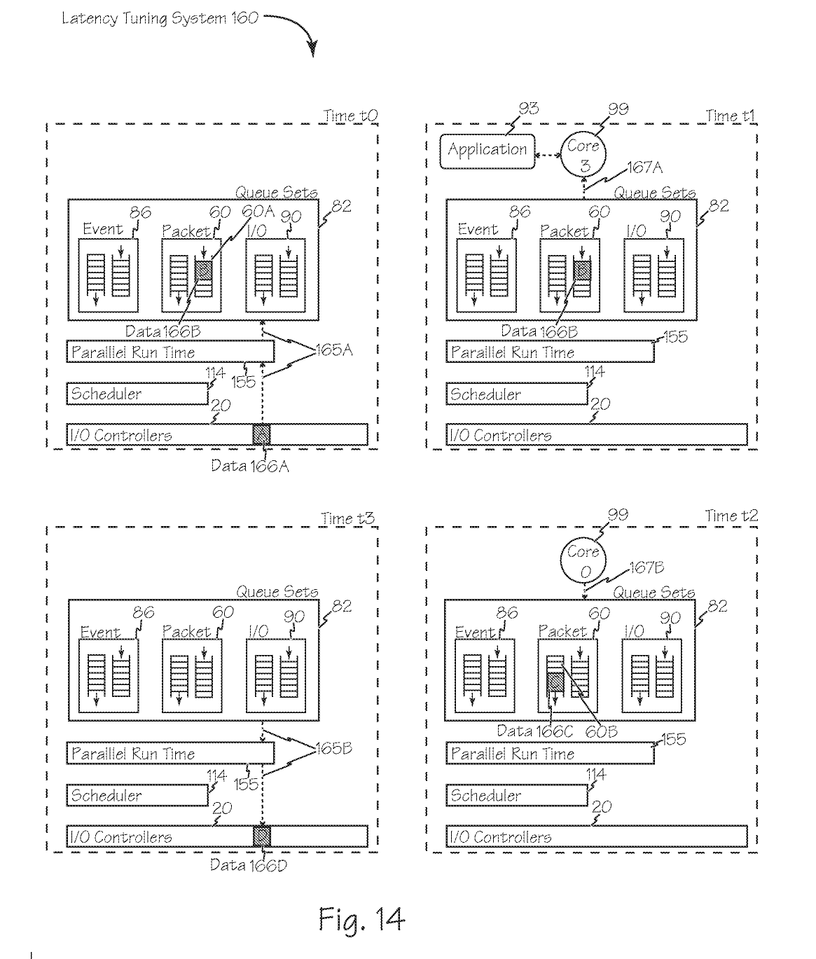

FIG. 14 is a block diagram illustrating latency tuning system 160 for throughput-sensitive applications in a computer system utilizing kernel bypass. For example, during time period t0, a portion of incoming data 166A (shown in the figure as gray box as “A”), from one of the plurality of I/O controllers 20, may be caused by scheduling decisions applied by scheduler 114 to PRT 25 to be moved via paths 165A to an incoming or ingress packet queue in queues 82, such as ingress queue 60A of packet queue 60. When a latency sensitive application, such as application 93, is executing with low latency, data 166B (shown in the figure as gray box as “B”), may be at or near the top of the ingress queue 60A, pending execution on core 99.

During time period t1, data 166B may be applied via path 167A to core 99 for execution. During time period t2, the result of such execution by processing by core 99 may be applied via path 167B (e.g., the same path as path 167A but in the reverse direction) to egress queue 60B of packet queue 60. Again, if the latency-sensitive application is operating with low latency, data 166C, (shown in the figure as gray box as “C”), may be at or near to the output of egress queue 60B of packet 60. During time period t3, PRT 25 in response to a scheduling decision applied thereto by scheduler 114, may transmits data 166D (shown in the figure as gray box as “D”) via path 165B to the one of I/O controllers from which data 166A was originally retrieved.

In this manner, scheduler 114 may reduce the execution latency of a latency sensitive application.

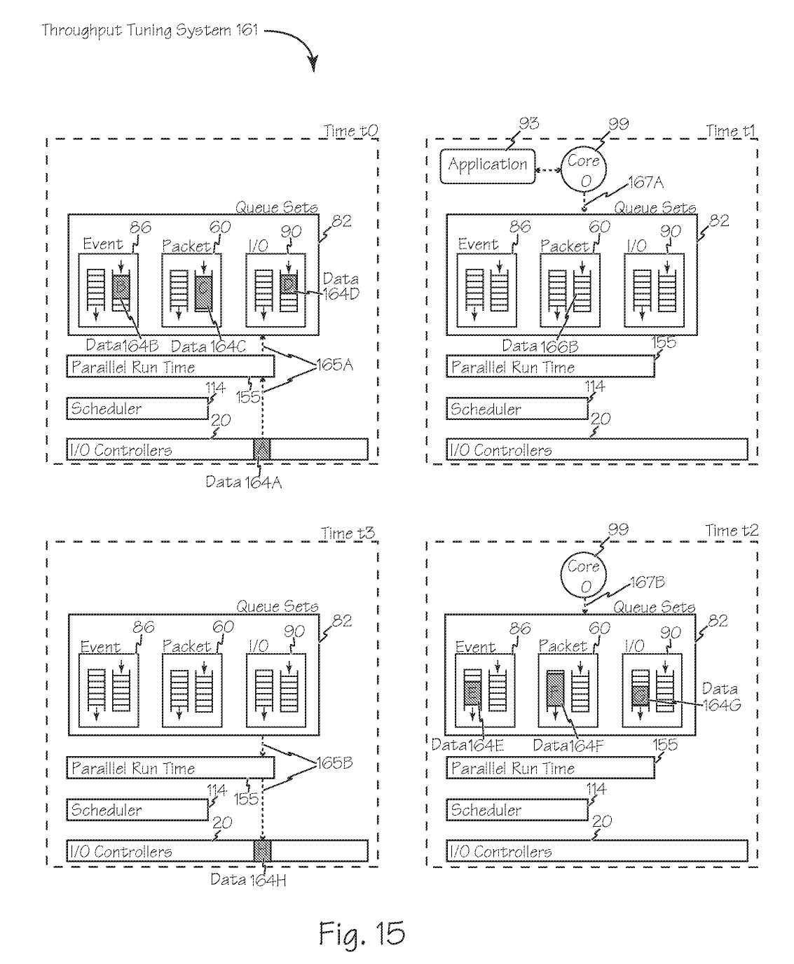

Referring now to FIG. 15, for throughput-sensitive applications for latency-sensitive applications as shown in latency tuning operation 160, resource scheduler 114 may configure PRT 25, by sending scheduling decisions thereto, to batch a relatively large quantity of data, such as data 164A, from/to output/input software processing queues, e.g., of event, packet and/or I/O queues 86, 60 and 90, respectively, to avoid unnecessary mode switches between application 93 and PRT 25 to improve execution throughput of application 93. Specifically, resource scheduler 114 may instruct PRT 25 to batch more events, packets, and I/O data in the software input queues before invoking the execution of application 93. Application 93 may be caused to be invoked by causing application 93 to wake up, for example from epoll, posix or similar kernel call waiting or blocking and the like, in order to start fetching the batched input data from buffer 33 then waiting in event, packet and/or I/O queues 86, 60 and 90, respectively.

For example, in throughput tuning operation 161, during time period t0, under the direction of scheduler 114, PRT 25 may cause I/O data 164A to be moved over path 165A, to the input queues, for example, of event, packet and I/O queues 86, 60 and 90, respectively. Data 164B, 164C and 164D in queues 86, 60 and 90, respectively, may be of different lengths as shown by the gray boxes B, C and D in those queues.

During time period t1, data 164B, 164C and 164D may be moved at different times via path 167A to core 99 for execution of application 93. During time period t2, data resulting from the execution of data 164B, 164C and 164D application 93 by core 99 may be returned via path 167B, which may be the same path as path 167A but in the reverse direction, to event, packet and I/O queues 86, 60 and 90, respectively. This data, as moved, is illustrated as data 164E, 164F and 164G in the egress queues of queues 86, 60 and 90, respectively, and may be of different lengths as indicated by the lengths of gray boxes E, F and G. During time period t3, data 164E, 164F and 164G may be moved via path 165B, to I/O controllers 20 as data 164H indicated therein as gray box H.

Batching I/O data in the manner illustrated may improve application processing, for example, by reducing the frequency of mode switches between application 93 and PRT 25 to save more resources, such as CPU cycles, for the execution of application 93 in core 99. PRT 25 may also hold up more outgoing data 33 in the software output queues of event, packet and/or I/O queues 86, 60 and 90, respectively, and while determining optimized timing to empty the queues. For example, PRT 25 may batch small portions of outgoing data 164H into a larger network packets to maximize network throughput. The optimal data batch size that can achieve best distribution of resources (e.g., CPU cycles) between the execution of application 93 and the execution of PRT 25, may depend on the processing cost of executing application 93 and the processing overhead for PRT 25 to transfer data such as I/O data. The optimal data batch size may be tuned by the resource scheduler from time to time.

It should be noted that excessive batching of input/output data, such as data 164A or 164H, may increase latency of the application being processed. The maximum batch size may therefore be bound by the latency requirements of the application being executed.

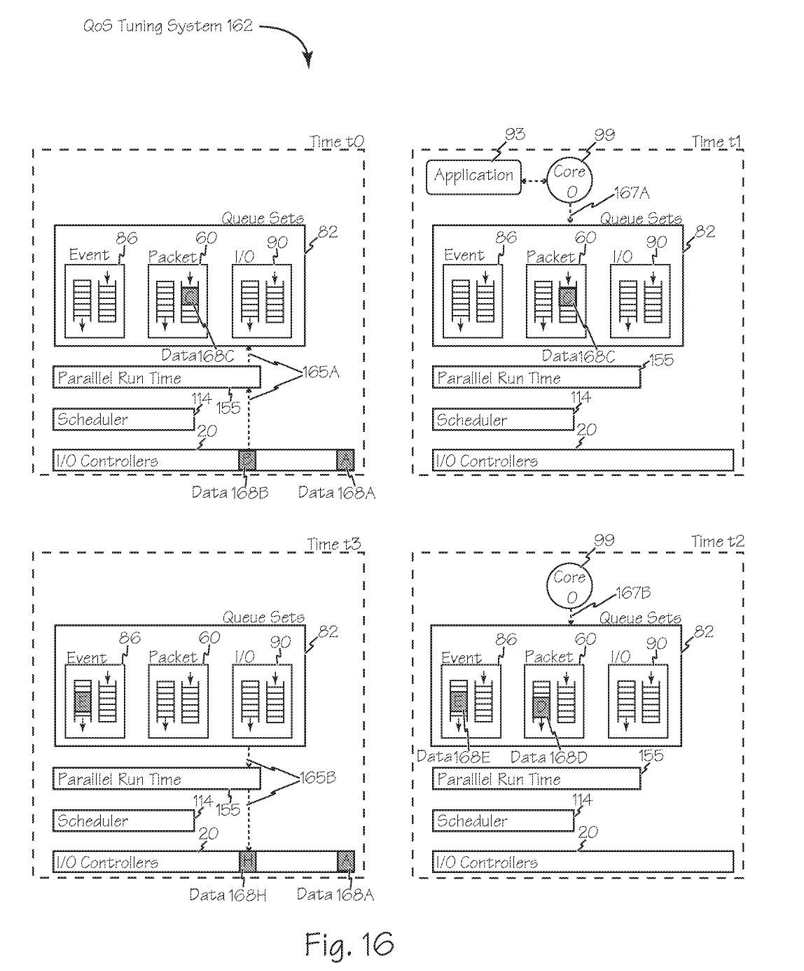

Referring now to FIG. 16, in QoS tuning operation 162, scheduler 114 may provide resource scheduling of different priorities for data transfers to and from software processing queues in order to accommodate the QoS requirements for processing an application such as application 93 on a parallel run-time core, such as core 99.

For example, scheduler 114 may prioritize data transfer, e.g., for I/O data from I/O controllers 20 even if other such data has been resident longer in I/O controllers 20. That's is, scheduler 114 may select data for transfer to software processing queues 82, based on the priority of that data being available in software processing queues 82 for execution, even if other such data for execution by the same application in the same group on the same core has been resident longer in I/O controllers 20. As an example, I/O controllers 20 could be scheduled to transfer I/O data 168A via path 165A, to packet queue 60, based on time of receipt or length of residence in a buffer or the like. However, if scheduler 114 determines that transferring data 168B to queue 60, before transferring 168A, would likely improve execution of application 93, for example by reducing processing overhead, improving latency or throughput or the like, scheduler 114 may provide scheduling instructions to prioritize the transfer of data 168B allowing data 168A to remain in I/O controllers 20.

As one example, during time period t0, scheduler may direct PRT 25 to fetch input data 168B from I/O 20 and move that data via path 165A, to an input queue of packet queue 60 as illustrated by gray box C. Data 168A may then continue to reside in a hardware queue of the Ethernet or I/O controllers 20 as illustrated by gray box A.

During time period t1, higher priority data, e.g. as shown in the gray box C, i.e., data 168C in egress packet queue 60, may be transferred from packet queue 60 via path 167A to core 99 for processing by application 93.

During time period t2, data 168D and 168E resulting from the processing of 168C in cores 98 may be returned to queues 82 via path 307. Data 168D may have higher priority in egress packet queue 60 than some other data, such as 168E in the egress queue of event queues 86. Further, data 168D and 168E may have different priorities, based on application performance, to be return to I/O controllers 20. Packet data 168D may be determined by scheduler 114 to have higher priority for transfer to I/O controllers 20 for application performance reasons compared to event data 168E.

During time t3, data 168D is transferred from packet queue 60, via path 165B, to the appropriate one of I/O controllers 20 as indicated by gray box H. It should be noted that at this time data 168A may remain in I/O controllers 20 and data 168E may remain in event queue 86. Scheduler 114 may then schedule processing in core 99 for one or the other of these data, or some other data, depending on the priority requirements, for any such data, of application 93 being processed in core 99.

Scheduler 114 may tune PRT 25 to schedule data delivery to different software processing queues to meet different application quality-of-service requirement. For example, for network applications that need to establish a large quantity of TCP connections (e.g., web proxy and server and virtual private network gateway), PRT 25 may be configured to direct TCP SYN packet to different NIC hardware queue, i.e. NIC logic 21, and dedicate a high-priority thread to handler these packets. For applications that maintain fewer TCP connections but transfer bulk data in them (e.g., back-end in-memory cache and NoSQL database), the software processing queues that hold the data packets may be given higher priority. Another example may be that a software application has two services running on two TCP ports and one of them has higher priority. Resource scheduler 114 may configure PRT 25 to deliver the data of the more important service faster to its software processing queue(s). During congestion, resource scheduler 114 may consider to drop more incoming or outgoing data of the service of lower priority.

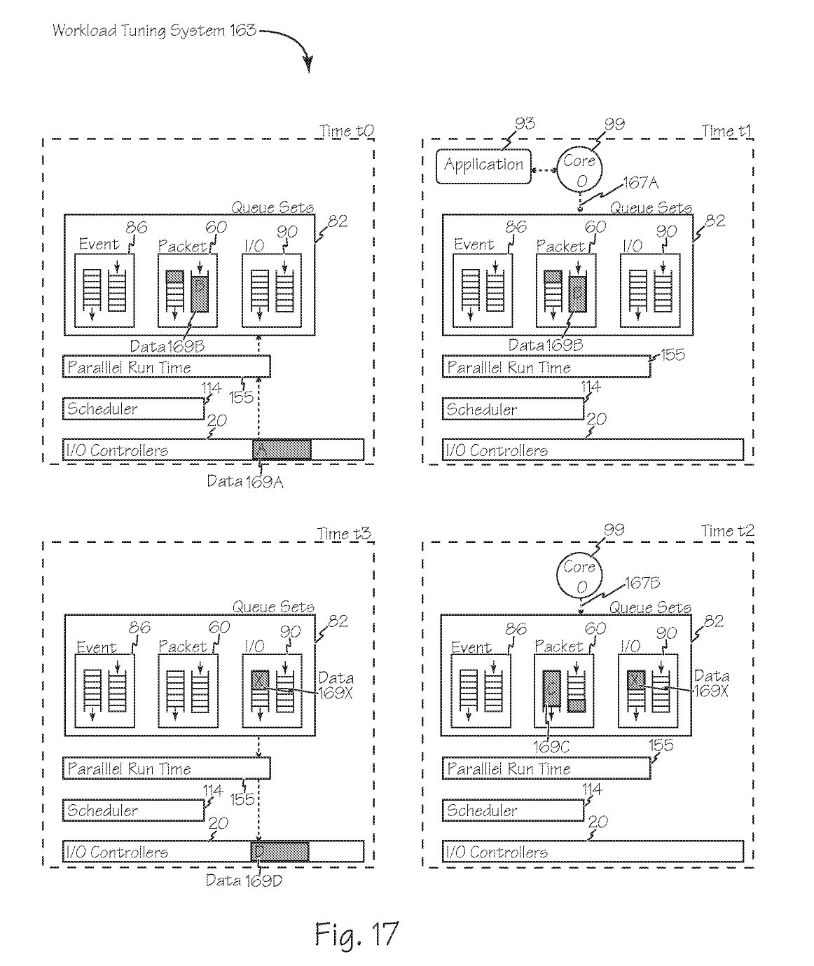

Referring now to FIG. 17, as illustrated in workload tuning operation 163, scheduler 114 may cause PRT 25 to schedule or reschedule data transfers with various different software processing queues in queues 82 in accordance with dynamic workload changes, e.g. during processing of application 93 by core 99. Scheduler 114 can adjust data delivery via PRT 25 to adjust to dynamic application workload situations. For example, If resource scheduler 114 identifies or otherwise determines congestion or starvation on some software processing queues, or finds out real-time trending of data between the software queues and its relevant external entities (e.g., hardware queues of input/output packets in network interface cards), scheduler can dynamically adjust the data delivery priority of the input and output software processing queues PRT 25 and change the priority of execution such queues by the software application on the associated cash in order to improve software application execution performance.

For example, at time t0, resource scheduler 114 may detect or otherwise determine that the ingress queue of packet queues 60 for application 93 holds new TCP connections as data 169B, or other data, having a long queue length. As shown in the figure, data 169B in the ingress queue of packet queues 60 is nearly full. Resource scheduler 114 may instruct PRT 25 to hold up data of other queues, even if they would otherwise have priority over data 169B, for enough time to allow application 93 sufficient time to process at least some of data 169B, e.g., which may be new TCP connections, in order to reduce the latency of establishing a new TCP connection.

At time t1, resource scheduler 114 can dynamically boost up the priority of data 169B the ingress queue of packet queues 60 and instruct PRT 25 to leave some low priority input data, shown for example as data 169A, temporarily in the hardware queues of the Ethernet I/O controllers 20. As a result, PRT 25 causes application 93 to fetch data 169B via path 167A and process the high priority input data, data 169B.

At time t2, application 93 may generate some output data via path 167B. Some of such output data, such as data 169C, may go to congested output queues such as the egress queue of packet queues 60. Other such output data, such as data 169X may be directed to non-congested output queues.

At time t3, resource scheduler 114 may treat congested output queues, such as the egress packet queue in packet queues 60, as having a higher priority than non-congested queues. It will then be more likely for resource scheduler 114 to configure PRT 25 to send out high priority output data 169D to I/O controllers 20, and delay the low priority data 169X.

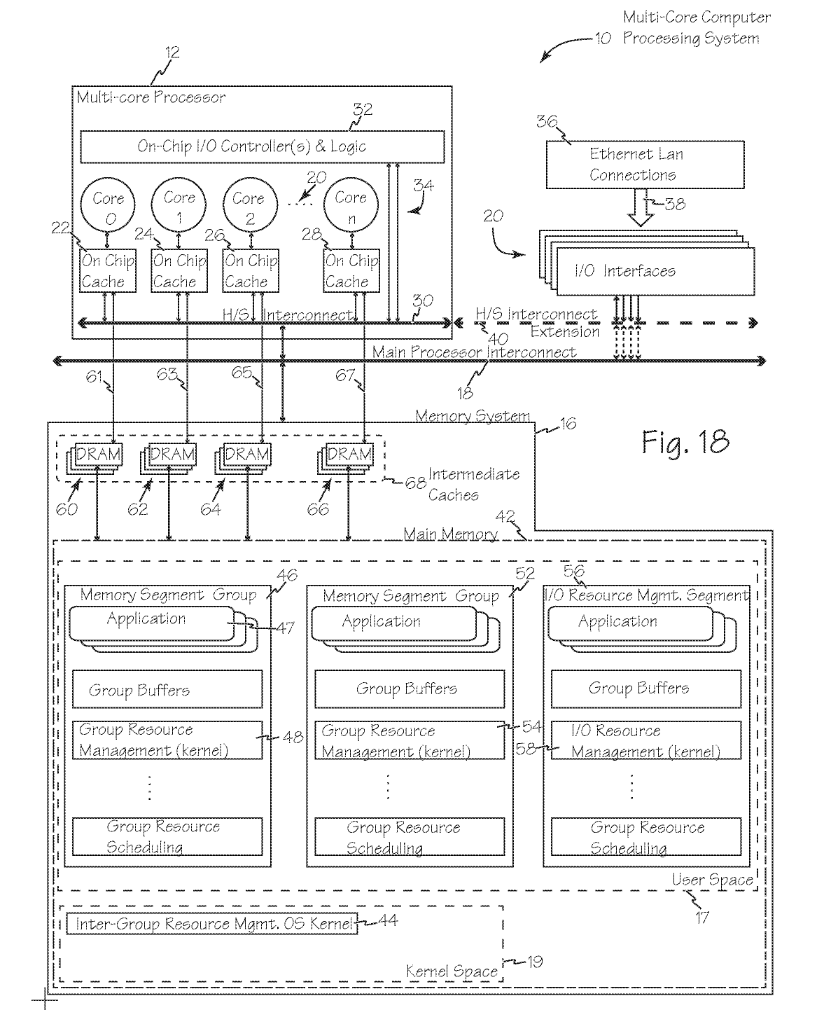

Referring now to FIG. 18, computer system 170 includes one or more multi-core processor 12, and resource I/O interfaces 20 and memory system 18 interconnected thereto by processor interconnect 16. Multicore processor 12 includes two or more cores on the same integrated circuit chip or similar structure. Only cores 0, 1, 2 and n are specifically illustrated in this figure. Line of square dots 20 indicates the cores not illustrated for convenience. Cores 0, 1, 2 through n are each associated with and connected to on chip cache(s) 22, 24, 26 and 28 respectively. There may be multiple on chip caches for each core, at least one of which is typically connected to on chip interconnect 30 as shown which is, in turn connected to processor interconnect 16.

Processor 12 also includes on chip I/O controller(s) and logic 32 which may be connected via lines 34 to on chip interconnect 30 and then via processor interconnect 16 to a plurality of I/O interfaces 20 which are each typically connected to a plurality of low level hardware such as Ethernet LAN controllers 36 as illustrated by connections 38. Alternately, to reduce processing time and overhead of for example packet processing, on chip interconnect 30 may be extended off chip, as illustrated by dotted line connection 40, directly to I/O interfaces 20. In datacenter and similar applications using high volume Ethernet or similar traffic, the more direct connection between on chip I/O controller and logic 32 to I/O interfaces 20, on chip or off chip lines 34 may substantially improve processing performance especially for latency sensitive and/or throughput sensitive applications.

On-chip I/O controller and logic 32, when coupled with I/O interfaces 20, generally provide the interface services typically provided by a plurality of network interface cards (NICs). Especially in high volume Ethernet, and similar applications, at least some of the NIC functions may be processed within multi-core processor 12, for example, to reduce latency and increase throughput. It may be beneficial to connect many if not all Ethernet LAN connections 36 as directly as possible to multi-core processor 12 so that processor 12 can direct data and traffic from each such LAN connection 36 to an appropriate core for processing, but the number of available pins or connections to processor 12 may be a limiting factor. The use of multiplexing techniques, either within processor 12 or for example between I/O interfaces 20 may resolve or reduce such problems.

For example I/O interfaces 20 may include one or multiplexers, or similar components reducing the number of output connections required. For example, the multiplexer, or other preprocessor, may initially direct different sets of I/O data, traffic and events from I/O interfaces 20 for execution on different cores. Thereafter, depending upon performance such as latency, throughput and/or cache congestion, processor 12 may reallocate some sets of I/O data, traffic and events from I/O interfaces 20 for execution on different cores.

Many if not all cores of processor 12 may be used in a parallel processing mode in accordance with a plurality of group or application specific group resource management segments of memory system 18. For example, core n may be used for some, if not all, aspects of I/O processing including, for example, executing I/O resource management segments in memory system 16 and/or executing processes required or desirable related to on chip I/O controllers and logic 32.

Main memory system 16 includes main memory 42, such as DRAM, which may preferably be divided into a plurality segments or portions allocated, for example, at least one segment or portion per core. For example, core 0 may be allocated to perform OS kernel services, such as inter-group resource management segment 44. Core 1 may be used to process memory segment group 46 in accordance with group resource management 48 which may include modified versions of execution framework 50 as illustrated and discussed above, kernel services 44, kernel space parallel processing 52, user space buffers 70, queue sets 82 and/or dynamic resources scheduling 120, as shown for example in FIG. 5 above. For example, inclusion of I/O controllers and logic 32, either within multi-core processor 12 or as a co-processor for multi-core processor 12, may obviate the need for some or all the aspects of kernel space parallel processing 52.

Similarly, core 2 may be used to process memory segment group 52 in accordance with group resource management 54 which may include differently modified versions of execution framework 50 (FIGS. 2 and 5), kernel services 44, kernel space parallel processing 52, user space buffers 30, queue sets 82 and/or dynamic resources scheduling 120. As a result, inter-group resource management 44 may be considered to be similar in concept to kernel-space 19, including a limited portion of OS kernel services 46 and OS software services 47 as shown in FIG. 5 and elsewhere. Any person competent to write an operating system from scratch can divide the OS kernel into container versions such as group resource management 48, 54 and 58 and intergroup container versions such as inter-group resource management 44.

Core n may also be used to process I/O resource management memory segment 56, in accordance with group I/O resource management 58.

Memory segment groups 46, 52 and others not illustrated in this figure, may each be considered to be similar in concept to user-space 17 of FIG. 5. For example, each memory segment group may be considered to be an application group or container as discussed above. That is, one or more software applications, related for example by requiring similar resource management services, may be executed in each memory segment group, such as groups 46 and 52.

Although main memory 42 may be a contiguous DRAM module or modules, as computer processing systems continue to increase in scale, the CPU processing cycles needed to manage a very large DRAM memory may become a factor in execution efficiency. One way to reduce memory management processing cycles used in multi-core processor 12 may be to allocate contiguous segments of main memory as intermediate or group caches dedicated for each core. That is, if the size of the memory to be managed can be reduced by a factor of 72 or higher, substantial CPU processing cycles may be saved. Similarly, because high capacity DRAM memory modules are no longer cost prohibitive, separate modules may be used for each memory segment group.

Although the use of separate DRAM modules or groups of modules, each module or group used for a different group of related applications may require the use of more total memory, smaller modules are much less expensive. That is, in a large datacenter for example processing a database in each of a plurality of containers or groups, the cost of a series of DRAM modules each providing enough main memory for a database per group, will be much less expensive by orders of magnitude than a single memory module and associated memory management costs.

Further, because each core of multi-core processor 12 operates in parallel, additional memory space may be added in increments when needed under the control of processor 12, for example by having core n execute I/O resource management 58 to add another memory module, or move to a larger capacity memory module. If two or more memory modules are used for a single core, such as core 1, the ongoing memory management may then be handled at least in part by core 1 and/or core n. The resultant memory management processing cycles will still be less for some of the cores using two DRAM modules that have to be managed, than the cycles required for managing a much larger DRAM handling all cores.

For large, high volume datacenter applications, another potential advantage of providing group resource management services, such as resource management 48, specific to the one or more related applications in each memory segment, such as segment 46, may be the use of additional cache memories, such as modules 60, 62, 64 and 66, used for each core as shown in FIG. 18. Extra, or extended cache memory such as modules 60, 62, 64 and 66 may include direct connections 61, 63, 65 and 67 respectively to the on-chip caches to avoid the bottleneck of main processor interconnect 16.

Resource management for groups of related applications executing on a single core provides opportunities to improve software application processing by using intermediate caches between the on chip caches and the related memory segment group. For example, intermediate caches 68 may be positioned between main memory 42 and multi-core processor 12. In particular, OS kernel cache 60 may be positioned intermediate OS kernel 44 and cache(s) 22 associated with core 0, group 46 cache 62 may be positioned intermediate Group 46 and cache(s) 24 associated with core 1. Similarly group 52 cache 64 may be positioned intermediate group 52 and cache(s) 26 associated with core 2 and so on. I/O resource management cache 66 may be positioned intermediate I/O management group 56 and cache(s) 28 associated with core n.

The size and speed of caches 60, 62, 64 and 66 must be compared to the costs of such caches. However, especially if a single large DRAM is used for main memory 42. That is, the on chip caches are typically limited in size, so many measures described above are used to maintain or improve cache locality. That is, processing the cores of a multi-core processor as parallel processors tends to have the contents of cache 24 more likely to be what's needed as compared to the use of SPM processing which spreads the execution of a software application across many cores requiring substantial cache transfers between the cores and main memory.

As a result, an intermediate speed cache, such as cache 62, may be beneficially positioned between chip cache(s) 24 and memory segment group 46. The benefits may include reducing processing cycles required for core 1. For example, I/O resource management 58 may be used to better predict the required contents of cache(s) 24 for software application in group 46 and so update intermediate cache 64 to reduce the processing cycles needed to maintain locality of cache 24 for further execution by core 1.

In use, multi-core processing system 170 of FIG. 18 may implement the OS kernel bypass as discussed above and the process of selecting which OS kernel services to allocate to a group resource manager such as group manager 48 may be accomplished by deconstructing the SMP or OS kernel to create a segment or group resource manager. Looking at the common calls and contentions of the applications in the memory segment group may be one technique for identifying suitable resource management services and copying them from the OS kernel to the group resource manager. Any of the SMP or OS kernel services that are not needed for a group manager are evaluated to determine if they are required for intergroup kernel 44 and if they are not required, they may be left out. Alternatively, inter-group resource management 44 may be formed by integrating required inter-group services iteratively as discussed above for group managers such as group manager 48.

Alternatively, the process of determining which OS kernel services to allocate to a specific group resource management service may be handled iteratively by the system and then the system may then test the allocation of group resources management services and change the allocation of group resource management services and retest the system and iteratively improve and optimize the system.

For example, one or more applications may be loaded into a memory segment group such as application 47 in memory segment group 46. Application 47 may be any suitable application such as a database software application. A subset of inter-group management services 44 may be allocated to group resource management 48 based on the needs of application 47. Core 1 may then run application 47 in one or more processes that are overhead intensive and during the operation of core 1 one or more system performance parameters are monitored and saved. Any suitable core such as core n running I/O resource management may then process the saved system performance parameters and as a result, inter-group resource management services 44 may have one or more resource services added or removed and the process repeated until the system performance improvements stabilize. This process enables exponential learning of the processing system.

A benchmark program could also be written and/or used to activate the database intensively, the program could be repeated on other systems and/or other cores for consistency. The bench mark could beneficial provide a consistent measurement that could be made and repeated to check other hardware and or other Ethernet connections as another way of checking what happens over LAN. Also that the earlier described computer systems can be used for the iterations.

This process may be run simultaneously under the control of one or more cores such as core n on multiple cores using the allocated intermediate caches for the cores and their corresponding memory segment groups. For example cores 1 and 2 may be run in parallel using intermediate caches 62 and 64 and corresponding memory segment groups 46 and 52.

Multi-core processor 12 may have any suitable number of cores and with the parallel processing procedures discussed above one or more of the cores may be allocated to processes that never would have been allocated to a core such as intercepting all calls and allocating them.

For big datacenters, cloud computing or other scalable applications, it may be useful to create versions of group resource kernel 48 for one or more specific versions, brands or platform configurations of databases or other software applications used a lot in such datacenter. The full or even only partially improved kernel can always be used for less commonly used software applications which may not worth writing a group resource kernel such as group resource kernel 48 for and/or as a backup if something goes wrong. For many configurations, moving some or all types of lock based kernel facilities is an optimal first step.

Various portions of the disclosures herein may be combined in full or in part and may be partially or fully eliminated and/or combined in various ways to be provide variously structured computer systems with additional benefits or cost reductions or for other reasons depending upon the software and hardware used in the computer system without straying from the spirit and scope of the inventions disclosed herein which to be interpreted by the scope of the claims.

1. A method for executing software applications in a computer system including one or more multi-core processors, main memory shared by the one or more multi-core processors, a symmetrical multi-processing (SMP) operating system (OS) running over the one or more multi-core processors, one or more groups, each including one or more software applications, in a user-space portion of main memory, and a set of SMP OS resource management services in a kernel-space portion of main memory, the method comprising:
a) intercepting, in user-space, a first set of software calls and system calls directed to kernel-space during execution of at least a portion of one or more of the software applications in the first one of the one or more groups, to provide resource management services required for processing the first set of software calls and system calls; and
b) redirecting the first set of software calls and system calls to a second set of resource management services, in user-space, selected for use during execution of software applications in the first group.

2. The method of claim 1 further comprising:
a) intercepting a second set of software calls and system calls occurring during execution of at least a portion of a software application in a second group of applications; and
b) directing the second set of intercepted software calls and system calls to a third set of resource management services different from the second set of resource management services.

3. The method of claim 1, wherein at least portions of the first group of applications are stored in a first subset of the use-space portion of main memory isolated from kernel space portion, the method further comprising:
intercepting the first set of software calls and system calls, redirecting the intercepted first set of software calls and system calls to the second set of resource management services, and executing the resources management services of the first set of management services, in the first subset of user space in the main memory.

4. The method of claim 3, further comprising:
using a second subset of user space in main memory, isolated from the first subset and from kernel space, to store at least portions of a second group of applications and a second set of resource management services, and
providing resource management in the second subset of main memory for execution of at least a portion of an application stored in the second group of applications.

5. The method of claim 4 wherein the first and second subsets of main memory are OS level software abstractions.

6. The method of claim 3 wherein the first and second subsets of main memory are software containers.

7. The method of claim 1 further comprising:
executing the at least a portion of one software application in the first group on a first core of the multi-core processor; and
using the first core to intercept and redirect the first set of software calls and system calls and to provide resource management services therefore from the first set of resource management services.

8. The method of claim 1, further comprising:
executing the at least a portion of one software application in the first group exclusively with a first core of the multi-core; and
continuing execution on the same first core to intercept and redirect the first set of software calls and systems and to provide resource management services from the second set of resource management services.

9. The method of claim 8 further comprising:
directing inbound data, metadata and events related to the at least a portion of one software application for processing by the first core, while
directing inbound data, metadata and events not related to a different portion of the software application or a different software application for processing by a different core of the multi-core processor.

10. The method of claim 9 wherein directing inbound data, metadata and events related to the at least a portion of one software application for processing by the first core further comprises:
dynamically programming I/O controllers associated with the computer system to direct inbound data, metadata and events related to the at least a portion of the software application for execution by the first core.

11. The method of claim 1 further comprising:
providing a second software application in the first group selected to have similar resource allocation and management resources to the at least one software application.

12. The method of claim 11 wherein providing a second software application in the first group selected to have similar resource allocation and management resources to the at least one software application, the method further comprising:
selecting a second software application so that the at least one software application and the second software application are inter-dependent and inter-communicating with each other.

13. The method of claim 1 wherein directing the intercepted set of software calls and system calls to a first set of resource management services, the method further comprising:
providing in user space a first subset of the SMP OS resource management services as the first set of resource management services.

14. The method of claim 13 further comprising:
providing a second subset of the SMP OS resource management services as a second set of resource management services for use in providing resource management services for use with software applications in a different group of software applications.

15. The method of claim 1 wherein directing the intercepted set of software calls and system calls to a first set of resource management services further comprises:
including, in the first set of resource management services, some or all of the resource management services required to provide resource management for execution of the first group of software applications while excluding at least some of the resource management services available in the set of SMP OS resource management services in a kernel space portion of main memory.

16. A method of operating a shared resource computer system using an SMP OS, the method comprising:
storing and executing each of a plurality of groups of one or more software applications in different portions of main memory, each application in a group having related requirements for resource management services, each portion wholly or partly isolated from each other portion and wholly or partly isolated from resource management services available in the SMP OS;
preventing the SMP OS from providing at least some of the resource management services required by said execution of the software applications; and
providing at least some of the resource management services for said execution in the portion of main memory in which said each of the software applications is stored.

17. The method of claim 16 further comprising:
executing software applications in different groups in parallel on different cores of a multi-core processor.

18. The method of claim 17, further comprising:
applying data for processing by particular software applications, received via I/O controllers, to the cores on which the particular applications are executing in parallel.

19. The method of claim 16, wherein providing at least some of the management services for execution of a particular software application in the portion of main memory in which the particular software application is stored, the method further comprises:
using a set of resource management services selected for each particular group of related applications.

20. The method of claim 17, wherein using a set of resource management services selected for each particular group further comprises:
selecting a set of resource managements services to be applied to execution of software applications in each group, based on the related requirements for resource management services of that group, to reduce processing overhead and limitations by reducing mode switching, contentions, non-locality of caches, inter-cache communications and/or kernel synchronizations during execution of software applications in the first plurality of software applications.

21-61. (canceled)
